(19) United States
(12) Patent Application Publication
(10) Pub. No.: US 2005/0042983 A1
(43) Pub. Date: Feb. 24, 2005

(54) Device appliances and methods for the diffusion billing payment and playback of digital media contents

(76) Inventor: Glenn Rolus Borgward, Munich (DE)

Correspondence Address: BAKER & DANIELS, 205 W. JEFFERSON BOULEVARD, SUITE 250, SOUTH BEND, IN, 46601, US

(21) Appl. No.: 10/487,957

(22) PCT Filed: Aug. 26, 2002
(86) PCT No.: PCT/EP02/09511

(30) Foreign Application Priority Data
Aug. 24, 2001 (DE) 101 40 712.2
Apr. 2, 2002 (DE) 102 14 645.4

(51) Int. Cl. H04H 7/00

(52) U.S. Cl. 455/3.06

(57) ABSTRACT

Mobile device for transmitting and/or storing and/or displaying data, having a two-part structure composed of a display and operator control part and a wearable computer, it being possible to connect the display and operator control part and operator control part and wearable computer via a wirebound or wirefree data connection, and it being possible to use the display and operator control part as an independent terminal (for example telephone, PDA, media player or remote control).

The invention relates to devices, equipment and methods for distributing, billing and paying for digital media content.

The Internet, as a global digital network, is extremely suitable for use as a technical platform for distributing digital data of content providers to their customers. Media content such as texts, audio content such as music or speech, images and moving video content are currently produced almost completely in digital form or can be digitized with little effort. By using highly developed compression techniques such as, for example, MP3 (for the audio field) or MPEG (for the video field), it is also possible to convey data-intensive content over the current Internet infrastructure, which still has a relatively narrow band at the consumer end. Software which is intended for use by the customer is also included within the digital content mentioned above in the context of the present invention.

A provider of such multimedia content typically operates a particularly powerful computer, referred to as a server, which is continuously connected to the Internet via a broadband dedicated line. The customers of the content providers must respectively have access to a computer which is connected or can be connected to the Internet, for example to what is referred to as a personal computer (PC), and by using suitable Internet for example service protocols such as, in the simplest case, for example the “hypertext transport protocol” (HTTP) they download the data representing the content from the server onto the local computer (client). In this context, the digital content are frequently stored initially in the form of a file on the local computer before they can be used there. Alternatively, what are referred to as streaming protocols are available, in which the data representing the content is converted directly into perceptible sensory impressions during the download from the server computer to the client computer without a file which corresponds to the digital content being generated and stored on the client computer.

For a long time not only fixed equipment in the form of a PC which is connected or can be connected to the Internet via line-bound transmission paths have been considered as client computers. Mobile equipment is available which can easily be carried on the person. Examples of this are compact playback devices (players), for example for MP3 audio files or for digital reading matter (e-books). Recently, equipment for converting digital content into perceptible sensory impressions which has a wirefree radio-frequency connection to the Internet, for example via mobile telephone networks such as GSM or UMTS, has also become known.

Usually, different types of media are differentiated with respect to the technical devices and methods which are used to convert a digital content into a form which can be perceived by sensory means by the consumer. In the case of texts and images, including video sequences, the sense of sight is stimulated, and the terms “display devices” and “display methods” are used. In the case of audio media, which stimulate the sense of hearing, the terms “playback devices” and “playback methods” are used. Digital media can also stimulate other senses, in particular the sense of touch and the sense of smell. The subject matter of this invention relates, in its most general form, to the conversion of all these different types of media into a form which is suitable in a given situation for perception by the senses. The generally inventive aspects which are explained in the following text apply, despite specific expressions such as “display”, “playback,” “playing back” etc., basically to all forms of the consumption of media as long as they are not restricted expressly to specific types of media such as page-orientated items of text, for example. The use of software is also subsumed under this because even when software, for example a computer game or a piece of text processing software, runs the consumer interacts on the level of sensory perception. Despite this, it appears unavoidable that specific examples which are introduced for the sake of illustration will be restricted to specific types of media.

There are unsolved problems with respect to billing and payment concepts for this type of modern distribution of digital content.

Experience has shown that the first and fundamental question is whether the customer is at all willing to pay the respective content providers for the consumption of digital content via the Internet above and beyond the costs incurred for the actual Internet connection. The answer to this question depends essentially on the technical infrastructure required.

For example, a company (MP3.COM) which is based in the United States offers a service which includes providing all Internet users with the possibility of downloading free of charge content in the form of audio files in the MP3 format, which originally could only be purchased as audio CDs (compact discs). The original concept originally included a control component which was such that the downloading of the MP3 audio file which was associated with a specific audio CD from a central server which was operated by the company was enabled for an individual customer only if this customer had previously transmitted a characteristic data sample of a corresponding audio CD to the server, the purpose of this being to prove that the respective customer had already purchased a copy of this CD and that the provision of a corresponding MP3 audio file was covered by restricting provisions of copyright law. This approach cannot be considered promising for the future, for a number of reasons:

1. On the one hand, at least for the United States, it has since become clear, as a result of court cases, that at least the original business model might not be covered by the qualifying provisions of U.S. copyright law.

2. On the other hand, according to the theory of this business model, the flow of money from the consumer to the provider is still based on the sale of material goods, because the consumer should be able to obtain access to the server only by purchasing a corresponding audio CD. This must be considered a disadvantage in the age of the digital Internet economy.

3. As a result of the fact that the MP3 audio files which are downloaded from the server represent, in extremely good quality, the items which were originally marketed on the audio CD, and furthermore can be distributed further over the Internet without a large degree of expenditure and without a further loss in quality, there is an incentive for the customers of the company to make available themselves the downloaded MP3 audio files free of charge not only, for example, to close friends or relatives but also to the public at large. As a result, the service providers lose income as the MP3 audio files are distributed to a much wider public than the original purchasers of the audio CDs.

4. Finally, the temporary possession of a suitable audio CD is not equivalent to legitimate ownership of this data carrier, i.e. it is not possible to exclude situations in which audio CDs are lent for a short time by the owner to third parties exclusively for the purpose of gaining access to the server.

Possibly also in view of the shortcomings of the billing and payment concept of MP3.COM described above, another company, Napster Inc., which is based in the United States has developed another business model whose users are provided with access free of charge to, in particular, digital content which are present as MP3 audio files.

In this concept (peer-to-peer file sharing), there is no longer a central server for storing digital content; the MP3 audio files and other content are stored exclusively on the local client computers under the control of the customers of this company. The central Napster server provides merely the function of an intermediary, i.e. it receives requests from Napster customers for a specific digital content and then supplies the Internet address of client computers from which a corresponding file can be retrieved and downloaded. According to this system, it is only possible to retrieve what at least one Napster customer keeps ready for retrieval and downloading at a given point in time on a computer which is under his control. The original business concept is based on the idea that the noncommercial exchange of items which are protected by copyright among private individuals is covered by qualifying provisions of copyright law, it being assumed that the commercial intermediary activity by Napster does not infringe the noncommercial-private character of the distribution of digital content. In this case too, it now seems to have become clear that the business model does not comply at least with the qualifying provisions of U.S. copyright law.

With the known peer-to-peer concepts, there is no provision within the concepts for a flow of money from the consumer to the content provider. The owners of the copyrights of digital content have therefore experienced a significant deficiency in available technical concepts in order to be able to charge and collect appropriate payment even under the conditions of the Internet economy.

In this context, technical approaches which basically wish to prevent peer-topeer transactions on the Internet, for example at the level of the infrastructure of the Internet access providers through compulsory filtering of the Internet data streams, seem to be problematic. On the one hand, for political and legal reasons it is doubtful whether these concepts could be implemented on the necessary wide scale. On the other hand, new technical concepts for protecting the exchange of files through peer-to-peer transactions, including not least against legal or administrative intervention, are continuously being developed. An example of this is the peer-to-peer file transfer protocol “Gnutella” which, in contrast to the Napster concept, does not require a central server as intermediary. The ability to identify the client subscribers of such a protocol and the associated possibility of taking steps against the use of these technologies at a legal or administrative level are now being undermined by cryptographic anonymity techniques such as have been included in what is referred to as the “freenet” protocol.

Adequate protection against unauthorized reproduction is a basic technical precondition for the possibility of sustained billing of a payment for the use of digital content by consumers. If this problem is not solved, economically viable billing does not appear possible.

Cryptographic concepts which present themselves for this purpose are ones in which
files incorporating digital content are distributed both over the Internet and by means of physical data carriers such as CDs, exclusively in encrypted form, and/or
in which files incorporating digital content are provided with steganographically concealed information, referred to as “watermarks,” which provide information on the copyright status of the items contained in said files and which cannot be removed again from the files representing the digital content by the consumer by means of illegitimate technical manipulations.

As a result of this approach, the cryptographic keys which are necessary to decrypt the files have to be effectively and reliably protected against any unauthorized access by third parties, in particular also access by consumers. This can be implemented particularly advantageously by content providers putting on the market, or having other interested companies put on the market, special equipment whose functional reliability the service provider trusts and in which, in particular, cryptographic keys are included, preferably for example in special sealed assemblies, in which suitable technical measures ensure that the cryptographic keys stored in them are deleted instantaneously as soon as an attempt at manipulation is detected.

The embedding of watermarks in digital content does not, in itself, yet provide a sustained basis for a practical way of billing for the use of media by consumers. This also requires, on the part of the service provider, monitoring of the level of equipment by means of which consumers bring about the use of the digital content. In this context, the equipment whose functional reliability the service provider or providers trust is constructed in such a way that said equipment filters out the steganographically embedded copyright information and evaluates it in a suitable way in order to effectively prevent unauthorized use processes, in particular unauthorized reproduction.

An example of such a technical infrastructure is known from the SDMI (Secure Digital Music Initiative) project.

Generally, devices and methods which have the purpose of technically implementing the monopoly position, according to copyright law, of the copyright holder or his legal successor with respect to digital content are referred to as “Digital Rights Management Systems (DRMS)”.

Technical concepts for DRMS are known, for example, from U.S. Pat. No. 6,112,181 as well as from U.S. Pat. No. 6,138,119.

However, such a closed technical infrastructure with a DRMS which, on an effective and sustained basis, prevents the consumer from making any use of digital content which is not authorized by the content provider does not yet solve the problem of permitting as far as possible flexible distribution of, billing of and payment for digital content both over the Internet and by means of physical data carriers such as CDs.

Nevertheless, in a method according to the invention for distributing, billing and paying for digital media content, as well as in a corresponding device, providing a connection to a DRMS which is cryptographically protected against misuse represents only one preferred form of implementation; such a cryptographically protected DRMS is not absolutely necessary.

DRMS with which charge scheme information can be added to digital content by means of suitable technical concepts are known. For example, the XrML (Extensible rights Markup Language), which is based on XML (Extensible Markup Language) and whose specification can be obtained at http://www.xrml.org/, contains measures for configuring charge scheme information in a form which is suitable for data processing systems. However, such approaches still do not satisfactorily solve problems arising in the area of the technical execution of billing and payment processes.

As things stand, such closed systems including a DRMS will gain acceptance on the market only if they also provide the consumer with perceptible advantages because the presence of the DRMS at first tends to be viewed as a hindrance by the consumer. However, it is also not at all the case that consumers would not be prepared to pay charges to the content provider for the use of digital content; what is significant is rather the fact that the modalities of the billing and payment processes do not correspond to customers' wishes. In this respect, there are considerable shortcomings with the present state of the art.

One of the problems of previous technical systems for distributing, billing and paying for digital content has been that they are based on concepts of a purchasing charge scheme or subscription charge scheme which are too inflexible.

For example, systems are known in which, for example by means of credit card payment, it is necessary to pay a full purchase price before a file constituting a digital content can be downloaded from a server. This leads in particular to a situation in which previous free-of-charge viewing of the digital content by the consumer to determine whether it is suitable, pleases him and so on and so forth is no longer possible. This presents a considerable barrier to the acquisition of a digital content by purchasing as if the customer is not satisfied it is generally impossible to reverse the purchase since, in contrast to, for example, the purchase of a physical book or a CD, it is very difficult reliably to rescind from the consumer the relevant right of disposal over the file which has been supplied to him as a copy.

On the other hand, systems are known which permit use-dependent distribution of, billing of and payment for digital content using the “video on demand” method. However, such systems have the disadvantage that the detailed nature of the billing process is associated with the presence of a data link between the terminal (client) and a server of the content provider. Although the costs for data transmission using modern telecommunications equipment are continuously dropping, it is currently unrealistic to assume that when consumers use digital content they will always have uninterrupted and secure access to telecommunications networks at low cost.

An important social aspect relating to the use of media is the option of the consumer to be able to act anonymously when acquiring media, for example by purchasing physical media for cash payment at a kiosk. Known digital distribution, billing and payment concepts using data traffic networks such as the Internet in particular are based on the possibility of identifying the individual consumers. There is a need for an improved technical infrastructure for distributing, billing and paying for digital content in which the consumer can also act anonymously.

It is known that both the market for digital content and the market for technical equipment with which digital content can be presented to the consumer in the form of sensory perceptions are characterized by a level of competition which is giving rise to a wide variety of different technical embodiments of this technical infrastructure. However, for the customer it is a significant disadvantage if this diversity also gives rise to a large number of billing and payment systems. In practice, the result of this diversity is that the consumer is expected to enter into numerous individual contracts with providers of payment systems, for example credit card companies, companies for mobile-radio-based payment systems and others. The level of acceptance of technical infrastructures for the controlled distribution of, billing of and payment for digital content is perceptively reduced by these disadvantages.

The object of the invention is therefore to specify a device and a method for distributing, billing and paying for digital content in which the abovementioned disadvantages are diminished or overcome and in which, in particular, a more finely detailed billing process is possible without a permanent data link to a billing server, for example.

The object is achieved according to the invention by means of the features of the independent patent claims. Advantageous refinements of the invention are contained in the subclaims which are respectively referred back to said claims.

The solution according to the invention permits an improved technical infrastructure for the distribution of, billing of and payment for digital content, which infrastructure permits the implementation of a partial or total departure from the rigid connection between the use of media and the purchase of material data carriers such as CDs, DVDs or video cassettes. According to the principles of the conventional use of media, the consumer acquires, through a purchasing transaction, a single copy of a physical data carrier with content recorded on it, and he can use said copy at his own discretion:
on the one hand, this approach leads to a situation in which the full purchase price is charged even if the consumer uses only a part of the content stored on the data carrier.
In addition, the distribution of media content through the sale and marketing of physical copies requires complex and costly logistics for the manufacture, storage and retailing of the data carriers.
However, on the other hand, the physical nature of the data carriers permits the billing of the charges to be paid by the consumer to be handled comparatively easily, provided that the uncontrolled duplication of the data carriers is sufficiently unattractive for the consumer, for example in view of the effort involved in making copies or in view of unavoidable decreases in quality levels such as inevitably occur when analog copies are made of content on audio or video cassettes.

Although the high transaction costs due to the physical nature of data carriers are automatically eliminated by the changeover to the nonphysical distribution of digital content over data networks, at the same time any possibility of distinguishing between the “original” of a file representing digital content, which was legitimately acquired through a purchasing transaction, and copies, which were manufactured virtually without effort or without incurring costs, is lost. When files are distributed digitally over data traffic networks such as, in particular, the Internet, the distinction between “original” and “copy” no longer makes any sense whatsoever.

The solution according to the invention is therefore based on the approach that in a digital economy the purchase of copies of a file representing digital content, with the subsequent right of disposal of the consumer acquiring the copy, which right follows logically from the purchase, must be replaced or at least supplemented by the concept of the granting (generally for payment) of rights of access and use (“access rights”) to the consumer, who however is as a result no longer able to exert the relevant right of disposal over a data carrier which is typical of its possession.

As a result of this paradigm change away from purchase and ownership and toward temporary granting of rights of access and use,
on the one hand a solution is provided to the problem that files which represent digital content can be copied at will since a suitably configured technical infrastructure means that the possession of (“original”) files by the consumer is no longer decisive for the use process; whereas in fact in the context of the solution according to the invention the files as such can in principle be copied and distributed at will by the consumer without adversely affecting the interests of the owners of the rights, according to the inventive solution, only the critical access-rights information which is necessary to use the content of the files now in turn has to be kept strictly under control using technical means;
on the other hand, the risk arising from the dependence of the consumer on the continued granting of rights of access and rights of use by the service providers potentially becomes greater because, in contrast to the conventional model of purchasing and ownership, the model of access and use is based on the assumption that the consumer can continue to have access to a service provider who is willing, ready and also actually able to provide the service to which the customer is entitled on the basis of rights of access and use. If the service provider, for whatever reasons, closes down his business or discontinues marketing a specific content, for example for economic reasons or in response to external pressure, the consumer is no longer able to access his acquired copy, which he has taken into his possession and archived, for continued consumption and use, something which would be possible with the purchasing and possession model.

The solution according to the invention therefore provides, in particular, a technical infrastructure with which a concept of access and use is made technically possible as a replacement of, or supplement to, the purchasing and possession model:

The aspect of integrating a card module into a solution according to the invention as explained in more detail below also makes it possible to synthesize “use” and “possession” as the right of use can be tied to a physical object which is difficult to duplicate and furthermore incorporates for the consumer in a perceptible form the rights of use which are transferred to him.

By virtue of the advantages of the solution according to the invention it is possible to make charge-incurring concepts for the use of digital concepts by the consumer more attractive in comparison with free-of-charge file sharing facilities as the consumer is provided with more than just a file which incorporates a digital content:
on the one hand, a uniform quality standard is ensured, i.e. in contrast to noncommercial free-of-charge file sharing facilities, the consumer does not need to allow for files which have been conditioned in a technically inadequate way, and
by virtue of the concept—explained in more detail below—of the status rights and its technical implementation, it is possible, at the commercial level, to configure products which provide the consumer with attractive added features, above and beyond the file which represents the digital content.
   Technical Portal Solution

A first aspect in conjunction with the invention is that the distribution of, billing of and payment for digital media content can be carried out for a large number of content providers and for a large number of consumers by means of one technical portal data processing device. In particular, wide area networks (WAN) can be used both by content providers to load files constituting digital content onto the portal data processing device, and also by the consumer to download said files from this portal data processing device. Here, in particular two embodiments are provided:
selective individual transmission of specific content “on demand” from the portal data processing device to a specific device which is operated at the consumer end, and
nondirected transmission of specific content by “broadcast” techniques from the portal data processing device to a nonspecific number of devices operated by a set of consumers.

The portal data processing device can also manage rights of access and use and collect billing data from the devices which are operated by the consumers, and on the basis of this billing data it can perform the billing both of the charges for use which are to be paid by the individual consumers as well as the billing of the royalties to be paid to the individual content providers. Finally, the portal data processing device can also carry out the corresponding payment processes.

It is particularly advantageous if the portal data processing device is operated in a mode in which content of numerous owners of rights are marketed jointly:
On the one hand, the consumer is spared the need to enter into a number of individual contracts with owners of rights; all that is necessary is a single global contract with the portal operator.
On the other hand, the portal data processing system can be set up to be a content archive for all the files with digital content which have ever been marketed, as a result of which the portal operator is placed, in comparison with the consumer, in a position of assuming a type of “guarantor position” with respect to the further availability of the service which is associated with the right of access and use. Even if the owner of the right has dispensed with a certain content and does not wish to continue managing and archiving the respective files (referred to as “abandonwave”), the consumer can be provided with a consideration, in accordance with his rights of access and use, via the portal data processing device.

The portal data processing device can also be configured in such a way that it can be operated as a component of “Peer-To-Peer” file sharing facilities. In such a context, the files which incorporate digital content are held available for retrieval on, for example, client computers which are operated by the consumer. The management of rights of access and use and the functions relating to the billing and payment then typically remain with the portal data processing device.

A second aspect relating to the invention consists in the fact that the billing and/or the payment of charges which have been incurred for the use of digital content does not necessarily need to be configured so as to be synchronous with the use process itself. That is to say, depending on the credit policy of content providers or billing companies, the consumer can be allowed to use the digital content to a specific degree by means of a suitable device according to the invention without there having to be an uninterrupted data traffic connection to some form of billing center, in particular to the portal data processing device, during this time. For this purpose, during a time interval between two billing times, all the necessary data relating to the use behavior of the consumer is collected locally in order to be able to use it at the next billing time as the basis for billing the contractually liable charge for use. This recorded data is preferably secured, using suitable technologies, against unauthorized manipulations, in particular by the consumer. It is possible to provide for the consumer to have to make a deposit in order to cover the credit risk from processes of the use of digital content which are to be billed later. It is preferable to have a system in which the risk for the content provider or the billing company is limited by the fact that a further use of digital content is prevented if the sum to be paid which has been run up exceeds a specific threshold value. Further use of the digital content is not enabled again until billing and payment have taken place.

Card Module

A third aspect of the invention is that preferably an exchangeable, module-like element, for example a chipcard or a flash memory module, can be used in particular for storing identity information, billing information and payment information.

This module does not necessarily need to be embodied as a card; it is also possible to use other forms, for example ones which are suitable for attachment, for example sewing in or bonding in, to items of clothing.

For the sake of simplicity, the term “card module” will be used below; however, other forms are also to be expressly considered as included in this.

The card module has an interface by means of which it can exchange data with other devices, in particular with a piece of equipment which is suitable and designed for making digital content perceptible to the consumer by sensory means, said piece of equipment being referred to below as “use equipment”. This data transmission may take place, for example, in a line-bound fashion, by means of electrical plug-type connectors, contact fields or connection lines.

Likewise, the transmission of data can take place in a wirefree fashion by means of a radio link, for example according to the Bluetooth standard, or by magnetic induction or visually, for example using an infrared connection according to the IrDA standard.

A card module can advantageously be used in conjunction with the solution according to the invention
for the distribution of digital content, for example by storing item-specific address information, i.e. reference information about network paths via which digital content can be accessed, or by storing the files representing digital content on the card module;
for billing by storing billing-related data on the card module, and
for payment by storing data on the card module which relates to the payment method and the payment path.

Using a card module also facilitates, in particular, contract bundling as the card module can be used in conjunction with a number of individual pieces of equipment for which otherwise it would be necessary to conclude separate contracts for use and payment. DRMS

A fourth aspect of the invention is that all the files which incorporate digital content are preferably distributed in encrypted form. As a result, it is possible, in conjunction with a cryptographic DRMS, to effectively prevent unauthorized use of digital content. With respect to the use of a cryptographic DRMS it is necessary to store the key or keys, the cryptographic keys which are necessary for lawfully decrypting the files representing digital content, in a suitable technical way so that the consumer can use the content which have been distributed in encrypted form. In this context, when a card module is used, two cases are to be differentiated:
when a card module is used, the multimedia items can, on the one hand, be encrypted in a decoder-specific way, not in a card-specific way, i.e. the card is used for providing authorization with respect to the decoder, whereas the data of the files representing the digital content to be used is decrypted by the use device by means of cryptographic decryption keys stored in the decoder, and is converted into a form which can be perceived by the senses. In this context, the card module preferably provides authentication for itself to the use device by means of suitable cryptographic protocols using the data transmission interface.
when a card module is used, the multimedia items can, on the other hand, be encrypted in a card-specific way, not in a decoder-specific way, i.e. the card is used to store the cryptographic decryption keys which are necessary to decrypt the digital content, it being possible to transmit these decryption keys to the decoder via an adequately secured data transmission link. The data of the files representing the digital content to be used can then be decrypted by the use device by means of the cryptographic decryption keys which are transmitted by the card module, and converted into a form which can be perceived by the senses.
   Flexible Charge Scheme Models

A fifth aspect of the invention is that the consumer of digital content is registered in a finely detailed way and billed fairly. This means in particular that a possible way is provided of enabling the consumer to pay a charge to the content provider only for those portions of multimedia items which he has also actually used. If only a part of a multimedia item is used, it is possible to provide a charge scheme which also demands only a part of the charge which was set for use of the entire item. Here, a distinction is made between
an item-specific item charge level in which the billing is carried out independently of the device according to properties of the item, and
an equipment-specific equipment charge level in which the billing is carried out independently of the item according to properties of the equipment, and
hybrid charge level structures composed of an item charge level and equipment charge level in which, for example, a higher charge can be demanded for an item if it is used on a piece of equipment which permits better presentation quality (larger screen, better sound quality or the like).

Basic instruments for the item charge level are
time-specific billing, for example listening time used in the case of audio content;
volume-specific billing, for example the number of pages of a page-oriented text content which have been used;
hybrid billing models, for example volume-oriented billing which is modified to have portions with a time-specific charge scheme, in the case of a page-oriented text content.

For example, the charge for use which is provided for use of half of the volume of a digital content could be set at half the charge provided for use of the entire content. In the case of a digital content in the form of a text item (book), measurement could be carried out for example by reference to the pages used in relation to the overall number of pages. However, other nonlinear charge scheme models are also possible. In addition, this makes it possible to differentiate as to whether the consumer would like to use a multimedia item as often as desired, like a conventional purchased item, once payment has been made on a single occasion or whether limitation of the use processes in terms of number, for a significantly reduced charge, is considered. It is also possible, for example in the case of a text item, to determine the charge as a function of how often its individual pages of text have been used by the consumer.

If the charge for the use of a page-oriented text item is calculated exclusively per page-display process, there is a serious disadvantage that the intuitive search process of “leafing through” is billed in an extremely costly way for the consumer as in this process a large number of pages may possibly be displayed in a short time without the consumer actually having been able to use the respective page content, as is assumed in this charge scheme model. If, on the other hand, the charge for the use of a page-oriented text item is calculated purely as a function of time, a slow reader would be unacceptably disadvantaged as a consumer in comparison with a fast reader. An advantageous complex charge scheme model can provide, in particular, one predetermined page-related charge per page displayed and a predetermined orientation time is fixed, it being assumed that a page cannot be absorbed by the reader until this time has expired. This permits a nondiscriminatory leafing function. Furthermore, each page can be assigned a predetermined reading time, after the expiry of which it is assumed, in terms of the charge scheme, that the consumer will have been able to completely absorb the page content provided. If the time period for which a specific page is presented on the display consistently after the expiry of the orientation time is shorter than the predetermined reading time, the system acts, for example, as if the reader had only used a proportion of the content which corresponds to the ratio of the actual display time, in excess of the orientation time, to the predetermined reading time. For the remaining (residual) proportion of the reading time, the reader is assigned a time credit, i.e. if the consumer displays the same page again, a renewed page use charge is demanded of him, once a new orientation time has expired, only if the credited residual proportion time has expired. It is also possible to collect all the time credits which have arisen due to premature termination of the reading of a page in a user-specific time credit account. Further pages can then be considered free of charge from this account.

In the case of equipment charge levels, in particular time-dependent enabling charge levels are possible in which, for example, a specific individual piece of equipment is enabled for the use of any desired items for 24 hours.

Even if the represented aspect relates to a technical infrastructure which permits fair and finely graduated billing for the use of digital content by the consumer, this of course does not preclude charge schemes which are based on flat rates. This applies both to unit charge levels and to equipment charge levels. Billing

A sixth aspect of the invention is that the use of the digital content is billed on the basis of the charge scheme models. For billing, a specific amount to be paid by the consumer in a currency which is recognized as a payment means or a fraction or a multiple of other value units is determined on the basis of the details of the use actions performed by the consumer, on the basis of the respectively applicable charge scheme model. For billing, in particular two secondary aspects are significant:
on the one hand, it is possible to prepare, for the consumer, an invoice-like listing of the use processes of digital content which he has carried out, for example, in a billing period, from which the consumer can see how the final amount is made up.
On the other hand, it is possible to produce, for the content providers, a listing indicating how often, and if appropriate also at what charge levels, specific parts of their digital content have been used, and what overall charge to be paid to the content provider was calculated on this basis.

Consequently, the solution according to the invention makes it possible to provide a billing service for the use of digital content not only for the consumer but also for the content providers in a fact-based fashion and without flat rates.

Status rights

A seventh aspect of the invention is the storage of data features corresponding to status and priority rights (“privileges”) which the consumer can acquire by completing use processes which are made possible and billed using the card. It is possible, for example, to provide for the user to be able to use for free those pages of a text item which he has used sufficiently often on a charge-paying basis in the past. It is also possible to provide for the consumer to be allowed discounts as a function of previously executed use processes. Status rights may be allocated, in particular, on the following level:
Consumer-specific status rights, i.e. specific status rights are tied to the identity of the consumer or, if appropriate, to a pseudonym identity of the consumer, but not to a specific, digital content (“item”). An example of this category of status rights are the turnover sums which have been incurred in total in the past and which can be used, for example, as the basis for a discount.
Consumer-related, item-specific status rights, i.e. these status rights are tied simultaneously both to the identity of the consumer or to his pseudonym identity and to a file which represents a digital content (“item”). An example of this category of status rights is an item-specific statement that a particular consumer has already used a particular page-orientated text item so extensively that according to the charge scheme he is now given the right to use this text item without further restrictions and without further billing of use actions.
Item-specific status rights which are tied to consumers can also be tied to a group of items, for example all items which are marketed by a specific content provider, for example by a specific publishing house.
Substatus rights which are tied to the consumer and to an item. These status rights are tied not only to the identity or pseudonym identity of a specific consumer but also to a specific part of an item. An example of this category of status rights is the right assigned to a specific consumer of being able to use, with respect to the use of a specific page-oriented text item, specific individual pages of the item without additional subsequent billing as a maximum charge, according to the charge scheme, has already been paid for the use of these pages in the past.

Status rights respectively form the basis for a claim, by the consumer to which they pertain, to a specific service which, depending on the circumstances of the individual case, may have to be provided, for example, by the content provider or by the operator of the portal data processing device. The possible service in this context is, in particular:
the payment of sums of money or other value units, if appropriate also when setting them off against existing charges arising from other use processes which have already been carried out or are to be carried out in the future by the consumer;
free-of-charge use of specific digital content with or without time restrictions;
discount for other media consumption actions by the consumer, for example for cinema visits, visits to festivals etc., in which case in particular various forms of marketing of one and the same item can be combined, for example when a discount is given for a conventional book purchase if the film associated with the book has been consumed digitally by means of the solution according to the invention;
provision of a physical data carrier with specific digital items, for example a CD-ROM with a specific music title if said item has been consumed a sufficient number of times (i.e. at least one predetermined number of processes) in return for payment using the solution according to the invention.

The acquisition of status rights by means of a consumption history can
take place offline, i.e. the device operated at the consumer end determines, from the consumption data, the status rights accruing to the consumer by direct reference to the consumption history, or
take place online, i.e. the portal data processing device does not determine the status rights accruing to the consumer until after the consumption history of the consumer has been transmitted from the device operated by the consumer to the portal data processing device. In this variant, there is the advantage that the consumer is motivated to make an online connection for the transmission of the consumption history as frequently as possible.
   Payment Method

An eighth aspect of the invention is that, on the one hand, the payment of the incurred charges can be adapted to known payment systems which have been introduced onto the market, but on the other hand the payment is preferably possible by means of technical measures both
anonymously, i.e. without knowledge of the identity of the consumer and without the possibility of being able to link a plurality of media use processes by accessing a pseudonym,
pseudonymously, i.e. without knowledge of the identity of the consumer, but with the possibility, by accessing a pseudonym, of being able to link a plurality of media use processes, as well as
with all the details about the identity of the consumer being revealed, i.e. with the name and address of the consumer being revealed.

Within the scope of the solution according to the invention it is possible to provide, in particular, for:
payment on a credit basis, i.e. the consumer must store an amount of money before the consumption actions are accepted, no further use being made possible, through technical disabling means, as soon as the credit has been used up, or
payment in arrears, i.e. the content provider or the operator of the portal data processing device provides an advance performance by permitting the consumer to use his service without previously storing a credit, the consumer having to pay after billing has been performed.

Also in the case of payment on an arrears basis it is possible to provide for a technical disabling means to prevent further use actions on the part of the consumer when a specific amount for payment in arrears is outstanding.

In principle, the processing of the payment can be performed using conventional channels such as a credit card, debit note or bank transfer. However, a variant of the solution according to the invention in which the payment process is performed by interacting with a card module (see the third aspect above) proves particularly advantageous. In this context, the data relating to the payment path which has been agreed with the consumer can be stored digitally on the card module and used by applying online payment techniques.

Appliances with Reduced Complexity

A ninth aspect of the invention is the use of use devices (appliances) with reduced complexity in order to make digital content perceptible by the senses of the consumer. For some time, data processing devices which have been interconnected by the Internet or other telecommunications systems have been used not only by companies but also by end users for participating in “e-commerce” in order to carry out commercial transactions of all types.

The use of the Internet and of other telecommunications systems such as, for example, proprietary online systems by the end user is almost always carried out using a personal computer, also referred to as PC, or a comparable piece of equipment, for example a workstation, of a portable computer (notebook) or of a piece of mini equipment which is to be held in the hand (palmtop).

Personal computers and such comparable pieces of equipment have the advantage that the scope of functionality which can be made available by them to the end user is not determined solely by the hardware used but also can be changed in an extremely flexible way by loading various programs at any desired time. For example, it is possible subsequently to download and install a specific piece of software if the end user wishes to use additional functionalities.

The disadvantage of this universality is the burgeoning complexity of PCs or workstations which are equipped with customary operating systems such as Windows or Unix. The end user must firstly acquire a considerable amount of background knowledge about the structure and the functional relationships of the complex overall system in order to be able to use in a practical way the potential universality provided in said system, in order to carry out specific tasks.

It becomes apparent that considerable groups of end users or prospective end users do not wish to use, or cannot use, telecommunication services, in particular for the purposes of e-commerce, because they are not capable of mastering the complexity of PCs or comparable pieces of equipment whose use has hitherto been de facto a necessary precondition for participation in or use of telecommunication services.

The technical problems which occur for the end user with conventional data processing devices are varied. They generally start with the fact that it is necessary not only to set up the operating system but also to configure and finally establish a link to a telecommunication system, for example the Internet. The modalities of the access to the Internet here vary, inter alia, locally depending on the country or region and also from provider to provider at the same location.

Finally, once a networked data processing device which is capable of use has been obtained, the end user is presented, for example on the Internet, with an unstructured profusion of offers for commercial activity. In conventional data processing devices, the end user himself has to work through and acquire extensive knowledge from references in order to be able to use the offers which are of interest to him via the telecommunications network.

Finally, if the end user has found a provider with which he wishes to establish a stronger business connection, it is generally necessary to take into account numerous particular features for each provider relating to the identification and the authentication of the customer as well as the delivery of the ordered goods and the processing of payments.

In view of this problem, it has previously been suggested to provide extremely specialized data processing devices which are capable of providing only a single functionality or at most a small number of functionalities. An example of this is the mobile phone which is a data processing device which is connected to a telecommunications network and which serves essentially only a single purpose, namely making a telephone call. However, restriction to a single functionality per type of equipment proves cumbersome given the increasing significance of networked data processing devices since the number of different types of equipment required for the various use areas increases too much. When there is an increase in the number of functionalities per piece of equipment using conventional procedures, for example by adding text message calling to a mobile telephone, a level of complexity in terms of the operator control of the piece of equipment which acts as a deterrent for wide groups of users is again reached quickly.

An important field of application of e-commerce relates to the distribution of files which may include data processing programs, texts, diagrams, multimedia items or video animations to customers by content providers. In this field of application there is the particular feature that the exchange of performances between the content provider and the customer can take place in a completely virtual fashion as both the catalogue of goods and services, the ordering process, the delivery of the ordered goods and the billing can be processed in the form of data which is exchanged via telecommunications devices. A disadvantage of previous approaches to solutions for distributing items is that the customer generally has to acquire a copy of the item as a purchased item even if he only wishes to use it for a brief time or only wishes to use parts of it.

The invention therefore relates to a technical infrastructure which is suitable for such purposes.

Telecommunications Cards

A tenth aspect of the invention is the approach in which the technical infrastructure according to the invention for distributing, billing and paying for digital media content, including a card module in conjunction with SIM cards and similar devices, is implemented in mobile communications radio networks, for example GSM or UMTS. As a result, the functionality of a telecommunications card can advantageously be combined with the functionality of multimedia consumption by virtue of the fact that the card serves at the same time as a card module.

The advantage which is provided by this aspect is particularly that using such a multifunction card it is possible to combine
the distribution of digital content over a mobile radio network,
the identification and authentication of the identity of the media consumer,
the billing for the consumption of digital content, possibly with the interaction of a billing server which can be accessed via the mobile radio network, and
the payment of consumed and billed digital content, in particular with the interaction of the telecommunications service provider,
   in a single application device (“appliance”) in a way which is transparent to the consumer.

Even if the present invention does not preclude the distribution of digital content by means of the sale and marketing of physical data carriers, a virtual transmission is nevertheless more important in terms of minimizing the costs of business transactions. A suitable digital wide area network (WAN) is necessary for this. Mobile radio devices constitute, by definition, a means of accessing a digital wide area network in the form of a digital mobile radio network.

Even if the virtual distribution of digital content by means of wire-bound wide area networks is also completely possible within the framework of the present invention, such wirefree transmission, for example by means of a mobile radio network, appears particularly advantageous as in this case the consumer can carry out his consumption transactions without being tied to a network infra-structure which is linebound and therefore not available everywhere.

The identity or at least pseudonym of a consumer is known to the telecommunications service provider who issues the SIM card. In the case of SIM cards which are used on a credit basis without the need for stored value, the telecommunications service provider must already know at least the name and a billing address of his customer for billing purposes. In the case of SIM cards which allow credit, the telecommunications service provider frequently has information on a specific payment path, for example in the form of a standing order allowing said provider to deduct amounts due from a specific account.

In the case of SIM cards which are issued by the telecommunications service provider as prepaid stored value cards, the charges for the use of digital content can be deducted from the amount of stored value managed by the telecommunications service provider. In theory, pseudonymous or even anonymous services are technically possible in this context. As far as the territory of the Federal Republic of Germany is concerned, pseudonymous or even anonymous issuing of SIM cards for GSM networks is not possible according to the relevant regulations of the telecommunications law which are intended to permit the authorized authorities to monitor the telecommunications traffic without difficulty. However, in other countries this may be different in certain cases.

Video on Demand

An eleventh aspect of the solution according to the invention is the approach in which a specific appliance is provided for distributing, billing and paying for digital content as video on demand. This may, for example, take the form of what is referred to as a “set top box”, i.e. a converter device between a cable television network and a television set. This set top box can also be provided with a digitization device for adapting analog television channels, which device detects, samples and digitizes the analog signal representing a television frame, for example by what is referred to as a “frame grabber” device.

Play and Order

A twelfth aspect relates to a particularly suitable solution for ordering and playing items and can be implemented with an independent inventive idea. Conventionally, virtual items and the like have to be selected and downloaded, or streamed, via the Internet. By means of broadcasting it is possible to broadcast specific items in real time in an encrypted or nonencrypted form at predetermined times and to make them available to the consumer when specific conditions are fulfilled. However, this entails considerable costs for the content provider if films are to be supplied, for example, on demand. As in this case one and the same film has to be transmitted at different times over a plurality of channels in order to be able to implement as it were the “on demand” effect for the consumer, not only is the air interface overstretched but also the transmission is still ineffective. The invention is based on the object of only broadcasting video material in the form of trailers or in abbreviated form with an advert over such channels in order to make the consumers familiar with as many items as possible in one time period. This is in any case already done in the case of radio transmission as the broadcaster has to earn its money by means of advertising revenues. By means of a suitable technical device at the consumer end it is possible to mark such items by making inputs on the device if there is a corresponding uniquely defined identifying facility, for example by means of verbal or written information from a presenter, or technically by adding an item identifier in the transmitted item (analogous to the DaB in car radios). By marking specific items, for example corresponding filters are set up on the reception part of the device. It is possible to broadcast the trailers over days at several intervals. These may be pieces of music (radio), games (gameshow), films (video trailers) etc.

At a later time or on another channel it is possible, depending on the items, to transmit them simultaneously by broadcasting to a large number of consumers, if appropriate in the same sequence of presentation, but this time compressed and encrypted over their entire length. The preset device at the consumer selects, by means of the filters, the desired items by filtering out the undesired items and stores them on a suitable storage medium which is provided for this purpose. If the user is legitimized by corresponding rights, for example by means of a rights card (smartcard), he is able to consume stored items. Charges are preferably incurred only when the items are actually used. The items can also be ordered over the Internet or offline, the items being delivered in this case in an addressed fashion. Charge-incurring transmission of data on the part of the consumer

A thirteenth aspect of the solution according to the invention is the approach in which technical facilities are provided which are suitable and intended for transmitting person-specific data from the field of the consumer, for example relating to his consumption habits, to the operator of the portal data processing system or to individual content providers, the consumer being granted status rights in return for this transmission of data.

The invention is explained in more detail below with reference to exemplary embodiments:

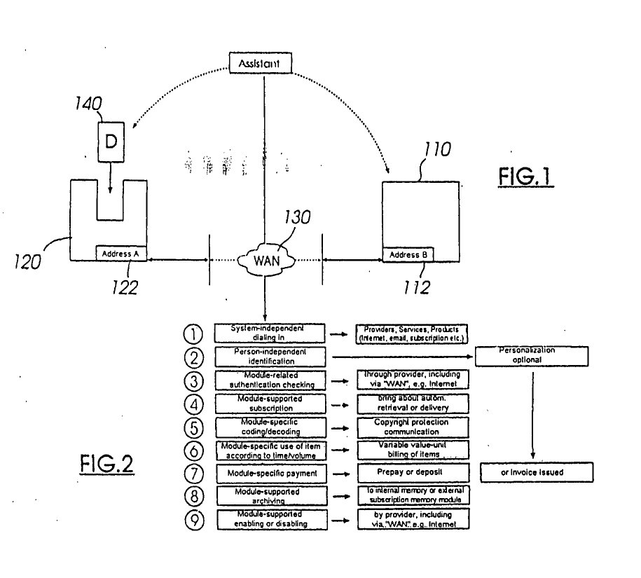

FIG. 1 shows a schematic view of a networked data processing device according to the invention with a server part and a client part,

FIG. 2 shows a schematic view of different aspects during the commercial use of a data processing device according to the invention,

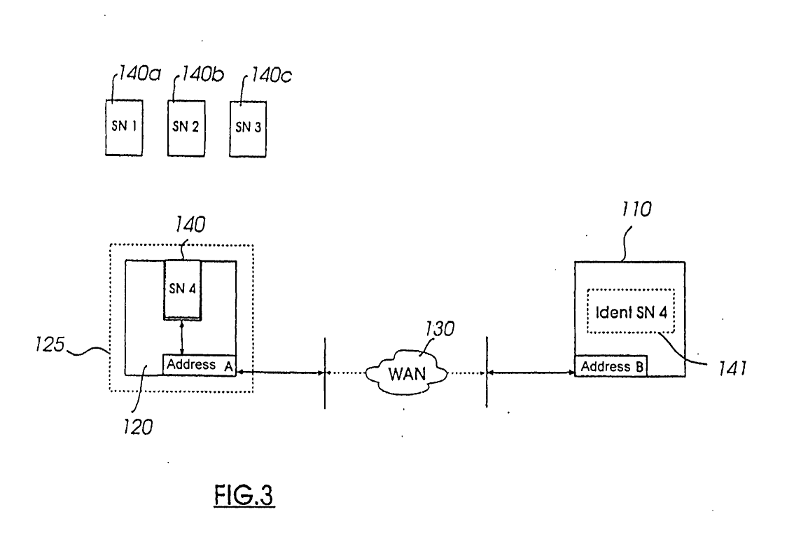

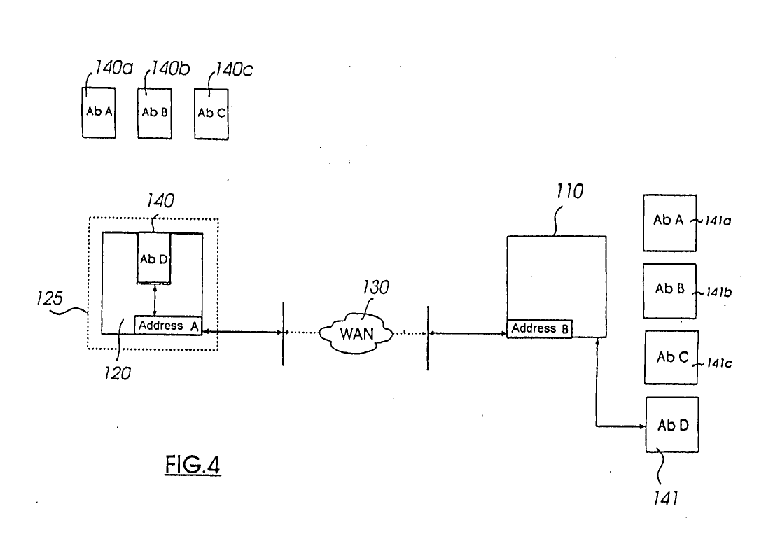

FIG. 3 shows a first application of the invention with reference to a schematic view of a data processing device according to the invention,

FIG. 4 shows a second application of the invention with reference to a schematic view of a data processing device according to the invention,

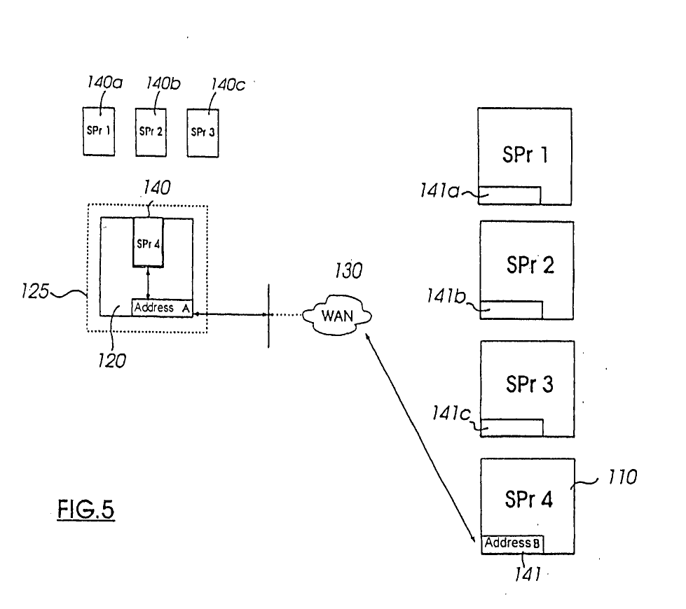

FIG. 5 shows a fourth application of the invention with reference to a schematic view of a data processing device according to the invention,

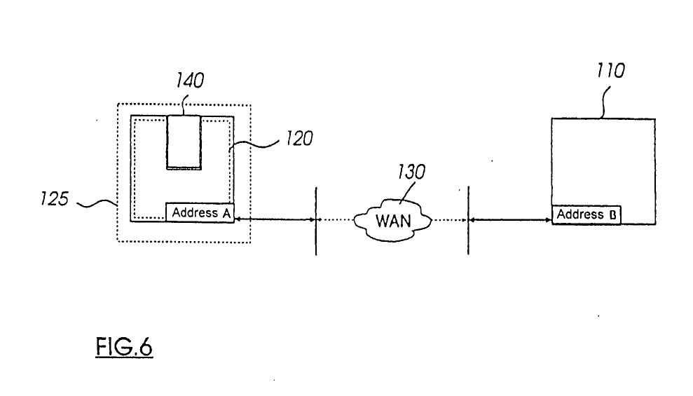

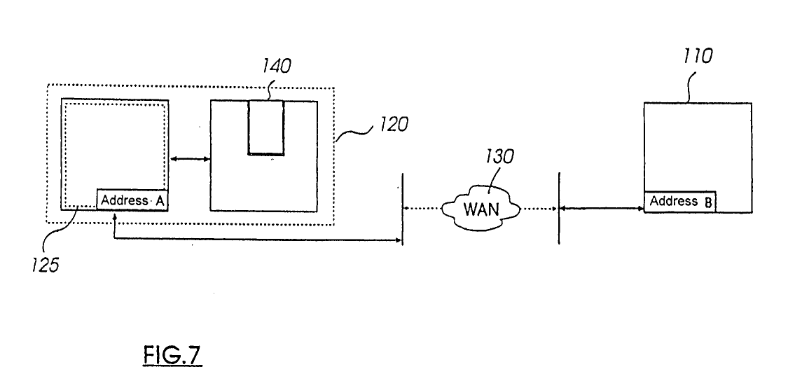

FIG. 6 shows a first variant of an embodiment of the solution according to the invention illustrated in FIG. 1,

FIG. 7 shows a second variant of an embodiment of the solution according to the invention illustrated in FIG. 1,

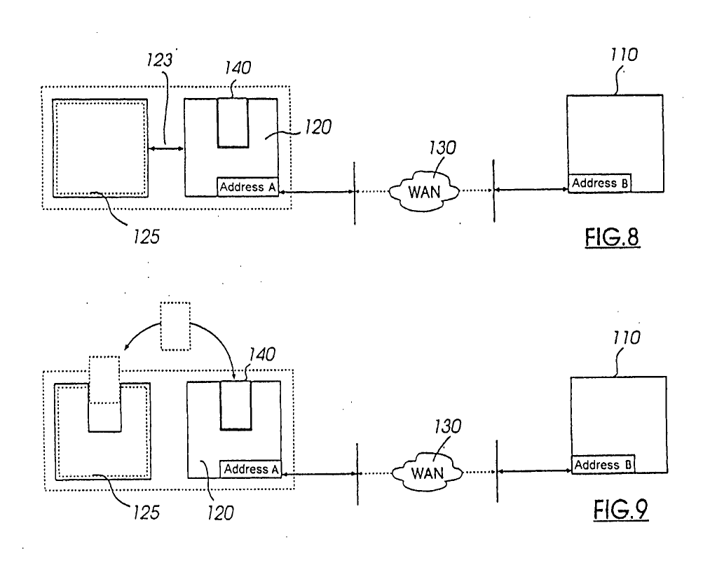

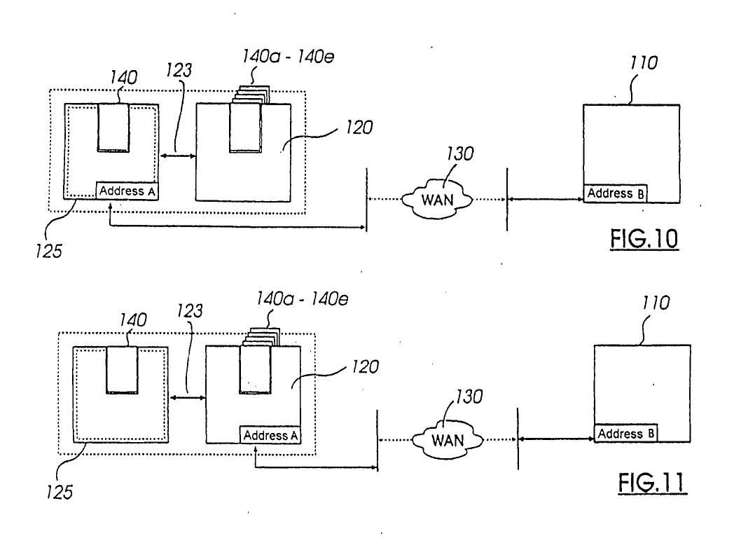

FIG. 8 shows a third variant of an embodiment of the solution according to the invention illustrated in FIG. 1,

FIG. 9 shows a fourth variant of an embodiment of the solution according to the invention illustrated in FIG. 1,

FIG. 10 shows a fifth variant of an embodiment of the solution according to the invention illustrated in FIG. 1,

FIG. 11 shows a sixth variant of an embodiment of the solution according to the invention illustrated in FIG. 1,

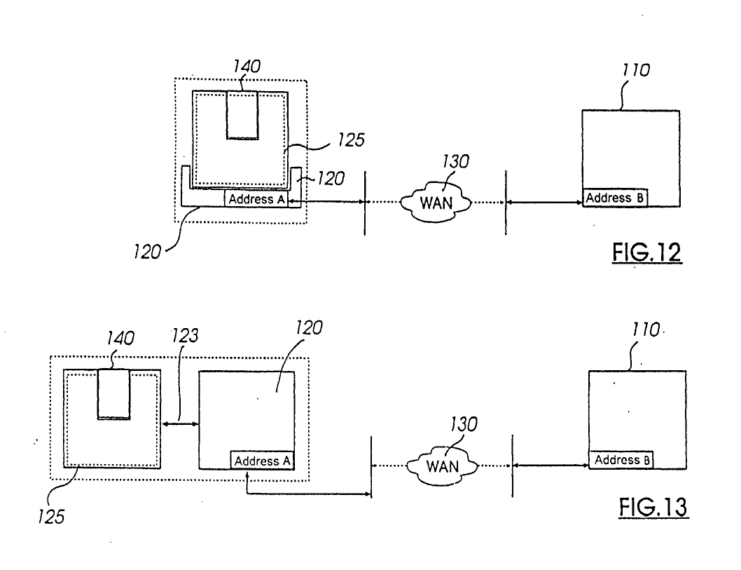

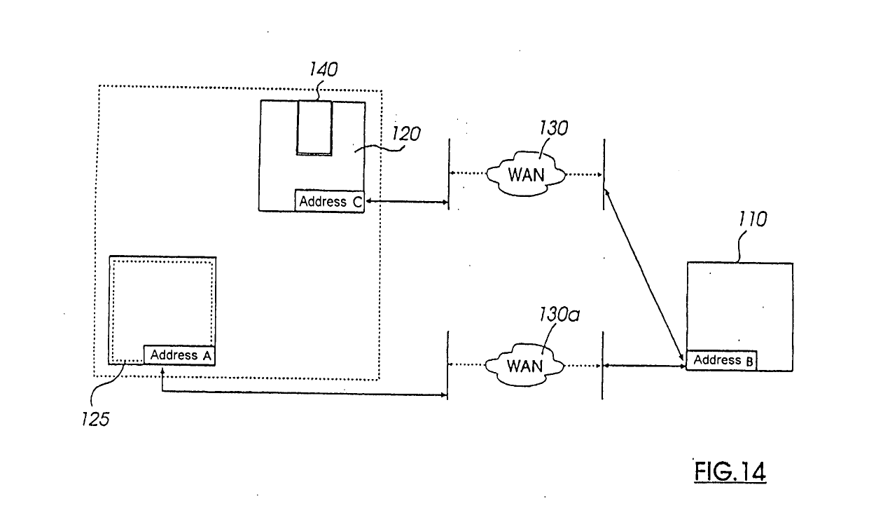

FIG. 12 to 15 show variants of an embodiment of the solution according to the invention illustrated in FIG. 1,

FIG. 16 shows a schematic block-diagram-like illustration of a device according to the invention for distributing, billing and paying for digital media content,

FIG. 17 shows a schematic block-diagram-like illustration of a detail of the device illustrated in FIG. 16,

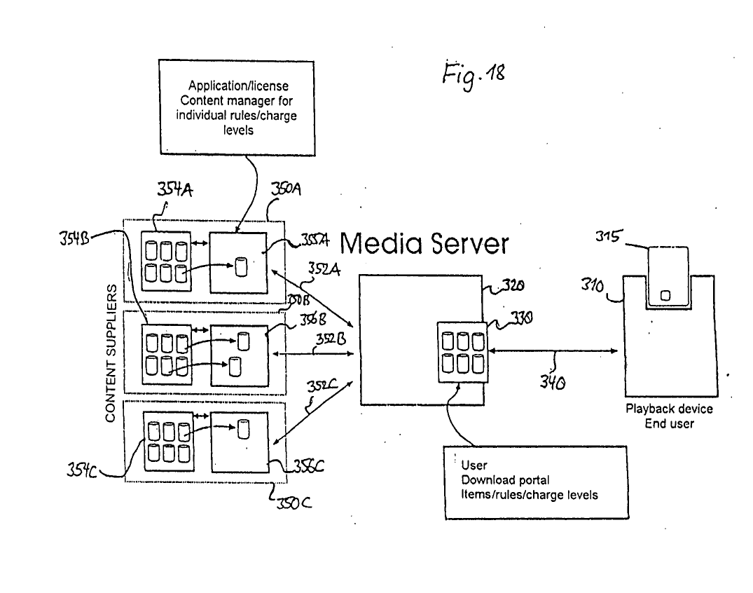

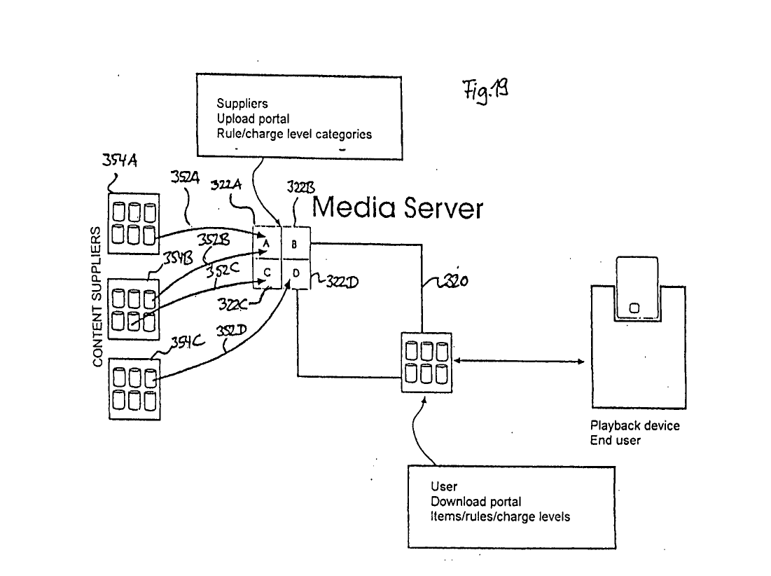

FIG. 18 shows a schematic view of a first exemplary system architecture of a device according to the invention for distributing, billing and paying for digital media content,

FIG. 19 shows a schematic view of a second exemplary system architecture of a device according to the invention for distributing, billing and paying for digital media content,

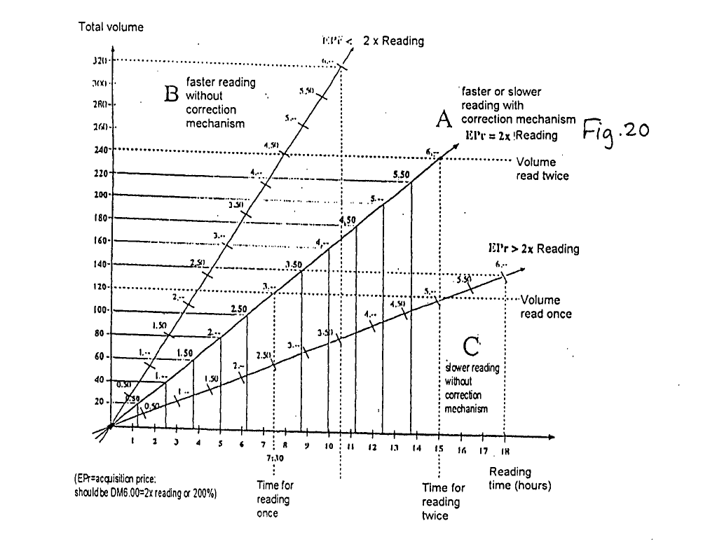

FIG. 20 shows a first diagram for discussing the dependence of the volume of pages of a page-orientated text document, received by the consumer, on the use time incurred in using this page,

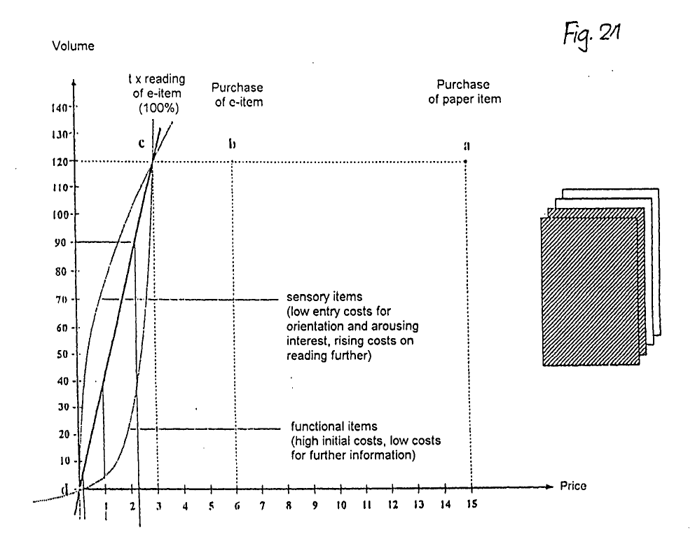

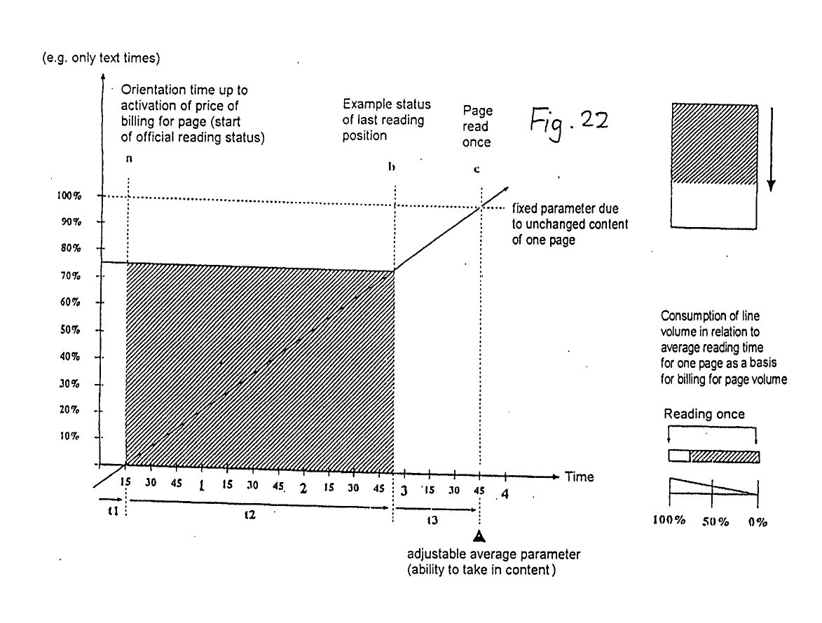

FIG. 21 shows a curve diagram relating to the discussion of the dependence between the intensity of use of an item and the assigned price,

FIG. 22 shows a first diagram relating to the discussion of the dependence of the volume of a page of a text document, received by the consumer, on the use time incurred in using this page,

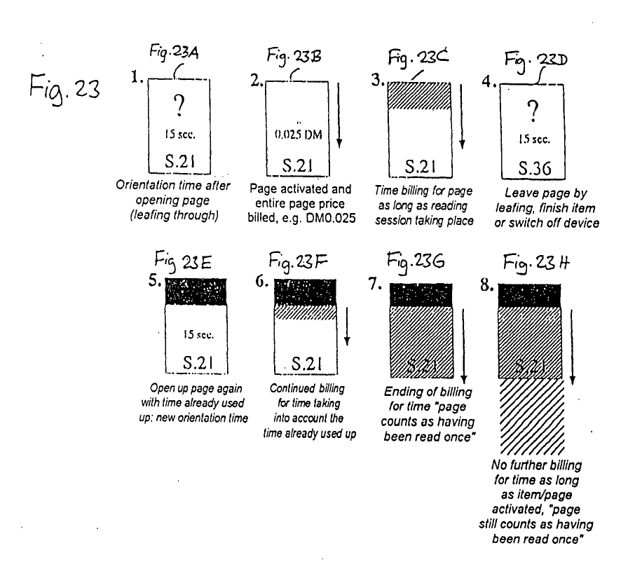

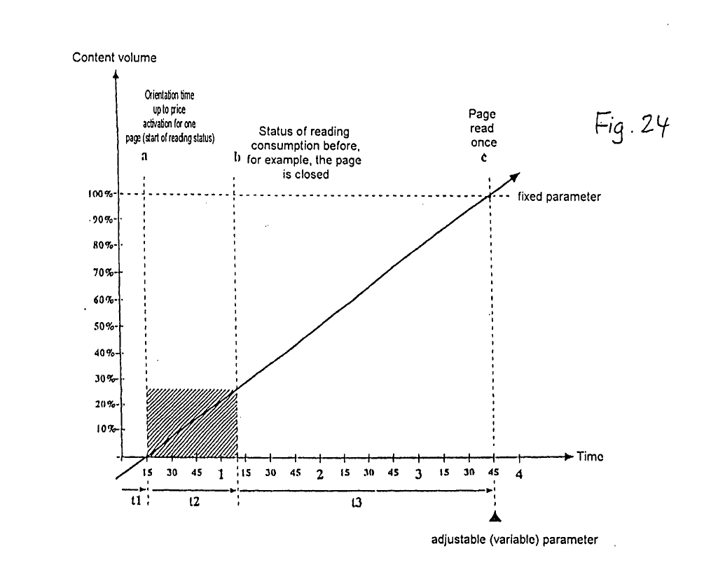

FIG. 23 shows a schematic exemplary view of time profiles when a page of a page-orientated text item is used by the consumer,

FIG. 24 shows a second diagram relating to the discussion of the dependence of the volume of a page of a text document, received by the consumer, on the use time incurred in using this page,

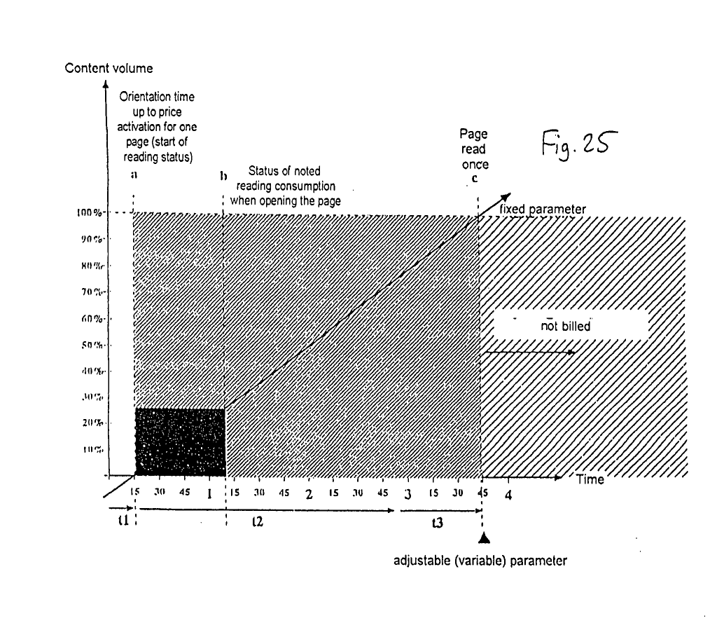

FIG. 25 shows a third diagram relating to the discussion of the dependence of the volume of a page of a text document, received by the consumer, on the use time incurred in using this page,

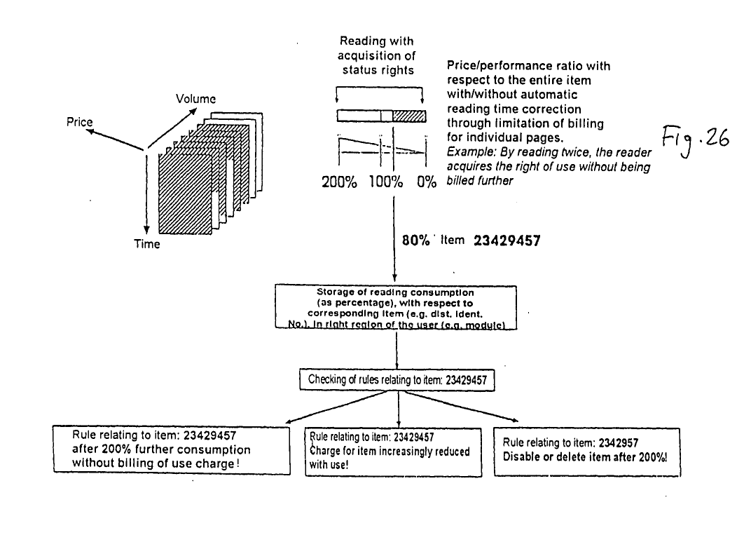

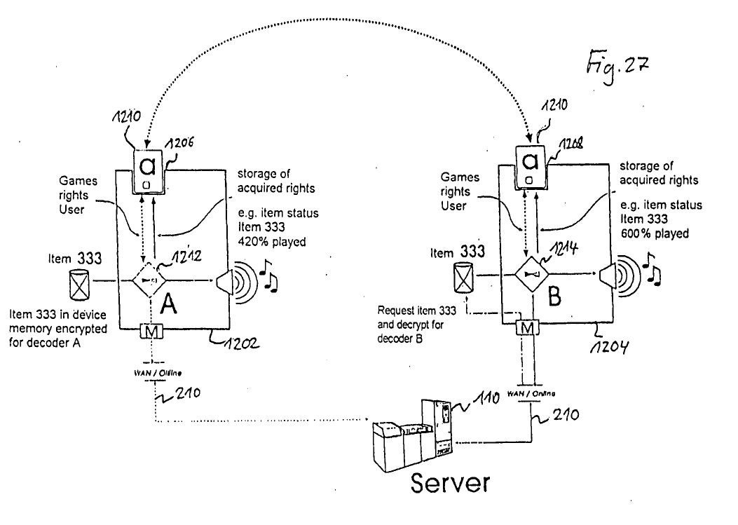

FIG. 26 shows a schematic view of the process of reading with the acquisition of status rights,

FIG. 27 shows a schematic view of a device according to the invention with a card,

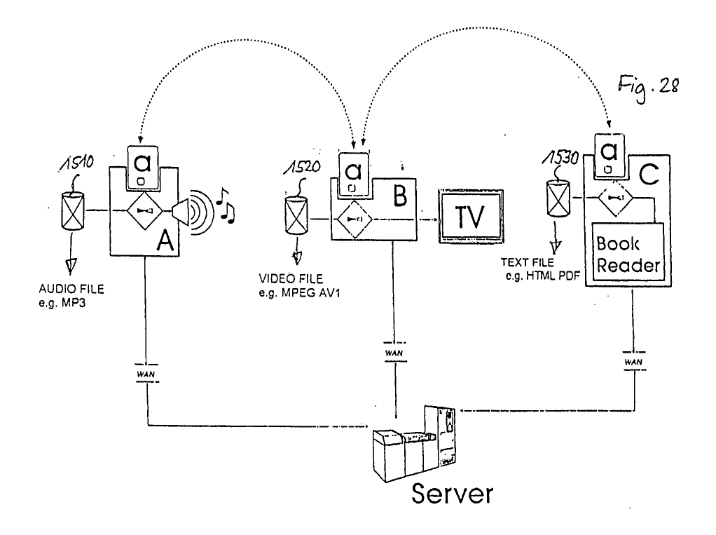

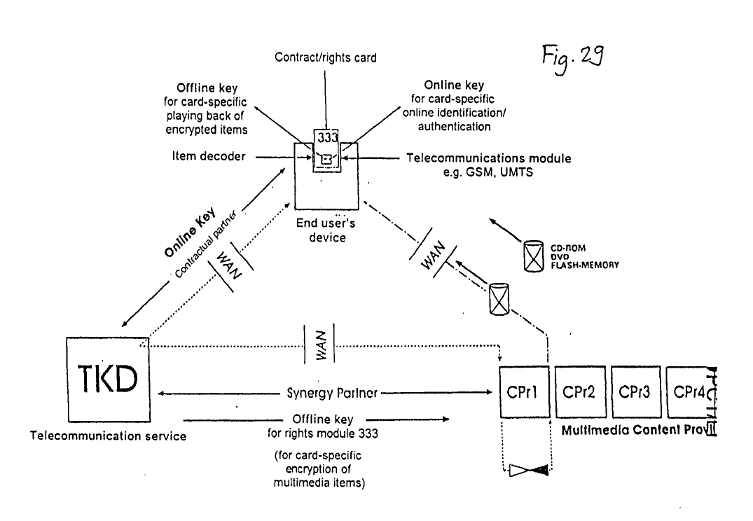

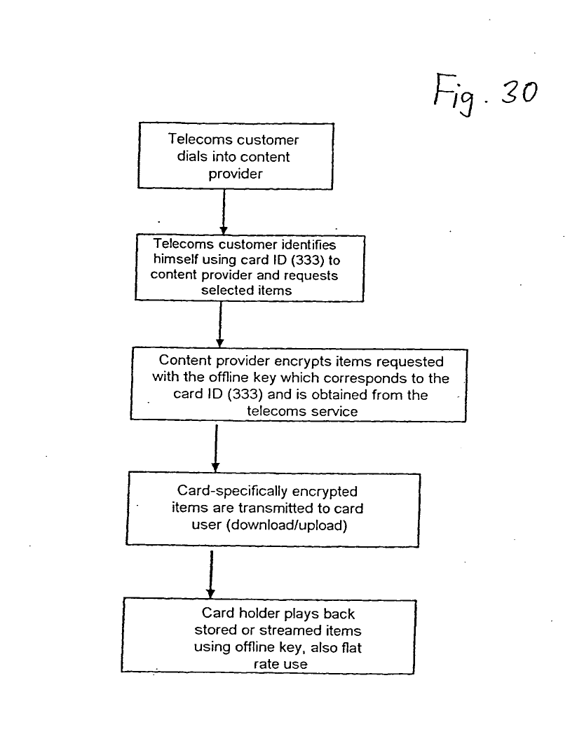

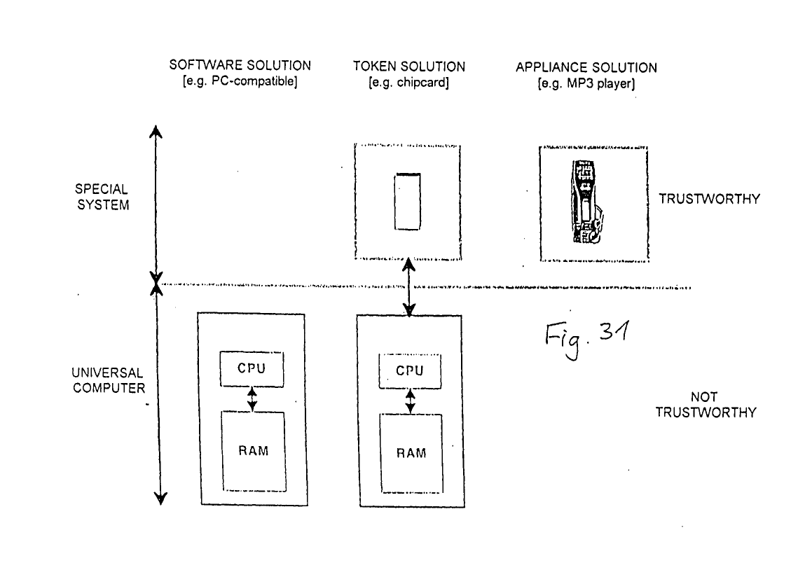

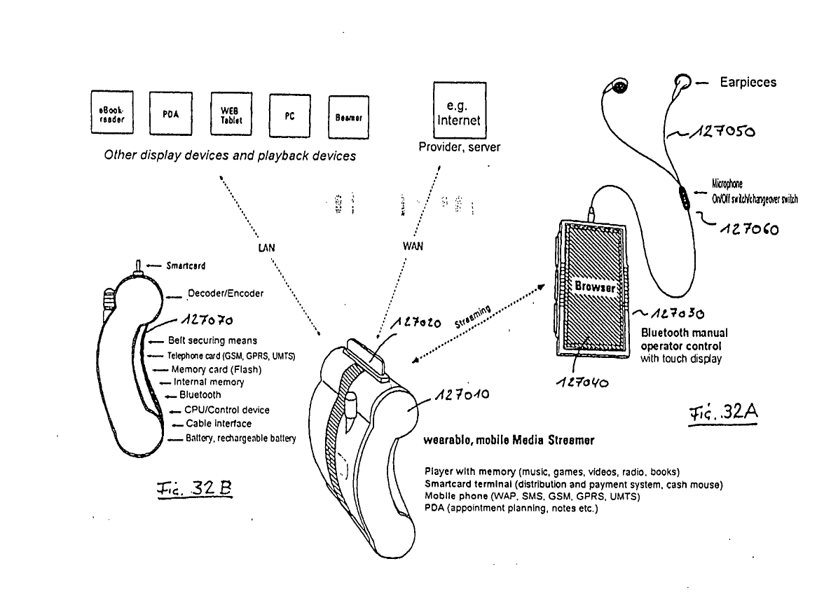

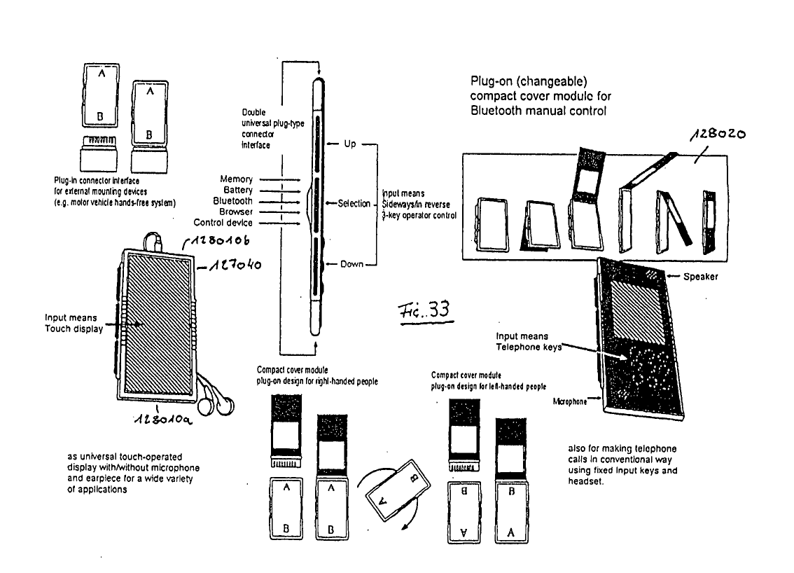

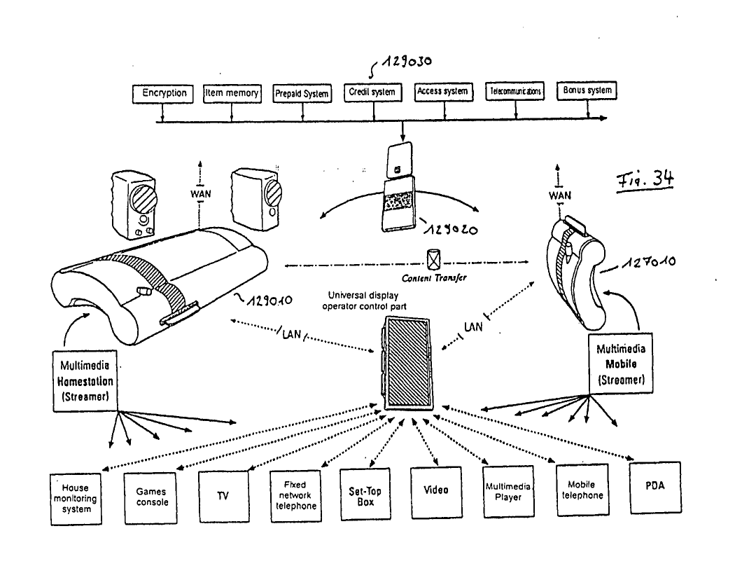

FIG. 28 shows a schematic view of the management and transmission of rights by means of a card module,

FIG. 29 shows a schematic view of a different way of managing and transmitting rights by means of a card module,

FIG. 30 shows a flow chart of a download operation,

FIG. 31 shows a diagram of various possible ways of implementing the invention and its security levels,

FIG. 32A shows a wearable computer with a display and operator control unit for universal communications facilities,

FIG. 32B shows a cross section through the wearable computer according to FIG. 32A,

FIG. 33 shows a handheld part as a universal display and operator control unit for use as a separate piece of equipment (PDA, web browser, media player, telephone and/or remote control) or in conjunction with a wearable computer,

FIG. 34 shows the use of the display and operator control part in conjunction with a home station or a wearable computer,

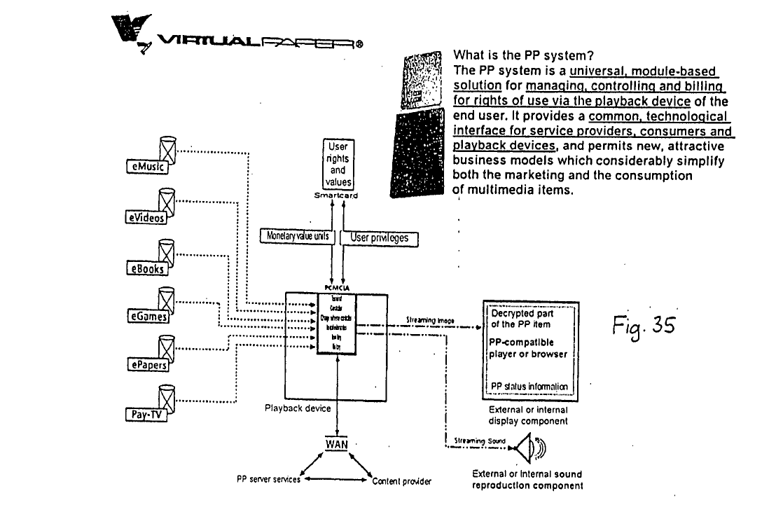

FIG. 35 shows a preferred embodiment of the previously described distribution and payment possibilities (referred to below as play and pay system or PP system) in the form of a PCMCIA card and a smartcard reader in which different formats are accessible by means of a PP module solution,

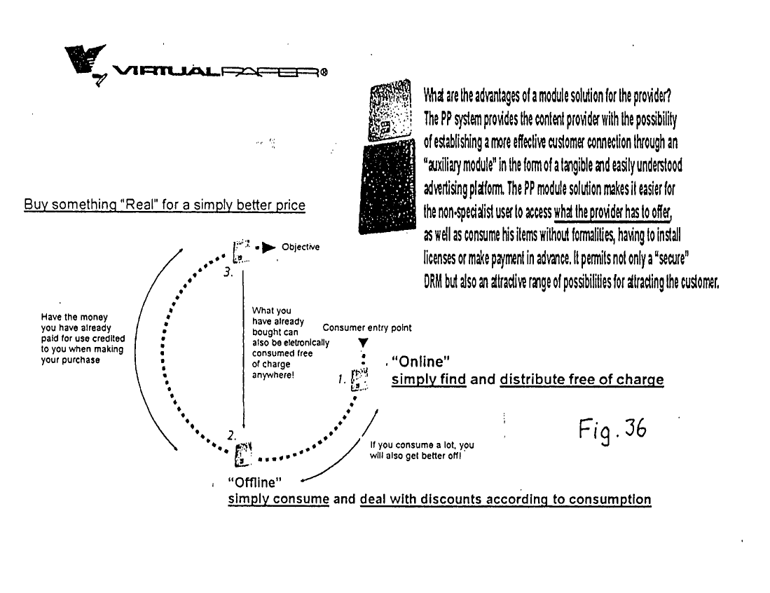

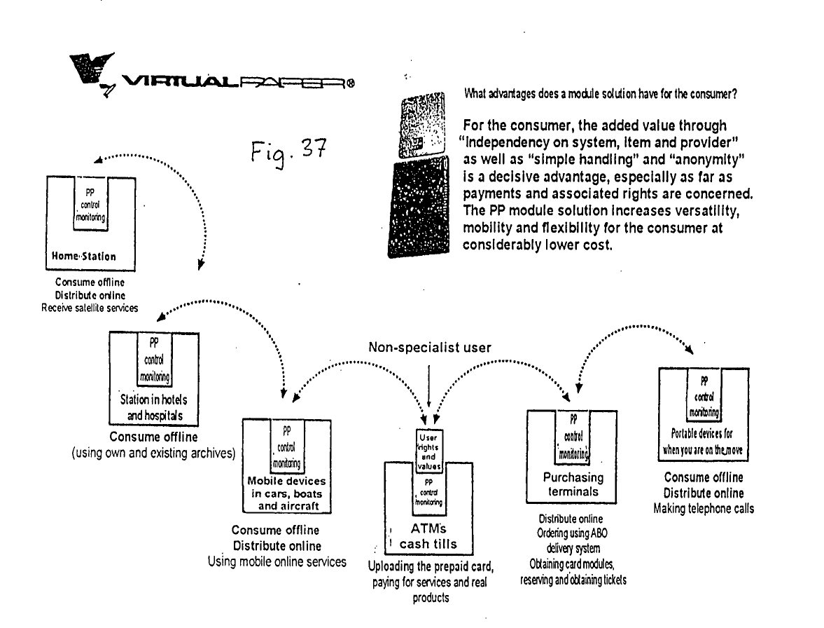

FIG. 36 shows the advantages of the PP system for the content provider,

FIG. 37 shows the advantages of the PP system for the consumer through a wide variety of possibilities of use,

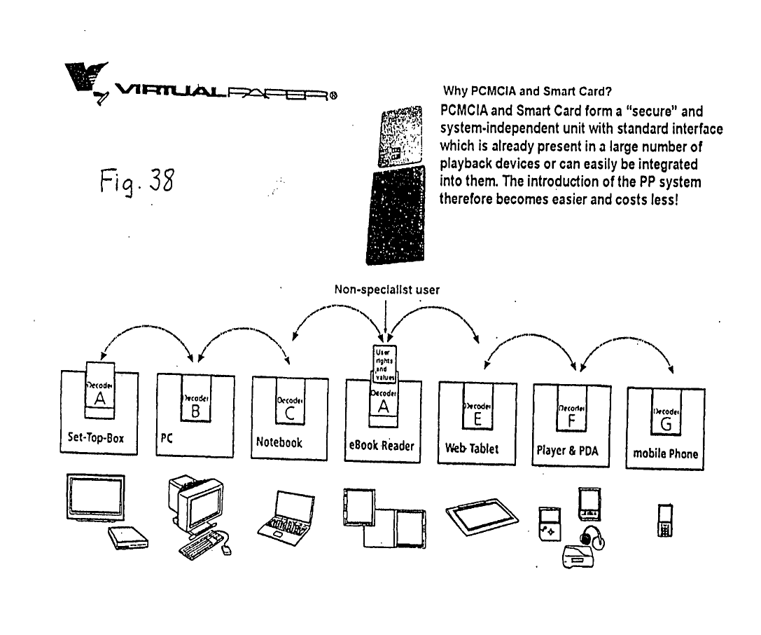

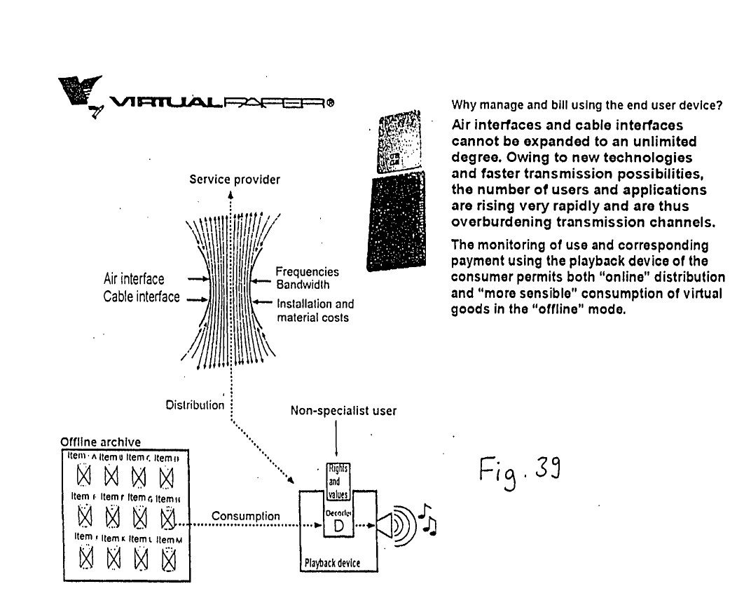

FIG. 38 shows the possibility of using the PP system in a very wide variety of playback devices,

FIG. 39 shows the possibility of using the PP system for online ordering and distribution and offline consumption,

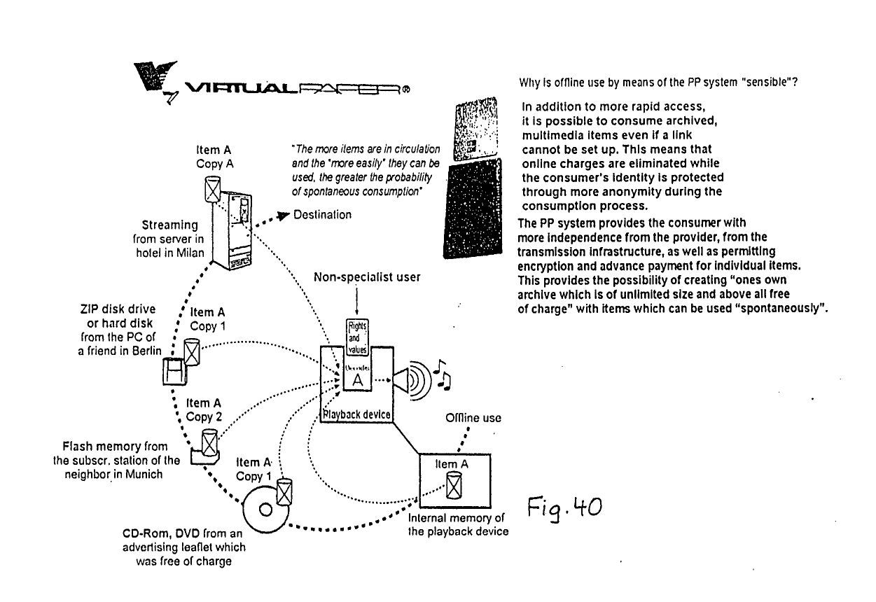

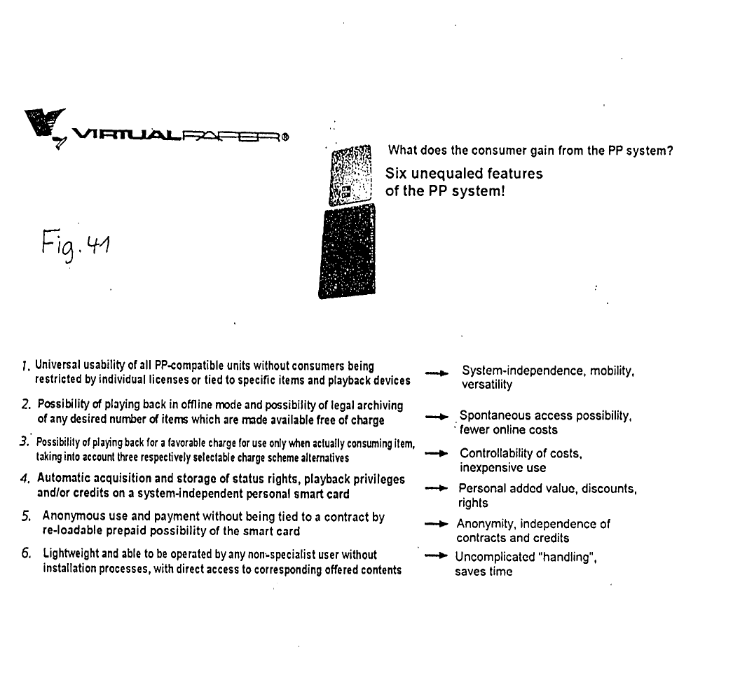

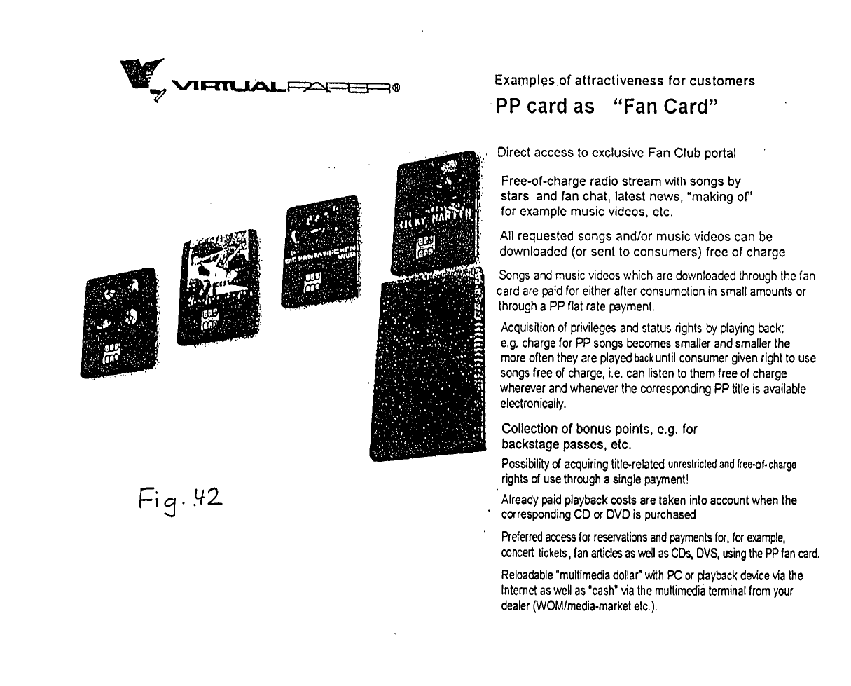

FIG. 40 shows the handling advantages using the PP module system by virtue of the possibility of using a wide variety of data memories and transmission paths for the encrypted content,

FIG. 41 is a general view of the advantages of the PP system,

FIG. 42 is an example of an embodiment of a PP customer card as a fan card with access for a specific fan portal and a link to other PP items (registers and search masks),

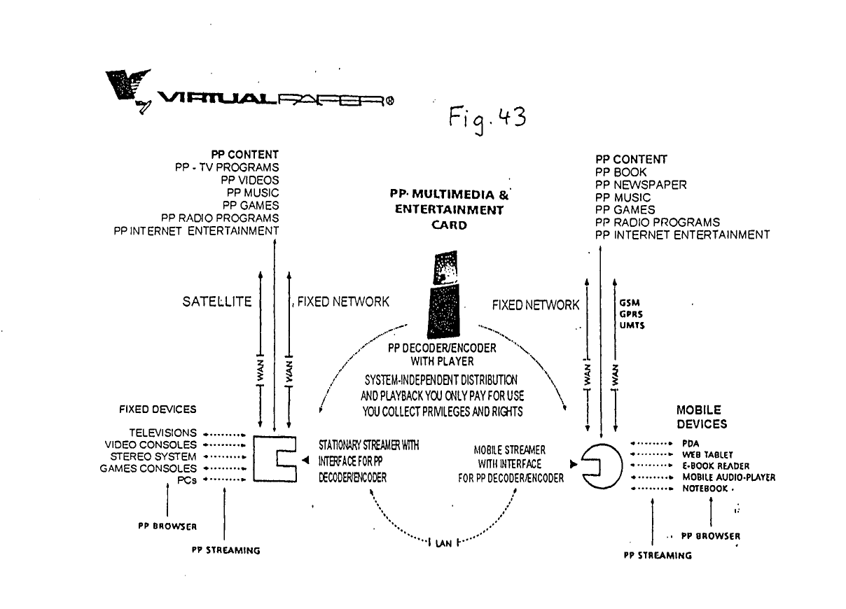

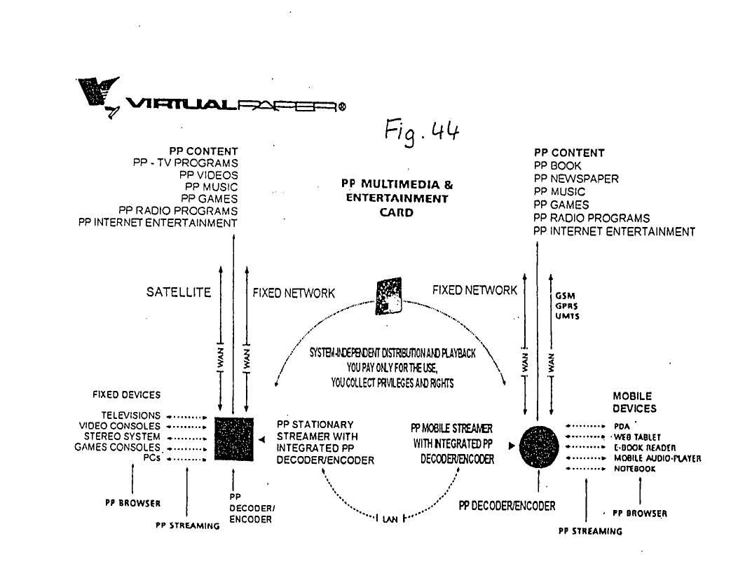

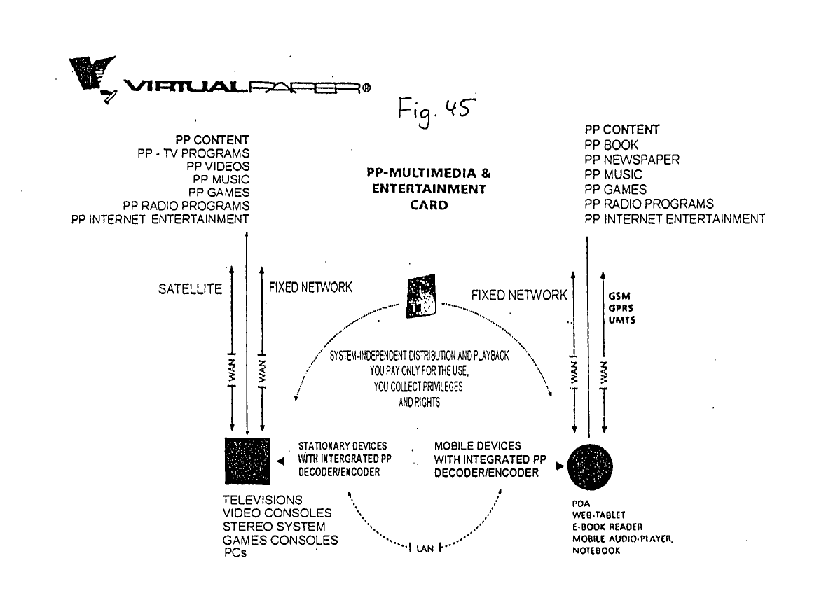

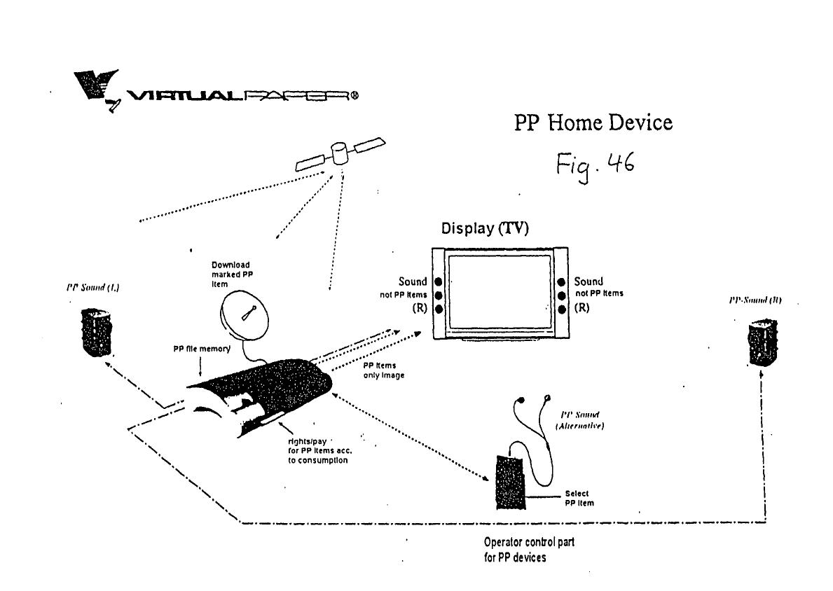

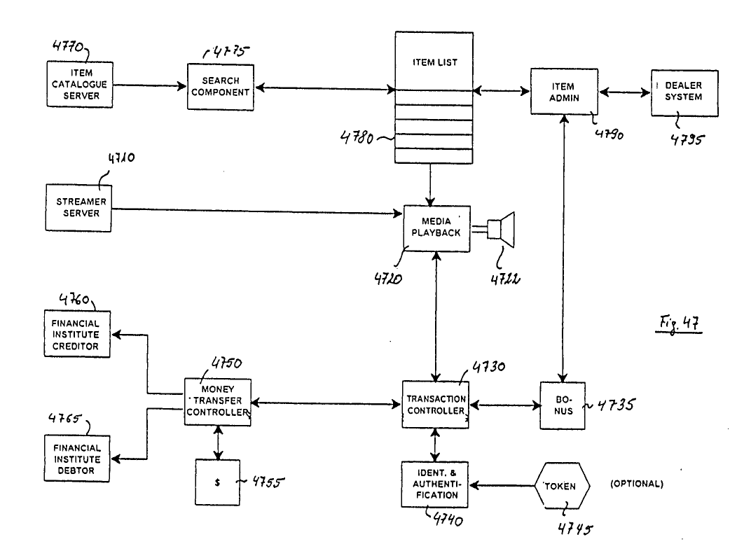

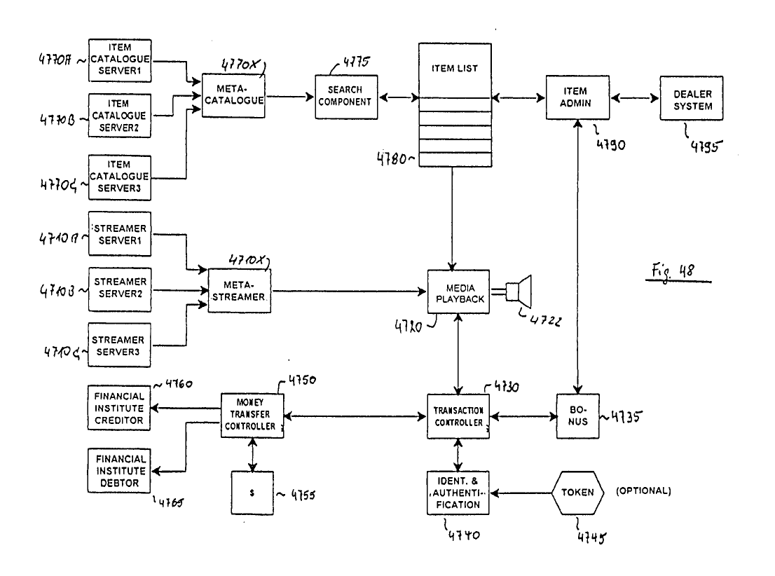

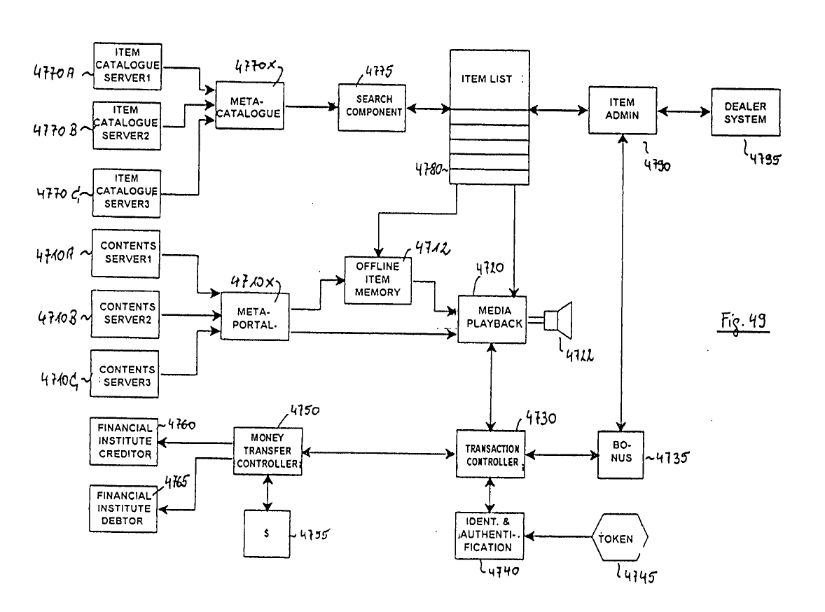

FIG. 43 shows the use of an external (smartcard/PCMCIA) PP system for connecting to a computer which communicates, as a streamer, with different playback or display devices, the items being streamed, for example, in a browser of the playback device,

FIG. 44 shows a PP streamer (piece of equipment) with integrated PP decoder or control module and smartcard reader for, inter alia, PP authentication cards for streaming into connected playback devices,

FIG. 45 shows playback terminals with a smartcard reader and integrated PP decoder or control unit and player or browser,

FIG. 46 shows the connection of the described play and pay system (PP system) with a display and operator control part and terminals,

FIG. 47 shows a schematic block diagram of a further device according to the invention for distributing, playing back, billing and paying for digital media content,

FIG. 48 shows a schematic view of a further development of the arrangement shown in FIG. 47,

FIG. 49 shows a schematic view of a further development of the arrangement shown in FIG. 48,

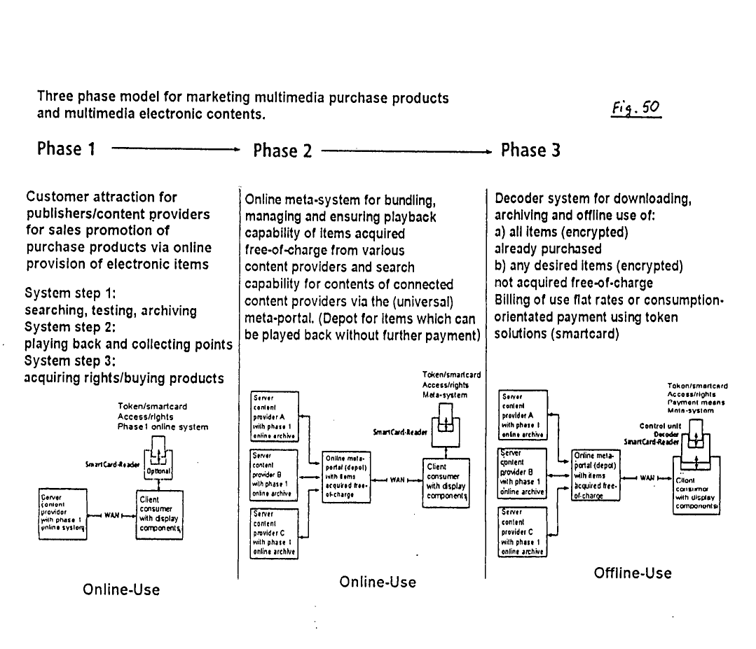

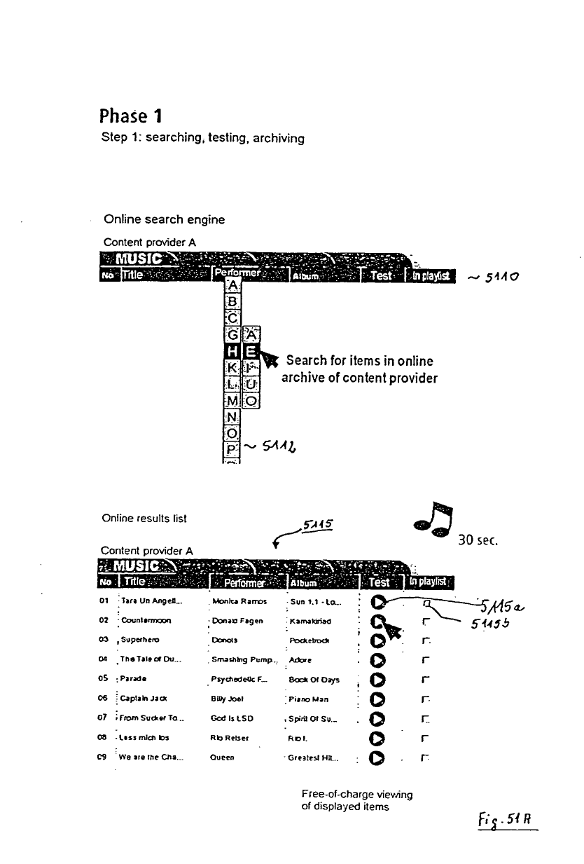

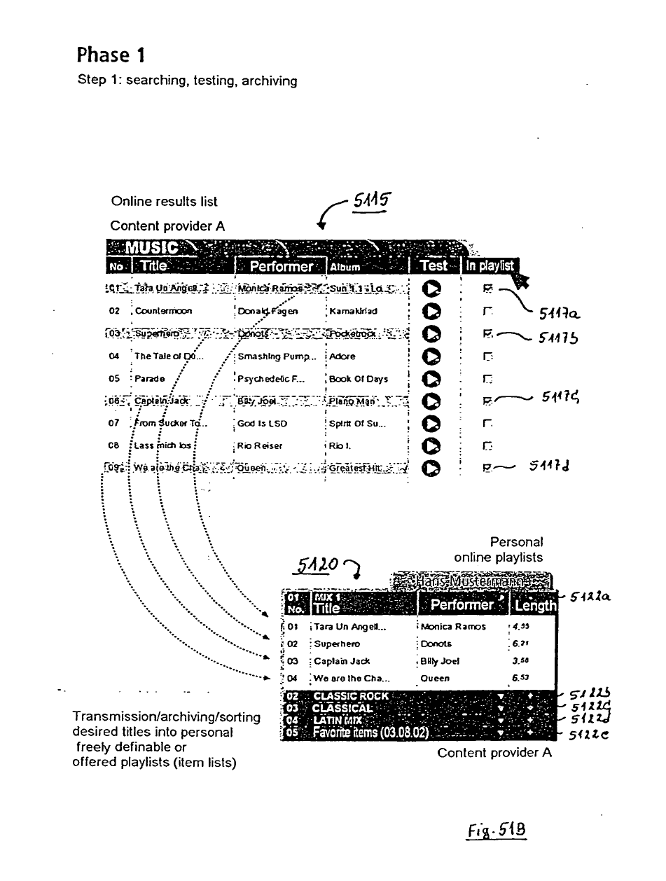

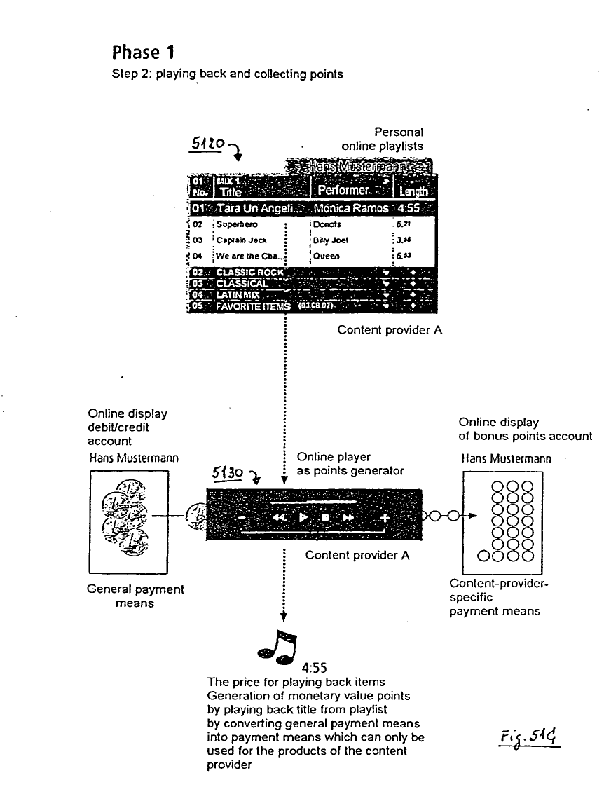

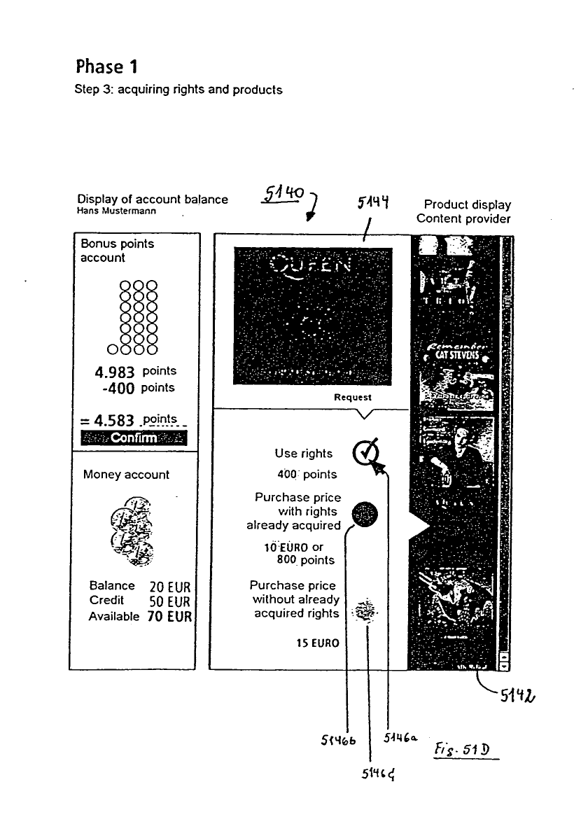

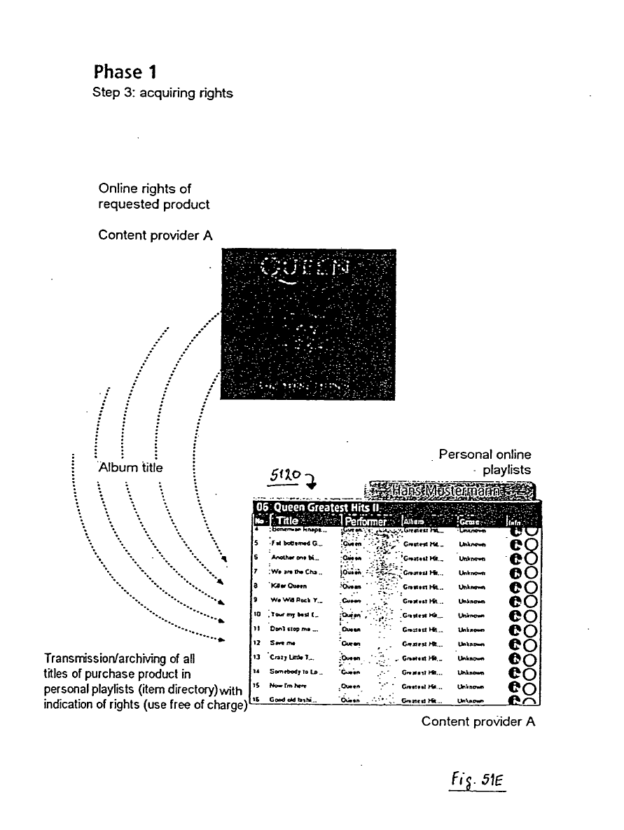

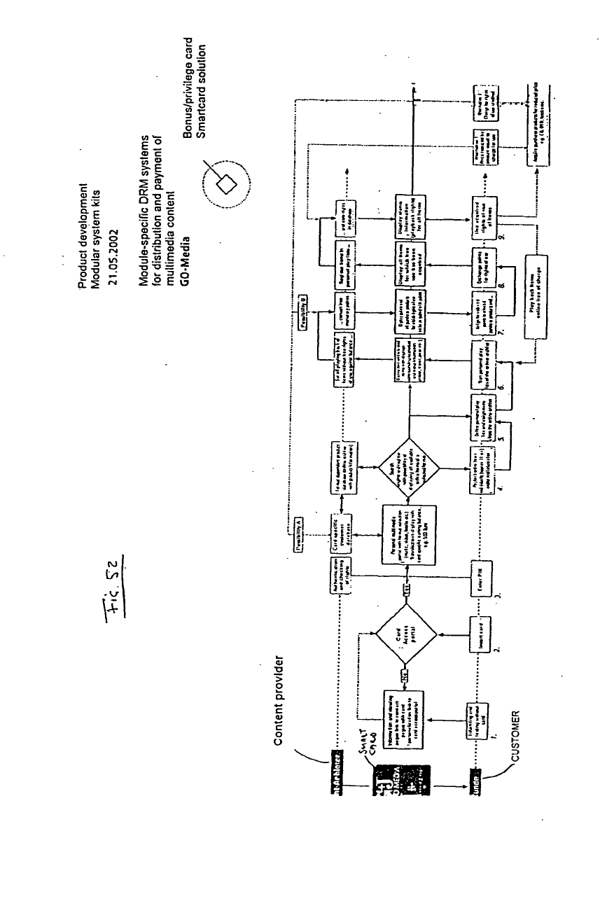

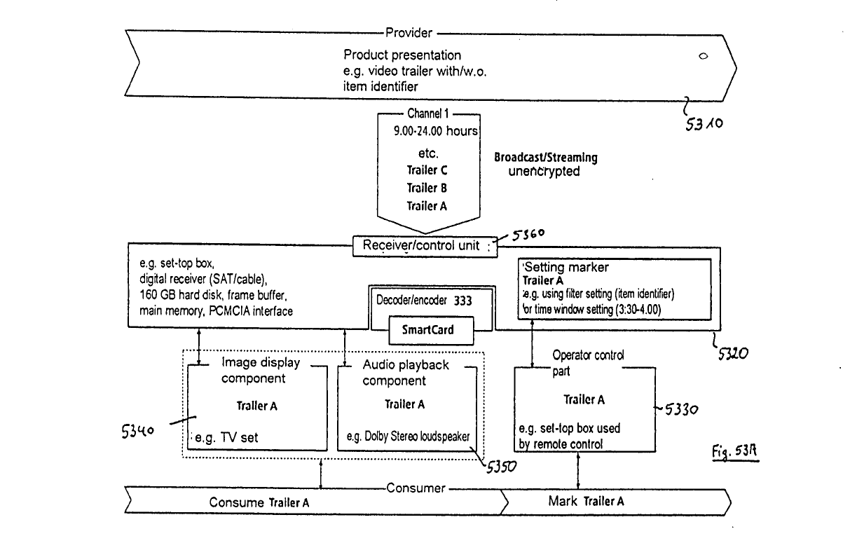

FIG. 50 shows a schematic overview of a phase model for marketing multimedia sales products on the basis of the arrangements illustrated in FIGS. 47 to 49,

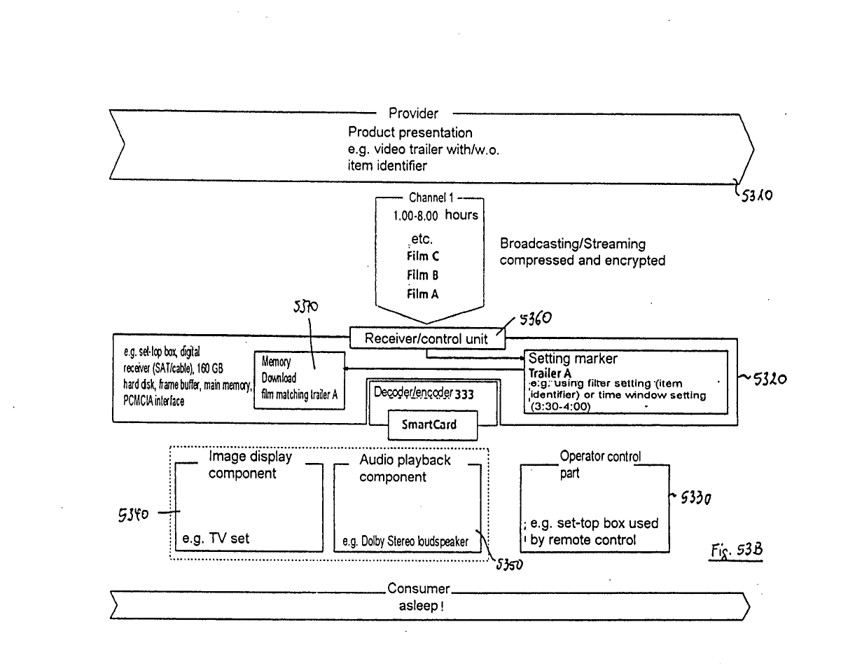

FIG. 51A shows a schematic view of an exemplary operator control interface of a first aspect of a first substep according to the first phase of the phase model from FIG. 50,

FIG. 51B shows a schematic view of an exemplary operator control interface of a second aspect of the first substep according to the first phase of the phase model from FIG. 50,

FIG. 51C shows a schematic view of an exemplary operator control interface of a second substep according to the first phase of the phase model from FIG. 50,

FIG. 51 D shows a schematic view of an exemplary operator control interface of a first aspect of a third substep according to the first phase of the phase model from FIG. 50,

FIG. 51 E shows a schematic view of an exemplary operator control interface of a second aspect of the third substep according to the first phase of the phase model from FIG. 50,

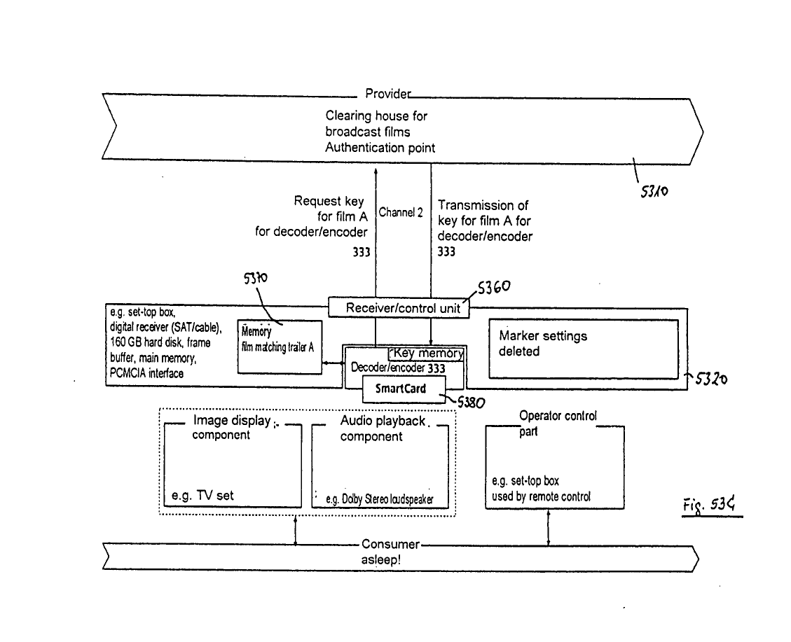

FIG. 52 shows a schematic view of sequences when using an inventive arrangement according to FIGS. 47, 48 or 49, both at the content provider end and at the media consumer (customer) end,

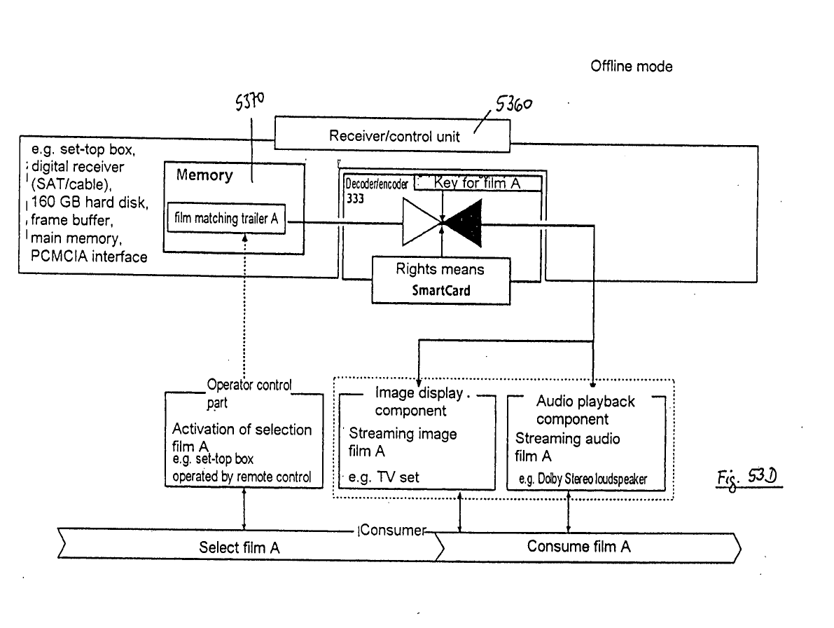

FIG. 53A shows a schematic view of a device and of a method for broadcast distribution of digital content in a first method step,

FIG. 53B shows a schematic view of a device and of a method for broadcast distribution of digital content in a second method step,

FIG. 53C shows a schematic view of a device and of a method for broadcast distribution of digital content in a third method step, and

FIG. 53D shows a schematic view of a device and of a method for broadcast distribution of digital content in a fourth method step.

FIG. 1 shows a schematic view of a networked data processing device according to the invention with a server part 110 and a client part 120. The server part 110 and the client part 120 are connected to one another via a telecommunications network 130 which is designated as a WAN (Wide Area Network), for example via the analog telephone network, via the ISDN network, via the Internet or via a satellite link for exchanging data. The server part 110 and the client part 120 are typically each assigned a unique address or identifier 112, 122, for example a telephone number, an Internet address or the like, for the purpose of exchanging data via the WAN 130. If the client part 120 wishes to set up a link to the server part 110 via the WAN 130, it requires information about its address 112. Conversely, the server part 110 requires information about the address 122 of the client part 120.

The client part 120 is designed to hold a mobile card module 140. The card module 140 comprises at least one storage device for the nonvolatile storage of data (not illustrated) and can exchange data with the client part 120 via a data communications device (not illustrated). The card module 140 may be configured in particular as a chipcard; however, other easily transportable designs are also possible. Basic properties of chipcards are disclosed, inter alia, in Wolfgang Rankl and Wolfgang Effing: “Handbuch der Chipkarten [Chipcard manual]”, Munich: Carl Hanser Verlag, 2nd edition 1996. The disclosures of this publication are included by reference in the present description. A card module 140 which can be used as a chipcard which is printed on both sides is particularly preferred. Here, for example one side of the chipcard may be formed by a media content provider who issues this card to his customers. When the card is inserted with this side facing upward into a terminal, a preferred connection to a selection page of this provider is set up. The other side is formed, for example, by the operator of the portal data processing device. When this side of the card is inserted facing upward, a connection to a register and/or a search engine of this operator of the portal data processing device is preferably made available, said connection permitting items to be selected independently of a media content provider. However, on the specific side of the media content provider who takes up one side of the card there is preferably at least a link to the side of the operator of the portal data processing device so that the user does not have to remove the card and turn it around but rather can also change over to other providers and the media content which they provide by clicking on a link button.

The server part 110 is a computer which is typically assigned to a commercial provider of goods and/or services. The server part 110 may be, for example, a computer which is connected to the telephone network via a modem or ISDN and which can be dialed up for data communication via a dialed line connection from the client part 120. In another embodiment, the server part 110 is a “World Wide Web” server (“WWW server”) which is connected to the Internet and which can communicate with the client part 120 via the hypertext transport protocol (HTTP protocol). In a further embodiment, the server part is embodied, for example, as a computer which is connected to the Internet and which can exchange electronic mail (e-mail) with the client part 120 via the simple mail transport protocol (SMTP) and via the Post Office Protocol (POP). The invention is not restricted to certain types of telecommunications networks or to specific protocols; to this extent, the information given above is exclusively for the purpose of illustration.

FIG. 2 shows a schematic view of various aspects of the commercial use of a data processing device according to the invention. The inventive interaction between the card module 140 and the client part 120 permits the end user (not illustrated) who is accessing the server part 110 via the client part 120 to carry out advantageous processing of transactions.

Aspect (1): On the one hand, the card module 140 permits, by inter-acting with the client part 120, a system-independent setup of the communication relationship to the server part 110, for example by means of a system-independent dialing-in process. For this purpose, access data, access configurations or access procedures are stored in the memory of the card module 140. This avoids the need for the end user to carry out complex configuration of the access data, for example with an Internet access provider, with a server for electronic mail or with a server for processing electronic subscriptions. In one preferred variant, the client part 120 may be configured with the card module 140 in such a way that the end user merely has to plug the card module 140 into the client part 120 in order to initiate the setup of a telecommunications link to a server part 110. Where it is displayed, the initiation of the setup of a telecommunications link to the server part 110 can additionally be made dependent on the activation of an operator control element, in particular on the client part 120, and/or on the inputting of an item of security information, for example a PIN.

Aspect (2): The card module 140 permits, by interacting with the client part 120, the end user to be differentiated and/or identified with respect to the server part 110. Three cases are to be distinguished here: on the one hand there may be cases in which it is not necessary or not desirable or legally unacceptable to identify the end user by name, address etc., but nevertheless various end users who each have separate card modules 140 are to be capable of being distinguished from one another in said cases. This may take place, on the one hand, by means of pure serialization of the card module 140, for example by means of a uniquely defined serial number which is written into a memory area, which cannot be overwritten, of the card module 140 and which does not repeat; if the end user successively uses various card modules 140 with different serial numbers, it is not possible to infer the identity of the end user without additional logic linking information. A third variant includes a pseudonym identification of the end user over a plurality of card modules 140 which, however, does not permit the identity of the end user to be inferred without additional information. In the case of prepaid card modules 140, it will frequently be possible to dispense with identification of the end user. If payment processing by the submission of an invoice, credit card, direct debit etc. is provided, data for completely identifying the end user will generally be necessary. A pseudonym is always appropriate if the intended exchange of performance is to be carried out even without knowledge of the identity of the end user but taking into account the knowledge of which different card modules 140 are to be assigned to the same end user (see also in particular aspect 7).

Aspect (3): The card module 140 also permits, by interacting with the client part 120, authentication with respect to the server part 110, i.e. specific authenticity properties of a card module 140 can be checked from the server part. Preferably known cryptographic methods can be used for this purpose. It is possible, for example, to store in a nonvolatile area of the memory (not illustrated) of the card module 140—said area being tamper-proof—a secret cryptographic key which is assigned to a specific end user. However, the cryptographic key does not need to be assigned to an end user in all cases; it is also possible to use these technologies to distinguish card modules 140 which have been legitimately placed in circulation by an authorized manufacturer from card modules which have been simulated by unauthorized third parties.

Aspect (4): In addition, the card module 140 permits, by interacting with the client part 120, chronologically recurring transactions with the server part 110, in particular subscriptions for specific services, to be controlled.

Aspect (5): Furthermore, the card module 140 permits, by interacting with the client part 120, card-module-specific decryption of files which are supplied by the server part 110 and which can represent, for example, software, text and/or multimedia items. This provides an effective technical protection of copyrights.

Aspect (6): The card module 140 also permits, by interacting with the client part 120, files which are supplied by the server part 110, and which may represent, for example, multimedia items, to be used in a way which is metered in a timed fashion. As a result, a technical infrastructure for the use-time-dependent calculation of copyrights can be implemented (see also in particular Aspect 7).

Aspect (7): The card module 140 also permits, by interacting with the client part 120, payment transactions with the server part 110 to be processed, for example by transmitting credit card numbers or digital cash. Various alternatives are to be distinguished here: on the one hand, a card module 140 which is placed in circulation may incorporate a specific amount of prepaid credit which is represented by means of a corresponding, predetermined data element which is stored in the memory (not illustrated) of the card module. On the other hand, the payment may be made in a person-specific fashion by the submission of an invoice, a credit card or a direct debit, the necessary details relating to the identity and the payment transaction data (account number, credit card number, billing address etc.) being stored in the memory (not illustrated) of the card module 140. In both cases it is advantageous to protect the authenticity of the card module 140 and the data elements stored in its memory by means of a digital signature which is generated by the legitimate issuing office. Irrespective of the above distinction between prepaid credit and ongoing billing, there is an alternative between the acquisition of files according to the principle of purchasing, i.e. after a purchase price is paid once there is a chronologically unlimited possibility of use, and billing according to intensity of use, preferably measured with respect to the use time or the volume of actually used data from a file. Finally, there is a further independent alternative between card modules 140 which, even at the time at which they are placed in circulation, have already been provided with all the necessary billing-related data elements and card modules 140 in which the billing-related data elements are not transmitted from the server part 110 to the memory (not illustrated) of the card module 140 until said card modules 140 have been issued to the end user. The eight individual cases which originate from the combination of these three alternatives each condition a particular technical embodiment of the card module and its interaction within the scope of the solution according to the invention.

Aspect (8): If the card module 140 is equipped with sufficient storage capacity, for example in the form of what is referred to as a flash memory, files which represent, for example, programs for data processing systems, texts or multimedia items can be stored temporarily or permanently in the card module. As a result, in particular the technical implementation of systems which have already been referred to in Aspect (4) for the automated periodic acquisition of software, text and/or files which represent multimedia items and are distributed by the server part 110 is improved.

Aspect (9): Finally, the card module 140 can be used, by interacting with the client part 120, to enable or disable specific functionalities by the server part 110 in a telematic fashion.

In a data processing device according to the invention, it is not necessary to implement all the aspects simultaneously.

The exemplary embodiments and their variants which are described below make use, to a certain extent, of specific cryptographic techniques such as, for example, asymmetrical cryptography and digital signatures. An introduction to applied cryptography can be found, for example, in: Bruce Schneier: “Applied Cryptography”, New York: John Wiley & Sons, Inc., 1994. The disclosures of this document are incorporated by reference in the present description.

FIG. 3 shows a first application of the invention by means of a schematic view of a data processing device according to the invention. As already illustrated in FIG. 1, a client part 120 is connected via a WAN 130 to a server part 110. The client part 120 is provided with a display device 125 which is illustrated only schematically. The card module 140 which is held by the client part identifies a specific end user (not illustrated) to whom the card module 140 is assigned personally or by means of a pseudonym. In particular, an item of identity information 141, which can be transmitted to the server part 110 via the WAN 130, is stored in the card module 140. The identity information 141 may be additionally secured in a customary fashion on pages of the client part 120, for example by means of a PIN or by means of biometric identity detection devices (not illustrated). In addition to the card module 140, there may be other card modules 140a, 140b, 140c which are each assigned to the identities SN1, SN2 and SN3. If the card module 140 which is associated with the identity SN4 141 is replaced with one of the other card modules 140a, 140b, 140c, the respective assigned identity information SN1, SN2 and SN3 can be transmitted to the server part 110. The first application of the invention which is illustrated in FIG. 3 is significant particularly if an acting subject is to be capable at least of being distinguished for example in its property as a contractual partner with respect to the server part 110, or else is to be capable of being identified directly or by means of a pseudonym.

FIG. 4 shows a second application of the invention by means of a schematic view of a data processing device according to the invention. As already illustrated in FIG. 1, a client part 120 is connected to a server part 110 via a WAN 130. The client part 120 is provided with a display device 125 which is illustrated only schematically. The card module 140 which is held by the client part can identify a specific contractual relationship AbD 141, in particular by means of a predetermined data element, said relationship including in the present example the regular supply (subscription) of a digital multimedia product. In addition to the card module 140, other card modules 140a, 140b, 140c which are each assigned to the contractual relationships AbA, AbB and AbC (141a, 141b, 141c) may also exist. If the card module 140 which is associated with the contractual relationship 141 is replaced with one of the other card modules 140a, 140b, 140c, the respective assigned contractual relationship information 141a, 141b and 141c can be transmitted to the server part 110. • The respective contractual relationship information 141, 141a, 141b, 141c is a characteristic variable which controls an automated selection process with respect to the file (not illustrated) which is to be transmitted from the server part 110 to the client part 120 and represents a multimedia representation, as well as with respect to the transmission time.

FIG. 5 shows a fourth application of the invention by means of a schematic view of a data processing device according to the invention. As already illustrated in FIG. 1, a client part 120 is connected to a server part 110 via a WAN 130. The client part 120 is provided with a display device 125 which is illustrated only schematically. The card module 140 which is held by the client part identifies, in particular, a specific server part 110 which may be assigned, for example, to an associated specific service provider SPr4. In addition to the card module 140, there may be other card modules 140a, 140b, 140c which are each assigned to the service providers SPr1, SPr2 and SPr3 (141a, 141b, 141c). If the card module 140 which is associated with the service provider 141 is replaced with one of the other card modules 140a, 140b, 140c, the respective assigned service provider information 141a, 141b and 141c can be transmitted to the server part 110. The respective service provider information 141, 141a, 141b, 141c is a characteristic variable which brings about in particular an automatic selection process with respect to the data transmission parameters from the client part 120 so that automatic initiation of a data exchange between the client part 120 and server part 110 is made possible.

FIG. 6 shows a first variant of an embodiment of the solution according to the invention which is illustrated in FIG. 1. As already illustrated in FIG. 1, a client part 120 which is designed to hold a card module 140 is connected to a server part 110 via a WAN 130. The client part 120 is provided with a display device 125 which is illustrated only schematically. FIG. 6 thus shows a solution in which the client part 120 which is designed to hold a card module 140 and the display device 125 form a piece of equipment which is essentially embodied mechanically in one piece.

FIG. 7 shows a second variant of an embodiment of the solution according to the invention which is illustrated in FIG. 1. As already illustrated in FIG. 1, a client part 120 which is designed to hold a card module 140 is provided. The client part 120 is connected via a data communications device 123 to a display device 125 which is illustrated only schematically and which is connected to a server part 110 via a WAN 130. FIG. 7 thus shows a solution in which the client part 120 which is designed to hold a card module 140, on the one hand, and the display device 125 which is connected to the WAN 130, on the other, each independently form a piece of equipment which is essentially embodied in one piece in mechanical terms, the exchange of data between the client part 120 and the display part 125 being carried out by means of the data communications device 123. Wirefree and wirebound devices and methods, in particular by means of a data transmission cable (not illustrated), by radio (not illustrated) or by infrared, for example IrDA (not illustrated), are possible as technical implementations of the data communications device.

FIG. 8 shows a third variant of an embodiment of the solution according to the invention which is illustrated in FIG. 1. As already illustrated in FIG. 1, a client part 120 which is designed to hold a card module 140 and which is connected to a server part 110 via a WAN 130 is provided. The client part 120 is connected via a data communications device 123 to a display device 125 which is illustrated only schematically. FIG. 8 thus shows a solution in which the client part 120 which is designed to hold a card module 140 and is connected to the WAN 130, on the one hand, and the display device 125, on the other, each form in themselves a device which is essentially embodied in one piece in mechanical terms, the exchange of data between the client part 120 and the display part 125 being carried out by means of the data communications device 123. Wirefree and wirebound devices and methods, in particular by means of a data transmission cable (not illustrated), by radio (not illustrated) or by infrared, for example IrDA (not illustrated), are possible as technical implementations of the data communications device.

FIG. 9 shows a fourth variant of an embodiment of the solution according to the invention which is illustrated in FIG. 1. As already illustrated in FIG. 1, a client part 120 which is designed to hold at least one card module 140 and which is connected to a server part 110 via a WAN 130 is provided. In addition to the client part 120 there is a display device 125 which is illustrated only schematically and which is also designed to hold at least one card module 140. FIG. 9 thus shows a solution in which the client part 120 which is designed to hold a card module 140 and is connected to the WAN 130, on the one hand, and the display device 125, on the other, each form in themselves a piece of equipment which can be embodied essentially in one piece in mechanical terms, the exchange of data between the client part 120 and the display part 125 being carried out by reinserting the card module 140. For example, the card module 140 can be held in the client part 140 in order to store data which is supplied by the server part 110. After the respective data has been stored in the card module 140, this data can be presented in a sensorially perceptible form by reinserting the card module into the display device. Conversely it is also possible to store, for example, data relating to ordering processes in the card module 140 if it has been held by the display device 125. After the card module 140 has been reinserted into the client part 140, this ordering data can be fed to the server part 110 via the WAN 130.

FIG. 10 shows a fifth variant of an embodiment of the solution according to the invention which is illustrated in FIG. 1. As already illustrated in FIG. 1, a client part 120 which is designed to hold a card module 140 is provided. The client part 120 is connected via a data communications device 123 to a display device 125 which is illustrated only schematically and is connected to a server part 110 via a WAN 130. FIG. 10 thus shows a solution in which the client part 120 which is designed to hold a card module 140, on the one hand, and the display device 125 which is connected to the WAN 130, on the other, each form in themselves a piece of equipment which is essentially embodied in one piece in mechanical terms, the exchange of data between the client part 120 and the display part 125 being carried out by means of the data communications device 123.

Wirefree and wirebound devices and methods, in particular by means of a data transmission cable (not illustrated), by radio (not illustrated) or by infrared, for example IrDA (not illustrated), are possible as technical implementations of the data communications device.

The client part 120 which is illustrated in FIG. 10 is designed to hold a multiplicity of card modules 140a-140e which can respectively initiate and control independently of one another communications processes with the server part 110 by means of the card module data (not illustrated) which is stored on said card modules 140a-140e, and which can be addressed independently of one another, from the point of view of the server part 110, during communications transactions which are initiated by the server part 110. For example, at least one of the card modules 140a-140e may act as a component of a system which is illustrated in FIG. 4, i.e. a card module or several card modules serve as a memory for digital multimedia products which are supplied in digital form by the server part 110 via the WAN 130, regularly but asynchronously with respect to operator control actions of the user.

The particular feature of the arrangement illustrated in FIG. 10 in comparison with the arrangement illustrated in FIG. 7 is in particular the fact that a master card module 140 is provided with which the display device 125 can identify and authenticate itself in a particular way with respect to the client part 120 and the other card modules 140a-140e inserted in it. For example, the master card module 140 can be inserted into a digital book which is used as a display device 125. The digital book is then configured by the master card module 140 in such a way that, with respect to the client part and the further card modules 140a140e inserted in it, specific privileged operator control transactions, for example the enabling or disabling of the client part 120 for supplies by the server part 110 or the performance of ordering transactions with respect to the server part 110, can be carried out by the user using the data communications device 123. For this purpose, the data communication via the data communications device 123 is preferably protected against tapping and manipulation by means of suitable technologies, in particular cryptographic technologies.

FIG. 11 shows a sixth variant of an embodiment of the solution according to the invention which is illustrated in FIG. 1. As already illustrated in FIG. 1, a client part 120 which is designed to hold a card module 140 and which is connected to a server part 110 via a WAN 130 is provided. The client part 120 is connected via a data communications device 123 to a display device 125 which is illustrated only schematically. FIG. 10 also thus shows a solution in which the client part 120 which is designed to hold at least one card module 140, on the one hand, and the display device 125 which is connected to the WAN 130, on the other, each form in themselves a piece of equipment which is essentially embodied in one piece in mechanical terms, the exchange of data between the client part 120 and the display part 125 being carried out by means of the data communications device 123. The particular feature of the arrangement illustrated in FIG. 11 with respect to the arrangement illustrated in FIG. 7 is in particular the fact that the client part 120 is designed, as also in the case illustrated in FIG. 10, to hold a plurality of card modules 140a-140e which, by means of the card module data (not illustrated) which is stored on them, can each respectively initiate and control communications transactions with the server part 110 independently of one another and which can be addressed independently of one another, from the point of view of the server part 110, during communications transactions which are initiated by the server part 110. For example, at least one of the card modules 140a-140e may act as a component of a system (illustrated in FIG. 4), i.e. a card module or a plurality of card modules serve as a memory for digital multimedia products which are supplied in digital form by the server part 110 via the WAN 130, regularly but asynchronously with respect to operator control transactions of the user.

In the variant illustrated in FIG. 11, it proves particularly advantageous to implement the client part 120 as a fixed card module station which is connected essentially continuously to the WAN 130 and can thus always initiate data communication transactions with respect to the server part 110, and furthermore can receive data communication transactions initiated by the server part 110, asynchronously with respect to use transactions of the user, even if the display device 125 is embodied as a mobile device which the user carries on his person even when he is not present at the location.

Both with respect to the variant illustrated in FIG. 10 and with respect to the variant illustrated in FIG. 11, it may prove to be advantageous to embody the display device 125 to hold at least one card module 140 so that the mode of use illustrated in FIG. 9 can be used by reinserting a card module.

While the client part 120 is designed to hold at least one card module 140 in the variants illustrated in FIGS. 6 to 11, FIGS. 12 and 13 each show a variant in which a client part 120 is used without a separate card module. FIG. 13 shows a client part 120 which is designed to hold a complete display device 125, the display device 125 being in turn designed to hold at least one card module 140. Data communication takes place between the server part 110 and card module 140 in a method in which the exchanged data is passed through the display device 125 by means of suitable electronic measures. Admittedly, it is not absolutely necessary for the client part 120 to be designed to hold a complete display device 125. The exchange of data between the client part 120, on the one hand, and the display device 125 which is prepared so as to hold at least one card module 140, on the other, may, for example, also be implemented, as illustrated in FIG. 13, by means of a data communications device 123. Wirefree and wirebound devices methods, in particular by means of data transmission cables (not illustrated), by radio (not illustrated) or by infrared, for example IrDA (not illustrated), are possible as technical implementations for the data communications device.

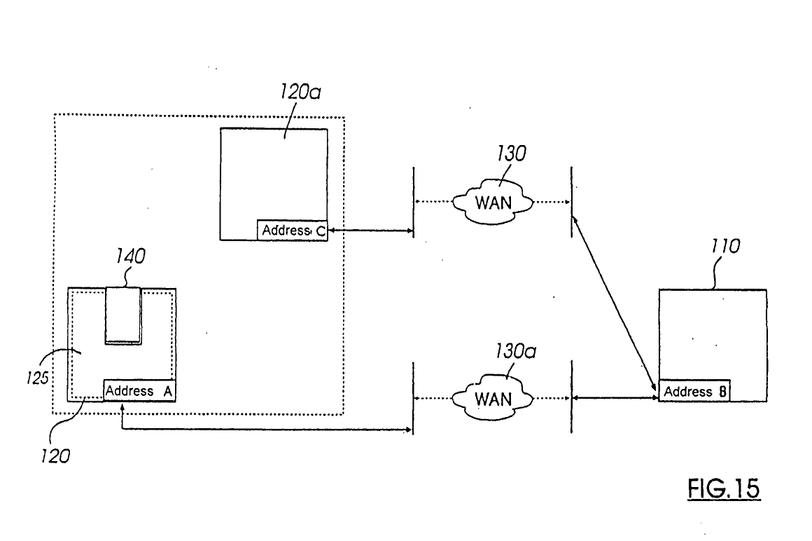

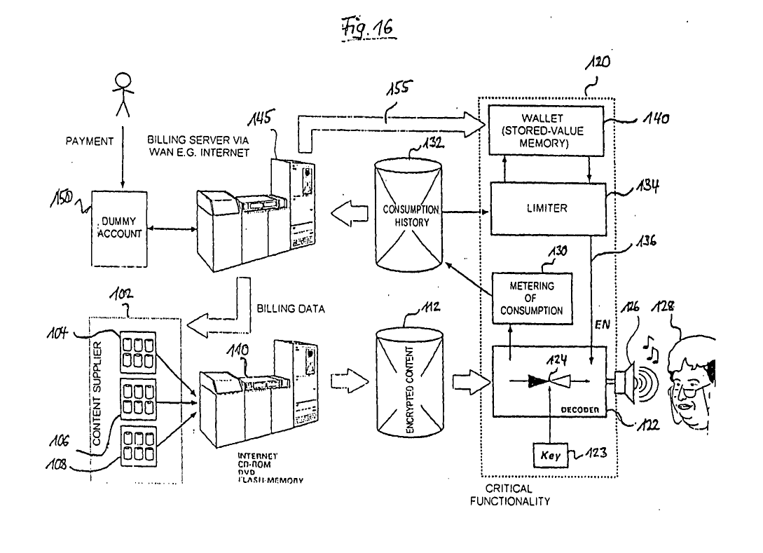

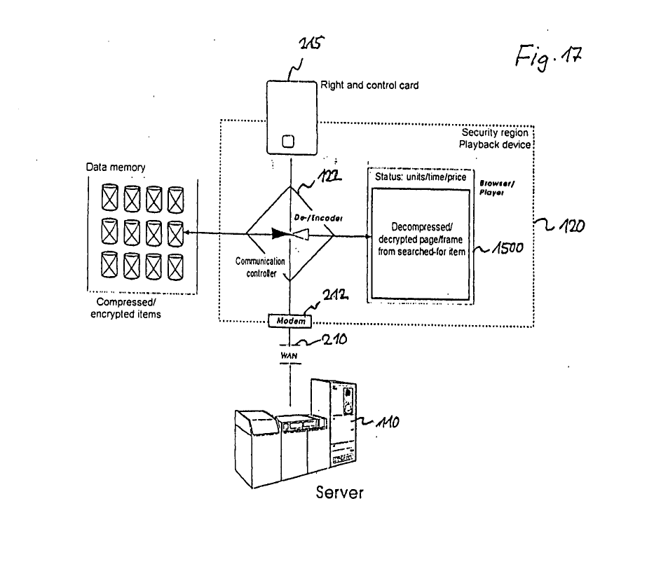

FIGS. 14 and 15 show further variants of an embodiment of the solution according to the invention which is illustrated in FIG. 1. As already illustrated in FIG. 1, a client part 120 which is designed to hold a card module 140 and which is connected to a server part 110 via a WAN 130 is also provided in FIG. 14. A display device 125 is also connected to the WAN 130a. The WAN 130 can be identical to the WAN 130a. An interaction—triggered by means of the display device 125 and transmitted via the WAN 130a—with the server part 110 causes multimedia data to be transmitted from server 110 to the client part 120 via the WAN 130. As a result, the user (not illustrated) may call, for example when on route, data from the server part 110 which is transmitted via the WAN 130 to the client part 120 which is, for example, installed at home.

FIG. 15 shows a variant in which the client part 120 is provided with a display device 125. The data (not illustrated) which is called at the server part 110 is transmitted to a secondary client part 120a via the WAN 130.

FIG. 16 shows a schematic block-diagram-like view of a device 100 according to the invention for distributing, billing and paying for digital media content.

Files 104, 106, 108 which are made available by content providers 102 are held ready for distribution on a server 110. The distribution of the files to individual client computers is preferably carried out in encrypted form by downloading via the Internet or by the sales and marketing of physical data carriers such as CDs, DVDs, flash memories etc. (not illustrated). Here, when dialing in to a service provider, specific item formats can be selected using means in the client computer or in the playback device so that, for example, an MP3 player is provided only with MP3-compatible items for downloading. By means of a personal computer or notebook or television with an Internet connection it would be possible to view all the formats of distributable items using specific rubrics for selecting and ordering (download, upload, streaming or broadcast).

The digital content which is made available to the client computer is represented symbolically and marked with the reference symbol 112. The billing and payment of the charges for these digital content 112 are carried out by an exemplary function block 120.

The function block 120 has a decoder 122 which firstly decrypts (reference symbol 124) the digital content cryptographically and then makes them accessible in some suitable technical fashion to sensory perception by the consumer 128. In the case of MP3 audio files, this may be done, for example, by generating an analog audio signal which can be reproduced with a loudspeaker 126 or headset (not illustrated). In the case of other content (for example texts, images, videos; not illustrated), there may also be, for example, a visual display on a display device (not illustrated).

An evaluation device 130 is connected to the decoder 120 in order to generate data continuously for a consumption history 132 while the media is being used by the consumer 128, said data describing the respective use process with sufficient precision to allow billing to be carried out later. The consumption history contains, for example, data on the duration of use of an audio title or, in the case of other formats of items (for example text; not illustrated), also contains data on used pages of text and the individual use times with respect to individual pages of text. Other possibilities for registering or metering use are also possible.

A limiter 134 is provided in order to supply a calculation of the charge total which is accumulated according to the data in the consumption history 132, continuously or at specific time intervals as a function in the consumption history, and to transmit a disable signal 136 to the decoder 122 when predetermined charge totals are exceeded. As soon as the decoder 122 receives the disable signal 136 from the limiter 134, the use of the encrypted content 112 is interrupted until the limiter 134 cancels the disable signal 136. Instead of a charge total, time credits or credits in terms of volume of use are possible. A hybrid variant of the possibilities described above is also possible.

A stored-value memory 140 stores a data value which represents a sum of money, an available use time or an available use volume which the consumer 128 has stored in order to cover future billing totals, for example through payment in advance in the form of a security. The stored-value memory 140 can be topped up by means of all customary micropayment systems. These include, for example, click and buy, paysafe (prepaid) or loading on by means of a service number such as, for example, a 0190 number. When the stored value is loaded on by means of a 0190 number, it is possible, for example, to load specific amounts of stored value by means of different telephone numbers which may be configured as end numbers for a master number, and for these amounts to be billed by the telecommunications companies. Loading up a stored-value memory, in particular for offline use of digital items, programs or the like, by means of a service number is an independent inventive idea for which protection is independently claimed. In particular, loading up a stored-value memory in a connectable payment module, for example a smartcard, by means of a service number is advantageously possible. This stored value can in turn be stored value in terms of money, a time credit or a volume-related credit. Items-specific rights of use and/or privileges can also be set up by means of a service number.

The limiter 134 preferably fulfills its functionality by interacting with the stored-value memory 140, i.e. as long as a stored value is present, the decoder 122 is not blocked.

The function block 120 contains critical data and functionalities which have to be protected against any unauthorized manipulation from the outside, in particular by the consumer. The decryption key 123 by means of which the decoder 122 cryptographically decrypts the data 112 representing the digital content, and thus makes it available to further processing, is particularly sensitive. The amount of stored value (not illustrated) stored in the stored-value memory 140 is also highly sensitive. The consumption measuring means 130 and the limiter 134 are critical functionalities because the aimed-at billing of charges can be sabotaged by manipulating these devices.

It is therefore advantageous to set up the function block 120 as a particularly protected (tamper-proof) assembly. In the simplest case, the individual elements of this assembly 120 can be embedded, for example, in a sealing compound, for example artificial resin. In further developed solutions it is possible to provide sensors (not illustrated) which are suitable for detecting unacceptable mechanical and/or electrical manipulations. The output signal of these sensors can then be used to delete instantaneously critical data such as, for example, cryptographic keys 123 or amounts of stored value in the stored-value memory 140. The stored-value memory 140 and/or limiter 134 components which, in the exemplary embodiment shown according to FIG. 16, are combined in one functional block 120 can also be contained in a separate module or separate modules which can be connected to the function module 120.

All the components which are combined in the function module 120 can be implemented either as separate hardware components or as individual software modules or else completely as a software solution, for example in the form of plug-ins for a browser.

The consumption history 132 also represents an aggregation of sensitive data which has to be protected against manipulation. To do this, the memory (not illustrated) for storing the consumption history 132 can also be included in the protected function block 120 (not illustrated). Another possibility is to protect the data values of the consumption history 132 against unauthorized changes by one or more digital signatures. To do this, a digital signature generating and testing component (not illustrated) which is advantageously included in the protected critical function block 120 is then provided.

When the binding billing and payment is carried out, the data content of the consumption history is preferably transmitted in a suitable way over a data network link, protected cryptographically against unauthorized monitoring and data manipulation, to a billing server 145. The billing server calculates, by reference to the data of the consumption history, the charge which is to be paid by the consumer and deducts the corresponding amount, for example by means of a debit transaction from a (dummy) account 150 which is assigned to the consumer. The consumer can then carry out a payment transaction in a conventional way, for example by means of a money transfer or by means of a credit card clearing house. The account 150 is not obligatory; if such payment systems are to be used which do not require a (dummy) account 150, such as anonymous digital cash, it is possible to dispense with the account 150.

After payment has been made, or, given appropriate creditworthiness of the consumer, also after billing by the billing server 145 has taken place, the amount of stored value which is stored in the stored-value memory 140 can be increased by a specific amount of stored value by transmitting a stored-value message 155, protected cryptographically against manipulations, from the billing server 145 to the function unit 120 or to the stored-value memory 140.

The stored-value memory 140 is particularly preferably accommodated on a smartcard in order to be able to use the stored amount of stored value independently of a system and in a mobile fashion, even on other pieces of equipment. The function module 120 contains in this case a smartcard reader (not shown). The component which contains the smartcard reader may be embodied, for example, as a PCMCIA card which has the functionalities of the function module 120.

An alternative (not illustrated) to FIG. 16 is for a module which can be coupled to a playback device to be preferably capable of being plugged in, for example PCMCIA, with an integrated memory in which, inter alia, what are referred to as players and/or playback licenses can be stored in such a way that when the module is connected to another playback device or computer the license with the corresponding playback rights or rights of use can be used and is not made unusable or invalid by using another playback device. Here, already existing license solutions of other providers can easily be modified and/or the module can be provided with means such that the system-independent use of the license or licenses of the player or players and/or of the items of the providers by means of the module is possible, but it is not possible to produce a copy of licenses, rights or amounts of stored value. In one further embodiment (not illustrated), means are used to embody a smartcard as a rights card in such a way that they make it possible, by interacting with a software license installed on a computer, to play back correspondingly provided multimedia data (items). Here, in particular information for identifying and/or checking the authorization to use the license, the player and/or specific items is made available by means of the smartcard. In one further development, a software license or a player can be modified in such a way that different users can use items or application programs etc., which are made available by means of a separate smartcard, without having to install a new license on the computer or playback device. Payment by means of a smartcard is possible, for example by means of units of money, setting off against a time credit and/or a credit in terms of usable data volume. It is likewise possible to embody the smartcard as a debit card and/or credit card.

FIG. 17 shows a schematic block-diagram-like illustration of a detail of the device illustrated in FIG. 16. The server 110 makes available digital content (not illustrated) and can be connected to the protected function block 120, for example, by means of a wide area data network (WAN) 210 via a modem 212. The function block 120 is connected in this case to a playback device and has a browser/player 1500 which can also be embodied as a plug-in for an existing browser and which is capable of also representing status information relating to consumed units, times or prices or remaining amounts of stored value, in addition to the decrypted data. Instead of a modem, another suitable network functionality device, for example for ISDN, GSM or UMTS, can also be used. Specific details from FIG. 16, such as in particular the consumption measuring means 130, limiter 134 and stored-value memory 140, are not illustrated in FIG. 17.

In FIG. 17, a card module 215 is provided which can optionally be used as a rights card and control card for controlling the decoder 122, which card is preferably embodied as a smartcard.

FIG. 18 shows a schematic view of a first exemplary system architecture of a device according to the invention for distributing, billing and paying for digital media content.

A use device for the use of digital content by the consumer is designated by the reference symbol 310. The use device 310 can be provided with a connection device for connecting a card module 315.

A media server 320 keeps ready content files 330 which each contain digital content and charge scheme information. The media server 320 can be connected via a data network link 340, preferably via the Internet, to the use device 310, in particular for downloading content files 330.

Individual providers of digital content may operate delivery servers 350A, 350B, 350C which are each connected via a data network connection 352A, 352B, 325C, for example via the Internet, to the media server 320.

In the arrangement illustrated in FIG. 18, it is the responsibility of the providers 350A, 350B, 350C to keep available files 354A, 354B, 354C with digital content and charge scheme information 356A, 356B, 356C. If a specific digital content is requested by the consumer (not illustrated) by means of the use device 310, the content provider 350A, 350B, 350C of the corresponding content file 354A, 354B, 354C assigns specific charge scheme information 356A, 356B, 356C and transmits the content files 354A, 354B, 354C to the media server 320 from where they can be transmitted to the use device 310 for use by the consumer.

FIG. 19 shows a schematic view of a second exemplary system architecture of a device according to the invention for distributing, billing and paying for digital media content.

In the variant of the arrangement from FIG. 18 which is shown in FIG. 19, predetermined tariff categories 322A, 322B, 322C, 322D are set up on the media server 320, and the providers of content files 354A, 354B, 354C stipulate the valid charge scheme model for each of the content files by virtue of the fact that the data transmission 352A, 352B, 352C, 352D takes place in a file-specific fashion into an area 322A, 322B, 322C, 322D of the media server 320 which is categorized according to charge scheme categories.

FIG. 20 shows a first diagram relating to the discussion of the dependence of the volume—received by the consumer—of pages of a page-oriented text document (not illustrated) on the vertical axis on the use time, used for this page, on the horizontal axis. Here, the scaling of the vertical axis is to be understood in such a way that a page of text which has been read a plurality of times also counts to the extent corresponding to this plurality of times. The number of pages of the text item assumed in the illustrated example is 120 pages.

Assuming a constant reading speed, for example the reading curve which is designated C, has a low degree of steepness and in which each of the 120 pages of the item has been read once by the consumer after approximately 15 hours of reading time is obtained for an exemplary, slow reader.

Correspondingly, for example the reading curve which is designated by B and has a high degree of steepness and in which each of the 120 pages of the item has been read once by the consumer after approximately 4 hours of reading time is obtained for an exemplary, fast reader.

Finally, for example the reading curve which is designated by A and has a low degree of steepness and in which each of the 120 pages of the item has been read once by the consumer after approximately 7.5 hours of reading time is obtained for an exemplary, average-speed reader.

With respect to the reading curve A, the charge scheme is selected in such a way that the distance from the zero point to the point at which approximately 240 pages have been read by the consumer after approximately 15 hours is assigned to a charge amount of DM6.00. Accordingly, to read the item once costs DM3.00 in approximately 7.5 hours. Fractions or multiples thereof are correspondingly billed proportionally.

FIG. 21 shows a curve diagram relating to the discussion of the dependence between the intensity of use of an item and the assigned price. Whereas in the diagram illustrated in FIG. 20 the charge increases proportionally to the number of pages read, alternative, nonlinear charge scheme curves are illustrated in FIG. 21.

In this respect, in the illustrated example “sensory items” such as texts of “high” literature are distinguished from “functional items”.

In the case of sensory items, it may be desirable, in view of marketing considerations, to charge for the use of digital content by means of a corresponding technical infrastructure in such a way that the first quantity components of the use of the item by the consumer are billed with a lower charge so that the consumer can orientate himself, without worry, in terms of high expected use charges, and he is motivated to continue with the consumption.

Correspondingly, it may be desirable with functional items to adopt a charge scheme for the use of digital content by means of a corresponding technical infrastructure in such a way that the first quantity components of the use of the item are billed with a higher charge in comparison with the use of later parts of the item by the consumer since the information which is extracted from the item by the consumer at the beginning frequently represents, on a subjective level, the most important useful value for the consumer.

FIG. 22 shows a first diagram relating to the discussion of the dependence of the volume—received by the consumer—of a page of a text document on the use time spent on using this page.

The time which the consumer takes to read a single page of a text-orientated item is plotted on the horizontal axis. The percentage of the quantity of text already read by the consumer in respect of the overall quantity of text on the page is represented on the vertical axis.

The reading curve plotted in the diagram shown takes into account a certain orientation time t1 of, for example, 15 seconds, i.e. for all the times in the time interval between 0 and 15 seconds it is assumed that the reader has not absorbed reading matter to any substantial degree. At a time ti+t2 which is taken by way of example, in the example therefore after 2 minutes and 53 seconds, the reader will be assumed to have read approximately 75% of the quantity of text on the page of text under consideration. After an overall time t1+t2+t3 of 3 minutes and 45 seconds, the page has been completely read.

The invention makes possible, for example, in particular a charge scheme in which a page-oriented item of text is billed as a function of the volume, an individual page which is displayed on a display not being completely calculated immediately after it becomes visible. Instead, during the orientation time [0,t1), in terms of the charge scheme the page is considered not to be used and is not billed at all. The page is considered to have been used entirely by the consumer in terms of the charge scheme only after a predetermined time t1+t2+t3.

FIG. 23 shows in a schematic and exemplary form time profiles for the use of a page of a page-orientated item of text by the consumer for a charge scheme methodology which is illustrated in FIG. 22.

The rectangles symbolize, by way of example, the same page of a page-orientated item of text; here a page with the page number 21. After the page has been displayed on a display device, the page is considered as not being used within the orientation time of, for example, 15 seconds (FIG. 23A). After the orientation time has expired, the price for the use of the page of, for example, DM 0.025 is billed completely (FIG. 23B) even if the user has received only a fraction of the text content of the page. The period of time during which this page is displayed on the display is registered continuously (FIG. 23C). Assuming that the reader terminates the display of the respective page after 15 seconds starting from the beginning of the charge-incurring use of the page after the expiry of the orientation time, by moving on to another page (in the example to page 36), aborting the use of the respective item or even switching off the display device (FIG. 23D), the use time which is stored for this page up until then is buffered. A free-of-charge orientation time of 15 seconds is allocated for the orientation on the new page 36. If the consumer then causes the same page 21 to be displayed again at a later time (FIG. 23E), firstly a new orientation time is allocated. After the expiry of the new orientation time (FIG. 23F), the billing of time continues taking into account the time already cumulatively spent viewing this page by the consumer in the past. If the time which has been predetermined for a single use of the page has expired, the page is considered to have been completely read (FIG. 23G). There is no further time-dependent billing as long as the page continues to be displayed without interruption on the display (FIG. 23H). Instead of individual storage of times of use which have been started for specific pages, it is also easily possible to run a time credit account in which unused times of all the pages which are exited prematurely are cumulated and made available to the user in order to view the same page or other, completely new pages.

FIG. 24 shows a second diagram relating to the discussion of the dependence of the volume—received by the consumer—of a page of a text document on the use time spent on using this page.

Here, the reading curve illustrated in FIG. 24 corresponds to the reading state of the page illustrated in FIG. 23C.

FIG. 25 shows a third diagram relating to the discussion of the dependence of the volume—received by the consumer—of a page of a text document on the use time spent on using this page.

Here, the reading curve illustrated in FIG. 25 corresponds to the reading state of the page illustrated in FIG. 23H.

FIG. 26 shows a schematic view of the reading process with the acquisition of status rights.

The charge scheme options which are made possible by the invention include, in particular, charge scheme models in which, in the case of a page-orientated text item, status rights can be acquired and presented in a suitable way in terms of information technology at the level of an entire item and/or at the level of a page. For example, the complex volume/time billing mode which is illustrated in FIGS. 20 to 25 makes it possible for the consumer to be credited with residual components of the reading time which is respectively page-related. This is indicated symbolically in FIG. 26 by virtue of the fact that the consumed time components per page are respectively represented in hatched form, whereas the remaining residual time components are not hatched. In addition, at the provider end rules can be predefined which describe the transition from a volume-orientated billing system, a time-orientated billing system or complex volume/time billing system to a purchase-orientated billing system.

For example, for a specific item (identified in FIG. 26 by an item identification number 2349457) it is possible to predefine that after reading twice the reader acquires a chronologically unrestricted right of use without an obligation to pay a further charge.

In FIG. 26, further possible charge scheme rules are given purely symbolically, for example rules that a degressive charge scheme is applied, or that the content cannot be used further after having been read twice.

FIG. 27 shows a schematic view of a device according to the invention with a card.

A first device for using and billing for the use of digital content and a second device for using and billing for the use of said content are respectively designated by the references 1202 and 1204. The distribution server 110 is connected via the data traffic network (WAN) 210 to the devices 1202 and 1204 for downloading files which are kept available on the server and have digital content which are provided for use by the consumer (not illustrated). It goes without saying that these files can also be transferred to the consumer for use by the devices 1202 and 1204 by exchanging physical data carriers (for example CDs, CD-ROM, DVD etc.).

The devices 1202 and 1204 each have a device 1206 and 1208, respectively, for accommodating a card module 1210. Each of the devices 1202 and 1204 also has a design which corresponds to the details illustrated in FIGS. 16 and 17, i.e. in particular a decoder 1212 and 1214 is respectively provided. The other components which are necessary for billing, such as consumption measuring means, limiter, stored-value memory and consumption history, are not illustrated.

FIG. 27 illustrates, on the one hand, that the consumer (not illustrated) uses, by means of the device 1202, an item with an item identification 333 and in doing so has used in total 420% of, that is to say more than 4 times, the volume of the item. The privileges acquired by repeatedly playing back the item 333 are stored here on the card module 1210. If the user changes over to another device 1204 (in the right-hand half in FIG. 27) and requests again the item which is not present on the device 1204, with the result that said item has to be made available again by the server 110 via the WAN 210, this is coded in a different form for the decoder B. The acquired privileges nevertheless become effective through the insertion of the card module 1210 into the device 1204, with the result that, depending on the charge scheme model, the playing back of the item 333 again is considered, for example, degressively in a cumulative fashion, for example as being 600% at the end, and is correspondingly billed. The example in FIG. 27 shows that the same item can be made available encrypted in a different form in different devices and nevertheless can be called by means of the same card module 1210.

FIG. 28 shows a schematic view of a scheme for managing and transmitting rights by means of a card module. FIG. 28 illustrates that the same card module 1210 is capable of calling digital media content from one or more servers on different playback devices in different formats. As a result, the card module 1210 is illustrated in the left-hand part in conjunction with an MP3 player, in order to play back sound signals or music, in the central part it is inserted into a set top box B, or a television set or some other terminal connected to the latter, in order to display video signals, and in the right-hand part in conjunction with an e-book reader for displaying pages of text and/or pages of images.

FIG. 29 shows a schematic view of another scheme for managing and transmitting rights by means of a card module. In particular there is an illustration here of module-related encryption which makes it possible to make telephone calls and transmit data online, and consume offline. The user requests an item from a multimedia content provider CPr1 via his telecommunications service using a telecommunications module (for example GSM or UMTS) which is equipped with a rights card. The rights card is additionally provided with an encryption module whose key type is known to the telecommunications service. The multimedia content provider CPr1 as a synergy partner of the telecommunications service inquires, from the telecommunications service using the telephone number of the end user, which key is to be used for this telephone number and transmits its item directly to the end user together with the corresponding encryption. Said end user can consume the item only using his rights card with the matching individual decryption module, either in lifestreaming mode or offline in the viewing mode. Billing is performed via the telecommunications service.

A device for using and billing for the use of digital content is designated by the reference 1410. A technical IT infrastructure of a telecommunications provider is designated by the reference symbol 1415. Technical IT infrastructures of content providers for files with digital (multimedia) content are designated by the references 1420A, 1420B, 1420C or 1420D.

FIG. 30 shows a flowchart of a downloading process in conjunction with

FIG. 31 shows various possible solutions for implementing the invention. In the simplest and least reliable case, the entire encryption of the media files and of the user data and charge scheme data is carried out on a conventional PC by means of a software solution. In order to increase the reliability, said PC can additionally communicate with a token solution, for example a chipcard. The highest level of security is obtained with an integrated terminal which is as far as possible encapsulated (appliance solution, for example MP3 player), in which opening causes data to be lost. Universal mobile device

FIG. 32 shows an advantageous digital mobile device in a particular embodiment as a wearable computer 127010, which can be used in particular as a multimedia player, preferably including a digital rights management system (DRMS). The mobile device 127010 may have a PCMCIA slot 127020 which can be used in particular for holding a smartcard chipcard, for example for distribution and payment systems.

The PCMCIA interface can thus also be used for other functionalities or expansions, for example for adapter cards for smart media modules or similar storage cards, processor cards or other software and/or hardware expansions. It is then also possible to equip the mobile device 127010 with a mobile phone functionality, for example WAP, SMS, GSM, GAPS, UMTS.

One embodiment is to embody a PCMCIA card as a decoder module for digital rights management with an integrated memory, smartcard reader and/or means for making telephone calls and/or for data communication/data transmission using WAN (GSM, UMTS, GPRS etc.). In addition, it is advantageous to provide customary functions of a personal digital assistant (PDA) such as appointment planning, notes etc.

These can also be implemented in the mobile device 127010 itself, in the display and operator control part 127030 or in a connection module, for example 127020.

All the functions can, if appropriate, be used individually or in combination. Further functionalities are also possible. The disclosed content of PCT/EP 01/03738, in particular the description of particular embodiments of wearable computers, is herewith expressly made the subject matter of this patent application.

The reference 127030 designates a display and operator control unit. The display and operator control unit 127030 has a display 127040 which is used for displaying texts and graphics, including videos, of the applications which run on the mobile device 127010. The connection between the mobile device 127010 and the display and operator control unit 127030 can also be made by means of a cable (not illustrated), but a cableless data communications connection, for example by means of radio waves using, for example, the Bluetooth standard or by means of infrared data transmission using, for example, the IrDA standard, is preferred. The display and operator control unit 127030 can advantageously also be provided with an audio subsystem, for example an earpiece/microphone combination 127050. For pure hearing purposes, it is also possible to use, for example, a HiFi headset. In another variant (not illustrated), the microphone can also be integrated into the display and operator control unit 127030.

The display and operator control unit 127030 is advantageously dimensioned in such a way that it can be comfortably held in the hand. If the display and operator control unit 127030 is embodied with a touch screen, the user can easily carry out input operations with the thumb of the hand with which he is holding the unit. Alternatively, operator control using an input pen (not illustrated) can also be provided. In one development, the microphone/headset 127050 has a switching device 127060 with which, for example, music playback can be switched off and an incoming telephone call connected. After the end of the telephone call, the music playback can be switched on again by activating again.

The display and operator control unit 127030 can be equipped with its own processor or control device and its own rechargeable battery. For this reason, in this variant the playback software can run directly on the display and operator control unit 127030. As a result, it is in particular possible to resolve copy-protected data formats only in the display and operator control unit 127030 and feed them to the earpiece. The encryption of the data stream between the mobile device 127010 and the display and operator control unit 127030 can be carried out, for example, by means of the SSL protocol. With such a configuration, the item decoder (not illustrated) can be provided with the digital rights management system in the mobile device 127010 without there being a risk of unauthorized copying. In this embodiment, it is possible, for example, to stream content from the wearable computer to a player or browser installed for that purpose in the display and operator control unit, for as long as the preconditions for this are fulfilled, for example by means of a connected rights smartcard in the wearable part or in the display and operator control part.

One particular embodiment of the display and operator control unit is the possibility of representing the operator control function of the piece of equipment to be controlled and the possibility of displaying, for example, multimedia content which have just been played back, together with associated information such as title, amount of stored value, playing time etc., or lists of multimedia items which can be played back or ordered. With a multifunctional embodiment of the display and operator control unit, for example both as a media player and as a mobile telephone, it is possible to switch to and fro automatically between displaying, for example, telephone numbers and displaying titles which are being played at that particular time, or titles which are available or can be ordered, depending on the operating mode or in response to an input. If a telephone call is being made at that particular time, the subscriber can be displayed or even represented by an image, and if, for example, a piece of music is being played (suppressed during a telephone call), corresponding information is presented on the display.

The mobile device 127010 can interact, via a LAN data connection, with other devices such as an a-book reader, PDA, web tablet, PC or beamer in the same or similar form, if provisions are made for that purpose. The mobile device can also interact with the Internet via a WAN connection other than a wirefree one by GSM, GPRS, UMTS etc., said connection being for example by analog telephone line, by ISDN line or by DSL.

FIG. 32B shows a side view of the mobile device 127010. For pleasant carrying comfort when the mobile device is attached to a belt for clothing (not illustrated), the housing has an ergonomic shape which has a depression 127070 on the side facing the belt. For reasons of convenience, rechargeable batteries (not illustrated) are advantageously arranged in the lower region of the housing.

An embodiment in which the housing can rotate approximately relatively on the belt by means of a connection part (not illustrated) so that it can always orientate itself in the direction of gravity is particularly advantageous. Customary peripherals, for example printers etc., can be connected to the mobile device 127010 in a developed embodiment.

FIG. 33 shows the display and operator control unit 127040 from FIG. 32. In a particularly preferred development, the display and operator control unit 127040 has, on the upper and lower end sides 128010a, 128010b, in each case a plug-in and latchable device (not illustrated) by means of which a cover module 128020 can be pushed and locked onto the display and operator control unit 127040, and possibly also establish electrical connection with it. In one specific embodiment, the cover module 128020 is equipped with a telephone keypad and has a viewing window for displaying the display and operator control unit 127040, and may have an earpiece and microphone (not illustrated), if the microphone is not included in the display and operator control unit 127040.

The cover module 128020 may be embodied in a wide and fashionable range of shapes and colors. The purpose is:
a) to permit the user to make a telephone call in the same way as he is used to from a conventional mobile telephone, and
b) to permit a device which is originally configured as a playback device to be possibly subsequently easily retrofitted to form a mobile telephone, or vice versa.

The cover module 128020 is, in the connectable embodiment, able to be plugged from above or below onto the display and operator control unit 127040 depending on the left-handedness or right-handedness of the user. What appears on the display of the display and operator control unit 127040 is correspondingly automatically orientated so that texts and images can always be read. In a simplified embodiment, this feature can also be omitted. A further advantageous possible. embodiment of the display and operator control unit is the lateral formation of input or operator control elements facing away from the display, at the edge of the display, with which the display and operator control unit 127040 can both be held with a hand and operated. One particular embodiment is to implement the input feature by means of at least three input pushbutton keys, permitting certain basic functions, for example leafing, scrolling and the triggering of marked functions or menus. The position and number of the plug-in and the latchable connections (if present) and the input possibilities may vary in an individual case.

The plug-in connection is particularly advantageous by virtue of the possibility of connecting to an accommodating means, for example in vehicles (not illustrated), the operator control and the inputting and outputting of sound taking place via the same interface as that of the cover module. The advantage of the separate display and operator control unit 127040 is in particular the compact design which can be made very lightweight.

In mobile radio applications, the GSM or UMTS transmission antenna can be arranged at a distance from for particularly sensitive body parts such as the head by mounting it on the mobile device 127010 which can possibly even be positioned away from the body, for example on a table.

The display and operator control unit and the wearable part (computer) may also be embodied in one piece, provided that the disclosed embodiments and/or functionalities, for example a DRM solution using a smart module and/or PCMCIA module, reception and/or transmission module for telephony, media player and PDA combination, remote controls for terminals and/or a lid with viewing window solution are implemented.

Of course, the embodiment of a handheld mobile device with a cover which can be unfolded and folded closed or folded over and which has a viewing window for the display below it is possible in a wide variety of embodiments. The advantageous cover with a viewing window serves as the basis for an independent inventive idea. The advantage of the viewing window in the folding cover of mobile, handheld devices is in particular to permit a display which is present to be read even when the protective cover is closed, and other functionalities can be made possible by closing the lid or the functionality of the mobile device can be expanded by folding over the lid, without a further display being required for this purpose. As a result, the use of the lid therefore covers all mobile handheld devices with functionalities which are specified in this disclosure, for example PDA, telephony (wirefree and/or using cables) and/or media player with or without a remote control function. It is also possible to embody the particular design of cover to be permanently associated with one mobile display and operator control part, regardless of whether the display and operator control part is embodied in one piece with a control unit or in more than one piece with an external wearable computer.

FIG. 34 shows the possibility of using the display and operator control unit 127040 from FIG. 32 for different pieces of equipment and applications. The display and operator control unit 127040 can always be kept ready for use on the person or in the vicinity of the person and can cooperate with numerous other electronic devices within the distance which can be spanned using, for example, Bluetooth or infrared (IrDA). For example for monitoring houses, games consoles, television set, fixed network telephone, set top box, video recorder, multimedia player, mobile telephone or PDA. Furthermore, FIG. 34 shows a fixed version 129010 which is similar to the mobile device with the same functional and technical embodiment possibilities, including that of streaming DRM-protected content onto corresponding display components. The difference with respect to the mobile device 127010 from FIG. 32 is that, for example, relatively large hard disk storage systems can be readily integrated. Furthermore, with the fixed version 129010, a fixed network connection possibility and a satellite communication connection possibility are provided as a primary WAN connection, while in the case of the mobile device it is preferably GSM, UMTS or a fixed network. In the fixed variant 129010 it is possible to provide an external audio output since it is advantageous to separate image and sound from one another by means of a digital rights management system. The display and operator control unit 127040, described above, of the mobile device can also be used to perform operator control of the fixed station, which is advantageous for the user since he can carry out operator control and display functions, and have them displayed, in the usual way using his universal display unit, without requiring another remote control. A further advantage of the display and operator control unit 127040 is that it is possible both to perform operator control of different devices, as shown, and to receive audio channels without having to pass via the external output of the fixed device, to which external output loudspeaker systems are usually connected (remote control with headset).

A wide variety of applications, for example monitoring of a house, games console, television set, fixed network telephone, set top box, video recorder, multimedia player, mobile telephone or PDA, can also run on the fixed station 129010.

The display and operator control unit 127040 detects advantageously if it is in range of a signed-on terminal for which it can perform operator control. In the display, a corresponding symbol is then displayed for the terminals which can be respectively operated. If different transmission paths, for example a fixed network or radio network for the transmission of signals between the display and operator control unit 127040 and the respective terminal are possible, in one particularly preferred embodiment the respectively most cost-effective transmission is selected. When it is used as a telephone, the display and operator control unit 127040 uses a uniform address and telephone number register and decides, depending on the telephone number of the subscriber participating in the call, which transmission path is selected as the most favorable or better one.

All the functions of the display and operator control unit can also be triggered by means of voice command control, irrespective of whether said unit is embodied in one part or two parts.

The reference 129020 designates the PCMCIA module which represents, in one embodiment, a digital rights management system (DRMS) with decoder function and which can easily be connected to and fro between the fixed station 129010 and the mobile device 127010. In particular the functionalities 129030 can be supported by the DRMS. As in the case of the mobile device, the PCMCIA module can be embodied with a smartcard reader and/or an internal data memory for storing, for example, licenses, DRM software, decoder software, player software, browser, rights information, status information, user privileges and/or consumer histories in as far as these are not implemented by means of hardware technology or are provided at all. Of course, the entire disclosure content of the possibilities described above, in particular of the distribution and payment system and its aspects can be applied in various embodiments either for the mobile or fixed solution.

FIG. 35 shows a preferred embodiment of the distribution and payment possibilities described above, in the form of a PCMCIA card with a smartcard reader, which permits, by interacting with a playback device, the consumption of protected multimedia data, with a corresponding basis for the billing of this data.

FIG. 47 shows a schematic block diagram of a further device according to the invention for distributing, playing back, billing and paying for digital media content.

A provider of digital media content (not illustrated) operates a server computer which is connected via a digital network, for example via the Internet (not illustrated), to a media playback component 4720 which is located at the media consumer end (not illustrated). In the exemplary embodiment depicted the media playback component 4720 is an audio player with at least one loudspeaker or headset 4722 which obtains digital audio data from the server 4710 by means of a streaming protocol, and converts them into sound which can be perceived by the media consumer. Of course, the invention is not restricted to audio media; it is likewise also possible to distribute and consume video media, electronic books or other media content in modified embodiments, a precondition being corresponding display means.

The playback function of the media playback component 4720 is dependent on control signals of a transaction control component 4730 which transmits an enable signal (not illustrated) to the media playback component 4720 only if billing of the consumed media content in accordance with the charge scheme is ensured. For this purpose, firstly sufficiently secure identification and authentication of the media consumer are necessary. An identification and authentication component 4740 is connected to the transaction control component 4730 and has a suitable user interface (not illustrated) with which the media consumer can identify and authenticate himself. In a very simple variant this may take place, for example, by the media consumer being required to enter his user name and his password by a request on a display (not illustrated). If the entered user name and the entered password correspond to a pair composed of the user name and password which are securely stored in the identification and authentication component 4740, it is assumed that the entered user name matches and that all the further media consumption actions are to be billed to this media consumer who is identified in this way. In an advanced variant of the identification and authentication component 4740 it is also possible for a hardware token 4745, for example a smartcard, to be used to secure the identifying and authenticating process. Other authentication means such as, for example, fingerprint, voice recognition and/or other known biometric identification and authentication means may also be provided.

In addition, the transaction control component 4730 is connected to a money transfer control component 4750. The money transfer control component 4750 accepts, from the transaction control component 4730, instructions relating to amounts of money for which the media consumer is to be billed, and signals to the transaction control component 4730 whether the billing of these amounts of money has been completed, or if it is at least to be considered as secured. The transaction control component 4730 controls the media playback component 4720 in a specific way so that the media consumption is interrupted as soon as the money transfer control component 4750 no longer signals that the billing of the amounts of money which are owed by the media consumer has been completed, or is at least to be considered as secured. The money transfer control component 4750 is preferably connected to a first computer system 4760 of a financial institution at which the media provider or a billing entity commissioned by the provider has an account, as well as to a second computer system 4765 of a financial institution at which the media consumer has an account. This connection may be made, in particular, via the customary billing data centers of the banks or the credit card company. If necessary, the money transfer control component triggers the transfer of a specific amount of money from the account of the media consumer to the account of the media provider or the billing entity commissioned by him.

In order to avoid rapid repetition of a large number of money transactions for very small amounts of money, which unnecessarily increase the money transfer costs, it is expedient to allocate the media consumer a credit framework, to demand payment in advance or to combine both and provide a money account memory 4755 in which a number is stored which corresponds to the amount which is owed by the media consumer, or to the amount paid in advance which is associated with the media consumer. The money transfer control component 4750 can then preferably be configured in such a way that a money transfer order which is effective to the outside with respect to the computer systems 4760 and 4765 of the financial institute is issued only from time to time if a predefined available credit limit of the media consumer has been reached or exceeded by continued media consumption, or if an advance payment which has been made by the media consumer has been used up. In addition, a bonus point storage component 4735 in which at least one number (bonus point number), which corresponds to units of financial value accrued to the media consumer without however expressing an amount of money in a national currency, is stored is connected to the transaction control system 4730. The charge scheme for media consumption actions which are carried out by the media consumer and the generation of additional bonus points, dependent on these consumption actions, in the bonus point storage component 4735 is carried out in particular in accordance with the principles and features specified in parts of the description above. An alternative embodiment is described in FIGS. 16 and 17.

In order to make the use of the media as simple as possible for the media consumer, in one preferred embodiment there is provision for, for example, the media provider to make available a catalogue server 4770 with a search component (search engine) 4775. By means of the catalogue server 4770 with the search component (search engine) 4775, the media consumer can comfortably search through the offer of the media provider, for example by reference to data relating to the title, composer, genre, album and/or performers. When less extensive information is made available, an alphabetic index may be sufficient; in the case of very extensive amounts of information a full text search is advantageous. If the media consumer has found, by means of the catalogue server 4770 and the search engine 4775, an item which is of interest to him, he can set up a data record for this item in an item list 4780 by means of suitable dialogs at the operator interface (not illustrated). Beyond listening to or viewing samples, the media playback component 4720 can be activated only by means of the item list 4780; the media consumer cannot consume an item for which there is no data record in the item list 4780. Conversely, the generation of a data record for a specific item in the item list 4780 does not necessarily mean that a charge-incurring consumption action has to be carried out. The item list 4780 instead constitutes a data structure which combines data on those items which the media consumer considers potentially interesting. From the results list of the search component it is possible to play back items for a predetermined time, for example.

However, the item list 4780 serves not only as a notes memory merely for item-specific information such as author or title, it also constitutes the basis for item-specific management of the item usage options by the media consumer. In particular it is preferably possible for information to be stored for each item in the item list 4780, indicating:
whether any use of the respective item is consumption-dependent, that is to say is billed as a function for example of time or volume, or whether the item is classified as “obtained free of charge” according to the applicable charge scheme rules, i.e. the item can be consumed to an unlimited degree without further billing;
whether a physical copy of the respective item has been acquired at a price which is reduced according to the charge scheme owing to a previous online use.

Corresponding information can also be represented in the results list of the search component, in particular also information indicating whether items have already been registered, and if so in which item list.

An operator control interface (not illustrated) which is assigned to the item list 4780 can in particular also comprise measures for transmitting, by means of an item management component 4790 an order, reduced according to bonus points stored in the bonus point storage component 4735, for the purchase of a physical item to a dealer system 4795. In conjunction with the purchase process, the number of bonus points which is stored in the bonus points storage component 4735 is then reduced in accordance with the charge scheme. Conversely, in one preferred embodiment, it is also possible to provide for the media consumer to acquire, by purchasing, a physical item, for example an audio CD, a shop. If at least one item which is stored on the audio CD can also be called online via the server 4710, it is possible to provide for the media consumer to be allowed to note, in a corresponding item entry in the item list 4780, that according to the charge scheme it is possible for him to make online use of this item in future free of charge or under preferred conditions insofar as this does not take place automatically at the provider end, for example when a product is purchased, by means of suitable methods and/or technical provisions. The protection against misuse can be provided by the dealer feeding into the dealer system 4795 the purchasing action together with an item identification and together with the personal data of the media consumer, insofar as necessary, in order to uniquely identify him, so that the item management component 4790 can verify the purchasing action. Another form of protection against misuse may take the form of each purchased item, that is to say for example of each purchased audio CD, being provided with a uniquely defined, concealed code number. This code number may be implemented as a sufficiently large random number which is printed onto an accompanying slip and covered with a nontransparent covering layer. The random number must have a number of digits which is such that the probability of being able to guess it as a function of the issue is sufficiently small for practical purposes. All the random numbers which are respectively issued as a code number are stored in a database in the dealer system. In addition, for each issued code number there is a note indicating whether or not it has already been used for a discount according to the charge scheme. The media consumer can then remove the nontransparent cover layer and transmit the code number into the item management component 4790 via a suitable operator control interface (not illustrated). The item management component 4790 transfers this code number to the dealer system 4795 where testing is carried out to determine whether it is a valid code number which is registered in the database and marked as unused. In such a discount transaction, the code number is marked in the database as used and in return a corresponding discount is entered in the respective data record (or in the case of a plurality of items it is also entered in a plurality of respective data records) in the item list 4780. It is also possible to make corresponding rights registration by means of a token solution, for example a smartcard. One embodiment variant provides for rights pertaining to an item (rights of use) to be stored, together with a uniquely defined item identification, directly on the smartcard. Here it is possible for the data to be accessed and modified only by the provider or the dealer system.

The invention therefore makes it possible to combine the virtual online use of digitizable items and the acquisition of items by purchasing with one another in a most advantageous way. If the media consumer firstly starts with the online use of a specific item, the proposed technical infrastructure makes it possible for him, when this media consumption is billed in accordance with a charge scheme, to acquire a corresponding physical copy at a discounted rate. Conversely, if the media consumer firstly starts with the purchase of a physical copy, a discounted, possibly free-of-charge online access to the same item may be made possible for him according to the charge scheme.

If the technical arrangement described above is operated in a way in which there is no provision for individual items to be “acquired free of charge”, consumption-dependent billing in accordance with a charge scheme remains possible. In this case, a simple authentication with a password may be sufficient with respect to the identification and authentication component 4740, since the media consumer will then develop, on the basis of the cost consequences associated with each consumption action, a high degree of motivation to protect his access data and in particular not divulge it to third parties. The situation is different as soon as it is permitted to “acquire” items free of charge. By limiting the cost consequences there is the risk here of individual media consumers liberally passing on their access data to third parties. Under such circumstances, the hardware token 4745 which is difficult to simulate proves very advantageous for authentication purposes.

FIG. 48 shows a schematic view of a development of the arrangement shown in FIG. 47. Whereas only one catalogue server 4770 and one content server 4710 of an individual service provider was provided in each case in the arrangement shown in FIG. 47, the development shown in FIG. 48 includes corresponding computers of a plurality of service providers, specifically in each case one catalogue server 4770A, 4770B, 4770C, as well as in each case one streamer server 4710A, 4710B, 4710C of a first, second and third service provider. The media consumer accesses the individual provider-specific catalogue servers 4770A, 4770B, 4770C, or the provider-specific streamer servers 4710A, 4710B, 4710C, in this case via a multi-provider portal with a metacatalogue server 4770X and with a metastreamer server 4710X. One particular embodiment provides for individual providers to provide their products via the system described in FIG. 47 and do the billing processes for them themselves, it being possible, for example, for online items which are acquired free of charge to be registered and played back not only in the item lists of the individual providers but also for all the corresponding items of a wide variety of providers to be registered and played back via a link to the metaportal in a type of universal item list. For this purpose the item list of the metaportal is used as a quasidepot for all the items which can be acquired free of charge from various providers (for example publishing houses) and thus played back free of charge. A token solution which is preferably designed for this purpose, for example in the form of a smartcard, has the purpose of unambiguously authenticating a user, and prevents free-of-charge passing on of a PIN or password to third parties. The management of free-of-charge items by means of the item lists of the metaportal is particularly advantageous as the consumer can use individual publishing houses, but when he wishes only to consume he can preferably access the item list of the metaportal via one of the content providers or directly in order to play back all the items there which have been acquired free of charge, without having to change to and fro between the item lists of individual providers.

FIG. 49 shows a schematic view of a development of the arrangement shown in FIG. 48. Whereas no local storage of digital items is provided in the arrangement shown in FIG. 48 and media consumption therefore always requires an online connection to a content server 4710, the development shown in FIG. 49 includes an item memory component 4712 which is equipped with a sufficiently dimensioned mass storage medium (not illustrated) and in which content data of digital items which have been downloaded from one of the content servers 4710 can be stored so that it can also be consumed offline by the media consumer, that is to say without an open online data network link. The local offline availability of an item in the item memory component 4712 is entered in the corresponding data record of the item list 4780 which is associated with the respective item. The various charge scheme modes according to the invention which are described above are also applied in offline consumption of items which are stored in the item memory component 4712. As no financial transactions can be performed via the financial institutions 4760, 4765 during offline consumption, in this variant the money account memory 4755 is not only advantageous but also necessary.

In all the arrangements illustrated in FIGS. 47, 48 and 49, a DRMS (not illustrated) is preferably used with an implementation component (not illustrated) in order to protect the digital content data against misuse.

The arrangements illustrated in FIGS. 47, 48 and 49 can be implemented technically in a variety of ways. In particular, they can also be represented by computer programs running on universal computers. While the servers 4770, 4710, 4760, 4765 and 4795 are generally embodied as computers which are installed and operated outside the sphere of the media consumer, the other components, with the exception of the token 4795, can be incorporated, for example, by software running on a PC. However, it is also possible to use particular application-specific devices which implement these components in another way, for example by means of suitable electronic circuits.

FIG. 50 shows a schematic overview of a phase model for marketing multimedia products for purchase on the basis of the arrangements illustrated in FIGS. 47 to 49. Three phases are distinguished:
a) Phase 1: an arrangement according to FIG. 47 is typically applied in phase 1, three operator control steps being available on a providerspecific basis, that is to say without a multi-provider functionality;
b) Phase 2: an arrangement according to FIG. 48 is typically applied in phase 2 in which items which are “acquired free of charge” from various content providers can be combined, managed and played back on a multi-provider basis.
c) Phase 3: an arrangement according to FIG. 49 is typically applied in phase 3 in which items from various content providers can be downloaded on a multi-provider basis onto a mass storage medium of a multimedia application of the media consumer, managed and played back either online or offline.

FIG. 51A shows a schematic view of an exemplary operator control interface of a first aspect of a first substep according to the first phase of the phase model from FIG. 50. A menu bar 5110 is displayed on a display device (not illustrated in more detail). The menu bar 5110 permits a search function to be activated, divided into categories of music items, videos, games and electronic books. An alphabetic index bar 5112 permits alphabetical index searching for the name of the performer by leafing through the alphabetic index. A corresponding alphabetical index search is also possible according to other criteria such as the title of the item, the album, the genre etc (not illustrated in more detail). As a result of the search process, a result list 5115 appears in which all the items which are contained in the result quantity are listed in tabular form with one row each. In the case of an example from the “music” column, consecutive numbering, the title of the item, the name of the performer and the name of the album are given. In addition, a first operator control element 5115a is generated per item, the triggering of which first operator control element 5115a, for example by clicking on a mouse, causing the respective title to be displayed briefly for a time which is predetermined depending on the item, for example for 30 seconds. In addition, a second operator control element 5115b is generated for each item, the triggering of which second operator control element 5115b causing, for example by clicking on a mouse, an item which has been searched for to be marked for later transferring to the “play list”, that is to say in the item list 4780 from FIG. 47. A direct transfer of individual items is also possible if an operator control element (not illustrated) is provided for this purpose.

FIG. 51B shows a schematic view of an exemplary operator control interface of a second aspect of the first substep according to the first phase of the phase model from FIG. 50. The media consumer (not illustrated) has caused an appropriate data record in the item list 4780 to be generated in the result list 5115 by triggering the second operator control element 5115b for a number of marked items 5117a, 5117b, 5117c, 5117d, and the consumer is provided with an online play list display 5120 on the operator control interface. In one preferred embodiment, the online play list display 5120 may be configured in such a way that it can be sorted and/or grouped according to genres or user-defined categories 5122a, 5122b, 5122c, 5122d, 5122e.

FIG. 51C shows a schematic view of an exemplary operator control interface of a second substep according to the first phase of the phase model from FIG. 50. It is possible, for example by clicking on a mouse, to select and play back an individual item or an entire play list with a plurality of items from the online play list display 5120. The media playback component 4720 from FIG. 47 then appears on the operator control interface in the form of an “online player” object 5130 with the customary functionalities such as start/stop, fast forward, fast rewind. The playback function of the “online player” object 5130 is enabled only if the transaction control which is described in conjunction with FIGS. 47, 48 and 49 permits the money transfer according to regulations. When the playback function of the “online player” object 5130 is triggered by means of the corresponding operator control element, the consumption-orientated billing of charges for use starts, or, as shown in FIG. 51C, the conversion of official payment means into content-provider-specific amounts of monetary value starts, and said amounts can advantageously be used only for purchasing products and/or services from the respective content provider.

FIG. 51D shows a schematic view of an exemplary operator control interface of a first aspect of a third substep according to the first phase of the phase model from FIG. 50. The item administration 4790 from FIG. 47 appears on the operator control interface in the form of a “product manager” object with a product list 5142 in which physical copies of items which can be acquired, here by way of example CD albums, are listed and preferably illustrated by means of icons, in which it proves particularly advantageous to configure the icons in accordance with the front page of the CD booklets in order to ensure a high recognition effect. By clicking on an icon of the product list 5142, the respective icon in the product field 5144 is displayed. Operator control elements 5146a, 5146b, 5146c relating to the product field 5144 are generated in order to be able to trigger various commercial transactions relating to the CD album which is symbolized by the icon in the product field 5144. Triggering the first operator control element 4146a causes the number of bonus points which are stored in the bonus point storage component 4735 from FIG. 47 to be reduced by 400, and as a result all the items of the album are acquired free of charge for online use, which is also marked in the item list. Triggering the second operator control element 4146b has the effect, in the case of rights of use which have already been previously acquired (see above), of reducing the number of bonus points stored in the bonus point storage component 4735 from FIG. 47 by 800, and as a result a contractual promise of the content provider or of a commissioned intermediary agent to supply a physical copy of the respective album to the respective media consumer is triggered under the control of the item management component 4790 and of the dealer system 4795. Triggering of the third operator control element 4146c causes the stored value of the media consumer which is represented in the money account memory 4755 to be reduced by 15 Euros, and an order for a physical copy of the respective CD album from the content provider or from an intermediary agent which is commissioned by said provider is triggered, without the precondition of rights of use having been already acquired. For this purpose, the order is advantageously carried out by means of a goods basket (not illustrated). Of course, other products or services of the provider can also be purchased using the acquired points.

FIG. 51E shows a schematic view of an exemplary operator control interface of a second aspect of the third substep according to the first phase of the phase model from FIG. 50. After rights of use are acquired for all the items of the respective CD album by triggering the first operator control element 5146a, a data record is displayed in the online play list display 5120 of the media consumer (“Hans Mustermann”) for each of the items contained in the CD album, said data record indicating that the rights of use have been acquired, i.e. that the item is “acquired free of charge”. A play list with all the titles on the album is advantageously created automatically. Titles which are already located in individual item lists are also marked and if they are included on the album which has been acquired free of charge they can be played back free of charge.

Of course, the relationships explained above with reference to a CD album can also readily be transferred to other digitizable media such as, for example, videos or electronic books.

An on-demand distribution of digital content, for example via a data network such as the Internet or via a terrestrial transmitter channel or via a cable channel or satellite channel proves extremely broadband intensive, in particular if relatively small numbers of different items are requested by a large number of individual users at different times. There is therefore in practice a considerable need to propose a device which saves broadband capacity, or a corresponding method which saves broadband capacity.

In the inventive solution of this object it is possible to use a channel, for example a terrestrial transmitter channel, preferably during a certain first time window, for example from 09.00 a.m. local time to 24.00 p.m. local time for the continuous sequential emission of nonencrypted exert samples of digital items, referred to as trailers. The trailers can relate in particular to video films, audio media or games. By means of a device according to the invention, for example in the form of what is referred to as a set top box, it is possible for the media consumer to then view, during the day, the sequence of trailer emissions and finally arrive at a decision, after a process of deliberation, to view specific items, for example video films, associated with the individual trailers which have been seen, in the long version on the next day, for example. With the method according to the invention, the media consumer then indicates, during the running time of the corresponding trailer, that he wishes to consume the corresponding long version by activating an operator control means which may be arranged, for example, on the set top box or on a remote control which is associated with the set top box. For this purpose, a remote control (not illustrated) which is equipped with a display, such as has been presented before as a universal remote control in FIGS. 32 to 34, is advantageous. On the display it is possible to display corresponding item identifications such as, for example, titles and to trigger, by means of a direct key, a function which carries out a setting in the set top box. This may be a filter setting which makes it possible to detect and download an item which is to be transmitted later by broadcast. Other items which are not marked in the set top box are not permitted for downloading. Another possibility is to preset a time window setting, transmitted with the trailer, for example, which makes it possible to receive a specific program at a specific time on a predetermined channel, which program is transmitted in unaddressed form by means of a broadcast mode. It is optionally possible for the device, for example in the form of the set top box, to forward the consumption request via a suitable back channel, for example via a telephone line or via the Internet, to a server of the content provider. During a second time window, for example from 01.00 a.m. local time to 08.00 a.m. local time, the server of the content provider distributes the digital content requested by the individual media consumers, via the same channel which was used for distributing the trailers during the first time window. The set top box is then configured with a mass storage medium (for example a hard disk with a capacity of 160 Gbytes) and a control unit in such a way that it is possible, during this second time window, to filter out, from the set of all the digital items which are emitted in encrypted form in the broadcast mode, those items whose trailers the media consumer had marked during the first time window, and to store said items in encrypted form on the hard disk. During this automatic downloading and storage process, there is no need for any operator control intervention on the part of the media consumer whatsoever. At the latest after the second time window has been terminated, all the digital items which are ordered by the media consumer are stored on the hard disk and can be consumed by the consumer after decryption. It is advantageous to protect the content data by means of a DMRS and to identify and authenticate the authorized media consumer before access to the content data; the latter being preferably again carried out by means of a hardware token, for example by means of a smartcard.

FIG. 53A shows a schematic view of a device and a method for broadcast distribution of digital content in a first method step. On a channel 5210, product presentations with trailers are broadcast continuously in broadcast mode during the first time window from 09.00 a.m. to 24.00 a.m. Between the trailers it is possible, where necessary, also to intersperse blocks of advertisements. In a still further improved variant it is possible to provide the media consumer with monetary advantages, for example in the form of bonus points, for consuming these blocks of advertisements. A variant which is improved even more is defined by the fact that a specific symbol, for example a number or a combination of letters, is included in each block of advertisements (advertisement).

The media consumer is then awarded bonus points in this ultimate improvement only if during the inputting or within a short time window afterwards he inputs the symbol which is recognized by him, for example by means of a keyboard provided in the remote control of the set top box, and in this way proves that he has actually consumed the block of advertisements. The channel 5310 is evaluated by a set top box 5320 according to the invention. The individual trailers and the associated long versions can be identified by means of suitable measures, for example by means of a uniquely defined item identifier or by the specification of a precise time window during which the corresponding long version is broadcast. The consumer (not illustrated) marks the trailer A in the example shown by activating an operator control means on the operator control part (for example remote control) 5330 of the set top box 5320. The trailers can be consumed, for example, by means of a screen 5340 and/or a loudspeaker 5350.

FIG. 53B shows a schematic view of a device and of a method for broadcast distribution of digital content in a second method step. On the channel 5210, the long versions corresponding to the trailers are broadcast encrypted in the broadcast mode during the second time window from 01.00 a.m. to 08.00 a.m., and filtered out under the control of the control unit 5360 and stored in the storage module 5370.

FIG. 53C shows a schematic view of a device and of a method for broadcast distribution of digital content in a third method step. By means of a token (smartcard), the authorized media consumer identifies and authenticates himself with respect to a clearing house from which a decoder-specific decryption key for the digital content stored in the storage module 5370 is obtained.

FIG. 53D shows a schematic view of a device and of a method for broadcast distribution of digital content in a fourth method step. The digital content, for example a video film associated with the trailer A, which is stored in the storage module 5370 can be decrypted and consumed under the control of the control unit 5360.

1-42. cancel

43. A mobile device for transmitting and/or storing and/or displaying data, having a two-part structure composed of a display and operator control part and a portable wearable computer, it being possible to connect the display and operator control part and wearable computer via a wirebound or wirefree data connection (for example Bluetooth), and it being possible to use the display and operator control part as an independent terminal (for example as a telephone, as a PDA, as a media player and/or as a remote control).

44. The mobile device as claimed in claim 43, wherein the wearable computer has a memory for storing digital items.

45. The mobile device as claimed in claim 43, wherein the wearable computer has a memory for storing PDA-typical data such as addresses, telephone numbers, appointments, tasks and the like.

46. The mobile device as claimed in claim 43, wherein the display and operator control part has a memory for storing PDA typical data such as addresses, telephone numbers, appointments, tasks and the like, the content of which memory is synchronized with the memory of the wearable computer when a data connection is set up to the wearable computer.

47. The mobile device as claimed in claim 43, wherein the display and operator control part and/or the wearable computer has a connection module for connecting to mobile or fixed playback devices.

48. The mobile device as claimed in claim 43, wherein the display and operator control part and/or the wearable computer have a smartcard reader.

49. The mobile device as claimed in claim 48, wherein the smartcard reader has the purpose of holding a PCMCIA module which has at least a data memory for storing at least a license and/or a decoder and/or a limiter and/or a use history and/or a credit and/or a player and/or a browser and/or a multimedia item.

50. The mobile device as claimed in claim 43, wherein the display and operator control part and/or the wearable computer have a clock module or can be connected to one.

51. The mobile device as claimed in claim 43, wherein the display and operator control part and/or the wearable computer can be connected, for data transmission purposes, to a mobile radio network or to a fixed network.

52. The mobile device as claimed in claim 43, wherein when the display and operator control part is used as a remote control it communicates with different types of terminals.

53. The mobile device as claimed in claim 52, wherein the display and operator control part displays, on a display, symbols of the terminals in whose range it is located.

54. The mobile device as claimed in claim 43, wherein the display and operator control part can be alternatively or simultaneously connected to a fixed station, which can also have all the features of the wearable computer.

55. The mobile device as claimed in claim 54, wherein the fixed station is provided with a memory and a connection interface for a DRM module for managing access rights for digital media content.

56. A mobile device according to claim 43, further comprising a data processing device, the data processing device having a data carrier having a memory area for storing user-specific data, at least one further memory area for storing use times and/or use data quantities of media items which are used online or offline, and at least one data terminal having a device for holding the data carrier, having at least one data input device and at least one data output device and having a connection device for connecting to a digital data network.

57. The mobile device as claimed in claim 56, wherein the data terminal has at least one memory for storing a media item.

58. The mobile device as claimed in claim 56, wherein the data carrier contains a memory area for storing user-specific charge scheme data.

59. The mobile device as claimed in claim 56, wherein the data carrier has a memory area for storing at least one address of an online portal.

60. A display and operator control part for a mobile device, where the mobile device is for transmitting and/or storing and/or displaying data, the display and control part comprising a two-part housing which has a housing lower part and a housing upper part, at least one of the housing parts having a display, and it being possible to activate different operator control functions by moving the two housing parts in relation to one another from a closed position into an opened position, wherein one of the housing parts has an opening which permits the display in the other housing part also to be used in the closed position.

61. The mobile device as claimed in claim 60, wherein the housing parts are arranged so as to be pivotable with respect to one another.

62. The mobile device as claimed in claim 60, wherein in the closed position the housing upper part leaves at least one operator control element on the housing lower part uncovered.

63. The mobile device as claimed in claim 60, wherein the opening in the housing upper part is covered by a transparent panel.

64. The mobile device as claimed in claim 60, wherein operator control elements are arranged on the inside of the housing upper part.

65. The mobile device as claimed in claim 60, wherein the housing upper part can be fastened in different positions on the housing lower part for right-handed or left-handed operation.

66. The mobile device as claimed in claim 60, wherein the housing upper part has the functions of a mobile telephone.

67. The mobile device as claimed in claim 60, wherein the housing lower part has the functions of a PDA and/or of a universal remote control.

68. A method for displaying, for requesting, transmitting and/or billing digital media content, according to the following method steps:
providing a two-part structure comprised of a display and operator control part and a portable wearable computer part,
connecting the display and operator control part and wearable computer part via a wire-bound or wire-free data connection,
a media directory and/or a search engine for selecting items is made available via an online portal,
an item or a plurality of desired items are selected by the user via the online portal,
the item or the items are transmitted to the user for direct online use and/or for storage for later offline use,
the online uses and the offline uses are registered by an electronic data processing device at the user end,
the recorded use data is transmitted to a billing portal.

69. The method as claimed in claim 68, wherein the item or items are transmitted to the user via an online data line.

70. The method as claimed in claim 68, wherein the item or items are transmitted to the user in encrypted form, and in that the electronic data processing device has a decryption program or decryption module.

71. The method as claimed in claim 68, wherein the transmission of recorded use data to the billing portal from the data processing device is carried out when the media directory and/or the search engine is next selected.

72. The method as claimed in claim 68, wherein the electronic data processing device has a data carrier which can be inserted and removed, preferably in the form of a card which is provided with an electronic memory.

73. The method as claimed in claim 72, wherein the data carrier has a memory area for the preferred selection of a specific online portal with a provider-specific media directory and/or a provider-specific search engine.

74. The method as claimed in claim 68, wherein the online portal has at least one connection to a further online portal and/or to the billing portal.

75. The method as claimed in claim 68, wherein when billing data is transmitted the use of items in terms of time and/or quantity is used by the billing portal to calculate a charge scheme which is adapted to the scope of use, and the new charge scheme data is transmitted to the data processing device and/or to the removable data carrier which interacts with said device.

76. The method of claim 68, further comprising the following method steps:
providing a data carrier having a memory area for storing user-specific data, at least one further memory area for storing use times and/or use data quantities of media items which are used online or offline, and
providing at least one data terminal having a device for holding the data carrier, having at least one data input device and at least one data output device and having a connection device for connecting to a digital data network.

77. The method as claimed in claim 76, wherein the data terminal has at least one memory for storing a media item.

78. The method as claimed in claim 76, wherein the data carrier contains a memory area for storing user-specific charge scheme data.

79. The method as claimed in claim 76, wherein the data carrier has a memory area for storing at least one address of an online portal.

80. A data carrier having a memory area for storing user-specific data and having at least one further memory area for storing use times and/or use data quantities of media items which are used online or offline.

81. A data processing device having a memory card which changes its status as a result of use.

82. A data processing device having a memory card which contains charge scheme rules for the transmission and/or use of digital media content.

83. The data processing device as claimed in claim 82, wherein the charge scheme rules on the memory card are superimposed on or erase other rules which are stored in the digital item.

84. A device for distributing and using digital media content, comprising:
a) at least one content server for storing and making available digital media content,
b) at least one client for using digital media contents,
c) the content server being capable of transmitting digital media content to the client via a data network,
d) the server having an identification and authentication component with which it is possible for a user to be identified and authenticated with respect to the server,
e) the server having an item list memory in which in each case at least one user-specific item list for at least one user is stored,
f) the user-specific item list containing characteristic data of items which can be transmitted to the client by the content server.

85. A device for distributing and using digital media content, comprising:
a) at least one content server for storing and making available digital media content,
b) at least one client for using digital media contents,
c) the content server being capable of transmitting digital media content to the client via a data network,
d) the client having an identification and authentication component with which it is possible for a user to be identified and authenticated with respect to the server,
e) the client having an item list memory in which in each case at least one user-specific item list for at least one user is stored,
f) the user-specific item list containing characteristic data of items which can be transmitted to the client by the content server.

86. A method for selling data carriers having digitally coded items recorded on them, comprising the following steps:
a) the digitally coded items are provided for paid online use by at least one user,
b) at least one digitally coded item is used by the at least one user,
c) at least one reproduction element of the data carrier is sold to the at least one user,
d) the purchase price of the reproduction element of the data carrier being reduced as a function of the paid online use which has taken place before the purchase.

87. A method for the online use of digitally coded items, comprising the following steps:
a) reproduction elements of data carriers having at least one digitally coded item recorded thereon are provided,
b) at least one data carrier is sold,
c) a specific, uniquely defined identifier being assigned to each purchasing transaction,
d) the uniquely defined identifier is assigned to an online user,
e) the digitally coded items are provided for paid online use, the use by that online user to whom the uniquely defined identifier is assigned being at a reduced rate or being free of charge.

88. A method for distributing digital content in the broadcast mode via a data channel, comprising the following steps:
a) a sequence of trailer blocks is output on the data channel during a first time window, each trailer block being assigned a specific digital item in advance;
b) individual trailer blocks are marked interactively by a user;
c) a sequence of digital items is output on the data channel during a second time window which is discontinuous with respect to the first time window, each item for which a trailer has been output during the first time window being output at least once in the broadcast mode;
d) all those digital items which are associated with one of the trailer blocks which are marked interactively by the user are selectively filtered out, downloaded and stored locally; and
e) the downloaded digital items are played back.
